(19) United States
(12) Patent Application Publication
(10) Pub. No.: US 2025/0250701 A1
(43) Pub. Date: Aug. 7, 2025

(54) SCALABLE SYNTHESIS OF HETEROATOM-DOPED CARBON NANOTUBES FOR ELECTROCHEMICAL CARBON DIOXIDE REDUCTION

(71) Applicant: THE TEXAS A&M UNIVERSITY SYSTEM, College Station, TX (US)

(72) Inventors: Ying LI, College Station, TX (US); Yang GANG, College Station, TX (US)

(73) Assignee: THE TEXAS A&M UNIVERSITY SYSTEM, College Station, TX (US)

(21) Appl. No.: 18/856,673

(22) PCT Filed: Apr. 12, 2023
(86) PCT No.: PCT/US2023/065665

§ 371 Date: Oct. 14, 2024

Related U.S. Application Data
(60) Provisional application No. 63/332,235, filed on Apr. 18, 2022.

(51) Int. Cl. C25B 11/091; C01B 32/168; C25B 1/23; C25B 9/19; C25B 11/052; C25B 11/065

(52) U.S. Cl. CPC C25B 11/091; C01B 32/168; C25B 1/23; C25B 9/19; C25B 11/052; C25B 11/065; C01B 2202/06; C01B 2202/22; C01B 2202/32; C01P 2002/52; C01P 2002/72; C01P 2002/85; C01P 2004/03; C01P 2004/04; C01P 2004/133; C01P 2006/12; C01P 2006/40

(57) ABSTRACT

Heteroatom-doped carbon nanotubes, catalytic electrodes, reactors, methods of making heteroatom-doped carbon nanotubes, and methods of reducing a molecule are described. In an embodiment, the heteroatom-doped carbon nanotube comprises single atomic metal-nitrogen-carbon (M-N—C) sites for use as an electrocatalyst. In an embodiment, the heteroatom-doped carbon nanotube comprises single atomic Fe—N bonds as active sites configured to convert carbon dioxide to carbon monoxide. In an embodiment, the active sites are disposed on an outer surface of the heteroatom-doped carbon nanotube. In an embodiment, the heteroatom-doped carbon nanotube further comprises Ni metal nanoparticles. In an embodiment, the Ni metal nanoparticles are disposed in joints of the heteroatom-doped carbon nanotube. In an embodiment, the Ni metal nanoparticles are encapsulated by graphitic carbon layers of the heteroatom-doped carbon nanotube.

### CROSS-REFERENCE TO RELATED APPLICATION

This application claims the benefit of U.S. Patent Application No. 63/332,235, filed Apr. 18, 2022, expressly incorporated herein by reference in its entirety.

### STATEMENT OF GOVERNMENT LICENSE RIGHTS

This invention was made with government support under Grant No. 1805132 awarded by the National Science Foundation. The government has certain rights in the invention.

### BACKGROUND

The electrochemical CO₂ reduction reaction (CO₂RR) is a promising solution to mitigate excess CO₂ concentration in the atmosphere that results in global warming. Utilizing renewable energy, such as solar and wind as the electricity source, CO₂RR can produce value-added chemicals at mild reaction conditions with significant scale-up potentials of the entire process. However, CO₂RR normally suffers from sluggish reaction rates due to the stable nature of CO₂ molecules. Thus, highly efficient catalysts are desired to reduce the reaction barrier and boost the activity to a practical level.

Among the many catalysts researched, metal and nitrogen co-doped carbon (M-N—C) has attracted increasing attention because of its advantageous properties including cost-effectiveness, abundance of precursor materials, and potential for large-scale application. Two types of carbon precursors are typically used to synthesize M-N—C catalysts. One starts from pristine carbon such as graphene oxide, carbon nanotubes (CNTs), or carbon black, followed by doping nitrogen and metal sources at a high temperature. The other route begins with metal source and carbon/nitrogen-containing organic-based precursors, which are subjected to high-temperature pyrolysis. Typically, multiple pre-treatments, namely strong acid/oxidant activations, are used to provide high carbon surface area and achieve effective nitrogen/metal doping. In terms of the metal precursor, metal salts (e.g., metal nitrates) are normally used for metal doping. Since the aggregation of metal sites, which forms metal nanoparticle on the carbon matrix during pyrolysis, decreases CO₂RR performance because of favoring competing hydrogen evolution reaction (HER), post-pyrolysis acid washing is typically applied to remove the exposed metal nanoparticles and leave only coordinated metal-nitrogen (M-N) sites that are active for CO₂RR. These treatments not only hinder the scale-up potential of the synthesis, but also produce pollutants, further adding the burden of downstream waste treatment to the CO₂RR life cycle.

Furthermore, to anchor nitrogen onto the carbon matrix, extensive amounts of nitrogen sources (such as urea, melamine, etc.) are typically used at quantities many times the weight of the carbon source. However, the poor interaction between these precursors and carbon precursors results in a majority of the nitrogen elements escaping as gasses instead of being doped onto the carbon. This leads to a low product yield considering the carbon/nitrogen quantity ratio, thus significantly reducing the scale-up potential and cost-effectiveness of the M-N—C catalyst synthesis. As a result, low-cost carbon, metal, and nitrogen sources requiring fewer treatment steps while still being effective for constructing M-N active sites are needed for future large-scale applications of CO₂RR catalyst synthesis.

Multi-walled carbon nanotubes (MWCNTs) are one of the most popular carbon precursors researched. It has been synthesized in an industrial scale and is more cost-effective than the other synthesized carbon precursors, such as graphene or metal-organic-frameworks (MOFs). CNTs also have a larger surface area, better conductivity, and greater strength than the natural carbon sources, such as graphite. However, the majority of the literature reports using CNTs solely as the carbon precursor suffer from multiple aforementioned disadvantages due to pre-/post-pyrolysis treatments.

### SUMMARY

To address these and related challenges, the present disclosure provides heteroatom-doped carbon nanotubes, catalytic electrodes, reactors, methods of making heteroatom-doped carbon nanotubes, and methods of reducing a reactant of a reaction catalyzed by the heteroatom-doped carbon nanotubes of the present disclosure.

Accordingly, in an aspect, the present disclosure provides heteroatom-doped carbon nanotubes comprising single atomic metal-nitrogen-carbon (M-N—C) sites for use as an electrocatalyst.

In another aspect, the present disclosure provides a catalytic electrode comprising a carbon electrode; and heteroatom-doped carbon nanotubes according to any embodiment of the present disclosure disposed on a surface of the carbon electrode.

In another aspect, the present disclosure provides a reactor comprising a first fluid compartment; a second fluid compartment; an ion exchange membrane fluidically separating the first fluid compartment and the second fluid compartment and configured to allow passage of ions therethrough; a first electrode in electrically conductive communication with an interior portion of the first fluid compartment; and a catalytic electrode according to any embodiment of the present disclosure in electrically conductive communication with an interior portion of the second fluid compartment.

In yet another aspect, the present disclosure provides a method for making heteroatom-doped carbon nanotubes comprising M-N—C sites for use as an electrocatalyst to convert carbon dioxide to carbon monoxide, the method comprising pyrolyzing a mixture of a solid nitrogen precursor and carbon nanotubes comprising intrinsic metal impurities at a temperature and for a time sufficient to provide a carbon nanotube catalyst comprising M-N—C sites effective for electrochemical carbon dioxide reduction.

In another embodiment, the present disclosure provides a method for making heteroatom-doped carbon nanotubes comprising M-N—C sites for use as an electrocatalyst to convert carbon dioxide to carbon monoxide, the method (a) contacting a solution comprising nitrogen precursors with carbon nanotubes comprising intrinsic metal impurities, whereby the carbon nanotubes adsorb nitrogen precursors from the solution to provide a suspension comprising organic-adsorbed carbon nanotubes comprising metal sites and adsorbed nitrogen precursors; (b) separating the organic-adsorbed carbon nanotubes from a solvent of the suspension to provide a mixture including the organic-adsorbed carbon nanotube, (c) drying the mixture to provide carbon nanotubes comprising metal sites and adsorbed nitrogen precursors; and (d) pyrolyzing the carbon nanotubes comprising metal sites and adsorbed nitrogen precursors at a temperature and for a time sufficient to provide a heteroatom-doped carbon nanotube catalyst comprising M-N—C sites effective for electrochemical carbon dioxide reduction.

In yet another aspect, the present disclosure provides heteroatom-doped carbon nanotubes having M-N—C sites prepared by a method according to any aspect or embodiment of the present disclosure.

In another aspect, the present disclosure provides a method for electrochemically reducing a reactant, comprising contacting the reactant with heteroatom-doped carbon nanotubes of any embodiment of the present disclosure. In an embodiment, the reactant is carbon dioxide and a product includes carbon monoxide.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of claimed subject matter will become more readily appreciated as the same become better understood by reference to the following detailed description, when taken in conjunction with the accompanying drawings, wherein: FIG. 1 schematically illustrates a process of fabricating heteroatom-doped carbon nanotubes (CNTs) comprising single atomic metal-nitrogen-carbon (M-N—C) sites using commercial CNTs and organic wastes for the application of CO₂ reduction reaction (CO₂RR), according to an embodiment of the present disclosure;

FIG. 2 graphically illustrates SMX adsorption isotherm with different fitting models (Qₑ: adsorption capacity; Cₑ: solution concentration at equilibrium), according to an embodiment of the present disclosure;

FIGS. 3A-3G provide (3A) a TEM and (3B-3G) HAADF-STEM/EDS images of carbon nanotubes pyrolyzed with sulfamethoxazole (SMX) (CNT-SMX-250), according to an embodiment of the present disclosure.

FIGS. 4A-4D graphically illustrates (4A) Ni X-ray absorption near edge structure (XANES) spectra, (4B) Fourier transformation of the Ni extended X-ray absorption fine structure (EXAFS) spectra, (4C) Fe XANES, and (4D) Fourier transformation of the Fe EXAFS spectra of CNT-SMX-250 and standard references, according to embodiments of the present disclosure;

FIGS. 5A-5C graphically illustrate (5A) CO Faradaic efficiency, (5B) total current density, and (5C) CO partial current density on CNT-SMX-X and CNT-HT in 0.5 M KHCO₃, according to embodiments of the present disclosure;

FIGS. 6A-6B graphically illustrate (6A) CO selectivity and potential between the cathode and reference electrode, (6B) product selectivity of CNT-SMX-250 in the flow cell at 100 mA/cm², according to embodiments of the present disclosure;

FIGS. 7A-7C provide (7A) Atomistic structure of proposed FeN₄@Ni model, where the dashed line represents the periodic boundary of the model, and a calculated free energy evolution of (7B) CO₂RR at the electrode potential of 0 V and (7C) HER at the electrode potential of 0 V on the modeled FeN₄ sites; according to embodiments of the present disclosure;

FIG. 8 graphically illustrates SMX adsorption on CNTs as a function of time, according to an embodiment of the present disclosure;

FIGS. 9A and 9B are SEM images of (9A) CNT and (9B) CNT-SMX-250, according to embodiments of the present disclosure;

FIGS. 10A and 10B are TEM images of (10A) CNT and (10B) CNT-SMX-250; according to embodiments of the present disclosure;

FIG. 11 is a TEM image of CNT-SMX-250, according to an embodiment of the present disclosure;

FIG. 12 graphically illustrates energy dispersive spectroscopy (EDS) element mapping of the square area (nanoparticle) in FIG. 3B, according to an embodiment of the present disclosure;

FIGS. 13A-13C are (13A) STEM, (13B) HR-TEM, and (13C) EDS images of raw CNTs, according to embodiments of the present disclosure;

FIGS. 14A and 14B graphically illustrate (14A) BET isotherm and (14B) pore size distribution of CNT and CNT-SMX-250, according to embodiments of the present disclosure;

FIG. 15 is N is spectra of CNT-SMX-250, according to an embodiment of the present disclosure;

FIG. 16 is a high-resolution S 2p XPS spectra for CNT-SMX-250; according to an embodiment of the present disclosure;

FIG. 17 is a high-resolution XPS images of N is in CNT, CNT-SMX-250, and CNT-Mel-250, according to an embodiment of the present disclosure;

FIGS. 18A and 18B are high-resolution XPS spectra of (18A) Fe and (18B) Ni in CNT and CNT-SMX-250, according to an embodiment of the present disclosure;

FIG. 19 is XRD spectra of CNT, CNT-SMX-250, and standards, according to embodiments of the present disclosure;

FIGS. 20A and 20B are (20A) Nyquist plots at −0.76 V vs. RHE and (20B) equivalent circuit of the cathode compartment of the H-cell, where R_{S} is the solution resistance, R_{Ω} is the ohmic resistance and R_{CT} is the charge transfer resistance. Q₁ and Q₂ represent the constant phase element, according to embodiments of the present disclosure;

FIG. 21 graphically illustrates double-layer capacitance C_{dl} (the slope) of CNT-HT and CNT-SMX-250, according to embodiments of the present disclosure;

FIGS. 22A and 22B are cyclic voltammograms curves performed at various scan rates (10, 20, 40, 50, 60, 80 and 100 mV/s) on (22A) CNT-HT and (22B) CNT-SMX-250, according to embodiments of the present disclosure;

FIG. 23 graphically illustrates CO and H₂ concentration in the effluent of the flow cell at different current densities using CNT-SMX-250 as the catalyst, according to embodiments of the present disclosure;

FIGS. 24A and 24B graphically illustrate (24A) Faradaic efficiency of CO and (24B) CO partial current density of samples with different nitrogen doping, according to embodiments of the present disclosure;

FIGS. 25A and 25B graphically illustrate (25A) Faradaic efficiency of CO and (25B) CO partial current density of samples in poisoning experiments, according to embodiments of the present disclosure;

FIGS. 26A and 26B graphically illustrate (26A) Faradaic efficiency of CO and (26B) CO partial current density of CNT-SMX-250 with and without post acid washing, according to embodiments of the present disclosure;

FIGS. 27A and 27B graphically illustrate (27A) Faradaic efficiency of CO and (27B) CO partial current density of CNT-SMX-250 and CNT-Mel-addFe, according to embodiments of the present disclosure;

FIGS. 28A-28C are illustrations of optimized adsorption configuration of H (28A), CO (28B), and COOH (28C) on FeN₄@Ni, according to embodiments of the present disclosure;

FIGS. 29A-29I are (29A) TEM, (29B) HR-TEM, (29C) HAADF-STEM image and elemental mapping images of (29D) Fe, (29E) Ni, (29F) N, (29G) C, (29H) O of CNT-Mel, and (29I) high resolution HAADF-STEM images of the CNT branch of CNT-Mel, according to embodiments of the present disclosure;

FIGS. 30A-30D graphically illustrate (30A) Fe XANES, (30B) Ni XANES, and Fourier transform of the (30C) Fe EXAFS spectra and (30D) Ni EXAFS spectra of Raw-CNT, CNT-Mel, and standard references, according to embodiments of the present disclosure;

FIGS. 31A-31C graphically illustrate (31A) Faradaic efficiency of CO, (31B) current density, and (31C) CO partial current density of CNT-Mel, nitrogen-free control sample CNT-Heat and Raw-CNT in H-Cell testing (Electrolyte: 0.5 M KHCO₃), according to embodiments of the present disclosure;

FIGS. 32A-32D graphically illustrate product selectivity and cathode potential of CNT-Mel tested at different current densities in varied CO₂ partial pressures in the flow cell (Electrolyte: 1 M KOH), according to embodiments of the present disclosure;

FIGS. 33A and 33B graphically illustrate (33A) product selectivity of CNT-Mel stability tests at different CO₂ partial pressures and (33B) comparison of CNT-Mel with the benchmark catalyst Ag NP in flow cell testing (Electrolyte: 1 M KOH; Current density: 100 mA/cm²), according to embodiments of the present disclosure;

FIGS. 34A-34F graphically illustrate (34A) Faradaic efficiency, (34B) total current density, and (34C) CO current density of catalysts synthesized from different nitrogen precursors; (34D) Faradaic efficiency, (34E) total current density, and (34F) CO current density of catalysts synthesized from different CNT vendors, all in H-Cell testing (Electrolyte: 0.5 M KHCO₃), according to embodiments of the present disclosure;

FIGS. 35A-35C graphically illustrate CO₂RR performance of (35A) CNT-Mel-100 mg, (35B) CNT-Mel-500 mg, and (35C) CNT-Mel-10 g in the flow cell (Electrolyte: 1 M KOH), according to embodiments of the present disclosure;

FIGS. 36A-36F are TEM images of (36A and 36B) Raw-CNT, (36C and 36D) CNT-Mel, and (36E and 36F) CNT-Heat, according to embodiments of the present disclosure;

FIGS. 37A-37H are (37A) HAADF-STEM image, elemental mapping images of (37B) C, (37C) Fe, (37D) Ni, (37E) O, (37F) N of Raw-CNT, and (37G and 37H) high-resolution STEM image of Raw-CNT, according to embodiments of the present disclosure;

FIG. 38 graphically illustrates XRD spectra of Raw-CNT, CNT-Heat, and CNT-Mel, according to embodiments of the present disclosure;

FIGS. 39A-39C graphically illustrate XPS N is spectra and fitting of CNT-Mel synthesized at different temperature: (39A) 650° C., (39B) 800° C., and (39) 950° C., according to embodiments of the present disclosure;

FIGS. 40A-40C graphically illustrate (40A) Faradaic efficiency of CO, (40B) total current density, and (40C) partial CO current density of CNT-Mel from different synthesis temperature in H-Cell (Electrolyte: 0.5 M KHCO₃), according to embodiments of the present disclosure;

FIGS. 41A-41C graphically illustrate (41A) Faradaic efficiency of CO, (41B) total current density, and (41C) CO current density of CNT-Mel and plain carbon paper in H-Cell (Electrolyte: 0.5 M KHCO₃), according to embodiments of the present disclosure;

FIGS. 42A-42C graphically illustrate (42A) Faradaic efficiency of CO, (42B) current density, and (42C) CO partial current density of CNT-Mel and poisoning samples by EDTA and KSCN (0.05 M EDTA or KSCN in 0.5 M KHCO₃ electrolyte) in H-Cell, according to embodiments of the present disclosure;

FIGS. 43A-43C graphically illustrate (43A) Faradaic efficiency of CO, (43B) current density, and (43C) CO partial current density of CNT-Mel and CNT-Mel-acid in H-Cell (Electrolyte: 0.5 M KHCO₃), according to embodiments of the present disclosure, FIGS. 44A-44C graphically illustrate (44A) Faradaic efficiency of CO, (44B) current density, and (44C) CO partial current density of CNT-Mel and Pure-CNT-Mel in H-Cell (Electrolyte: 0.5 M KHCO₃), according to embodiments of the present disclosure;

FIGS. 45A and 45B graphically illustrate cathode potential (without iR compensation) during stability test: (45A) different CO₂ partial pressure and (45B) comparison to Ag NP (Cell Configuration: flow cell; Electrolyte: 1 M KOH; Current density: 100 mA/cm²), according to embodiments of the present disclosure;

FIG. 46 illustrates a one batch synthesis of approximately 10 g (150 ml) of CNT-Mel, according to embodiments of the present disclosure; and FIGS. 47A-47C graphically illustrate (47A) Faradaic efficiency, (47B) total current density, and (47C) CO current density of CNT-Mel-100 mg, CNT-Mel-500 mg, and CNT-Mel-10 g in the H-Cell (Electrolyte: 0.5 M KHCO₃), according to embodiments of the present disclosure.

### DETAILED DESCRIPTION

In various aspects, the present disclosure provides heteroatom-doped carbon nanotubes, catalytic electrodes, reactors, methods of making heteroatom-doped carbon nanotubes, and methods of reducing a reactant of a reaction catalyzed by heteroatom-doped carbon nanotubes according to embodiments of the present disclosure.

### Heteroatom-Doped Carbon Nanotubes

In one aspect, the disclosure provides heteroatom-doped carbon nanotubes useful as an electrocatalyst to convert carbon dioxide to carbon monoxide. In certain embodiments, the heteroatom-doped carbon nanotube comprises single atomic metal-nitrogen-carbon (M-N—C) sites for use as an electrocatalyst to convert carbon dioxide to carbon monoxide. As discussed further herein, the heteroatom-doped carbon nanotubes of the present disclosure include atoms other than and in addition to carbon. In certain embodiments, the heteroatom-doped carbon nanotubes of the present disclosure comprise atoms, molecules, or particles comprising, for example, but not limited to Fe and Ni. In certain embodiments, the heteroatom-doped carbon nanotube comprises single atomic Fe—N bonds as the active sites. In certain of these embodiments, the Fe—N bonds are the major M-N—C sites. Other M-N bonds can include bonds with transition metals such as Ni, Co, Mn, Cr, and Cu.

In an embodiment, the single atomic Fe—N bonds are active sites configured to reduce a certain molecule. In an embodiment, the single atomic Fe—N bonds are active sites configured to convert carbon dioxide to carbon monoxide. While reducing carbon dioxide to carbon monoxide is discussed further herein, it will be understood that the heteroatom-doped carbon nanotubes of the present disclosure are also suitable for and configured to catalytically convert other molecules, such as oxygen (e.g., O₂), nitrogen (e.g., N₂, nitrate, nitrite), and the like.

In an embodiment, Fe in the single atomic Fe—N bonds is in a positive oxidation state, such as may be determined or confirmed by high-resolution X-ray photoelectron spectroscopy (XPS). In an embodiment, Fe in the single atomic Fe—N bonds comprises an oxidation state in a range of 0 and 3 as determined by high-resolution XPS. Such positive oxidation state can be confirmation of or an indication of formation of Fe—N bonds, which are configured to convert, for example, carbon dioxide to carbon monoxide.

In an embodiment, the heteroatom-doped carbon nanotube further comprises one or more Ni metal nanoparticles. In an embodiment, the Ni metal nanoparticles are disposed in joints of the heteroatom-doped carbon nanotube. In an embodiment, the Ni metal nanoparticles are encapsulated by graphitic carbon layers of the heteroatom-doped carbon nanotube.

In an embodiment, and without being bound to any particular theory, the Ni metal nanoparticles are configured to convert carbon dioxide to carbon monoxide synergistically with the single atomic M-N—C sites. As discussed further herein, density functional theory (DFT) calculations show that the single atomic Fe—N bonds act synergistically with the Ni metal nanoparticles to reduce a molecule, such as by converting carbon dioxide to carbon monoxide.

In an embodiment, the carbon nanotube is a multi-walled carbon nanotube. While multi-walled carbon nanotubes are discussed further herein, it will be understood that other forms of carbon nanotubes (such as single-walled carbon nanotubes) can be used and are within the scope of the present disclosure.

In an embodiment, the metals from the single atomic MNC sites are residual metals, such as residual Fe and/or Ni from processes used to manufacture the carbon nanotubes used as source materials. In this regard, in certain embodiments, metals are used to catalytically manufacture carbon nanotubes and residual metal may remain after manufacturing.

Without wishing to be bound by any particular theory, it is believed that metal atoms, such as single Fe atoms, sit in defect sites of the heteroatom-doped carbon nanotube. In an embodiment, the active sites are disposed on an outer surface of the heteroatom-doped carbon nanotube, such that, for example, they are positioned to react with and reduce a molecule, such as by converting carbon dioxide to carbon monoxide.

In an embodiment, the heteroatom-doped carbon nanotube comprises a specific surface area in a range of about 100 m²/g and about 200 m²/g as measured by Brunauer-Emmett-Teller (BET) measurement. In an embodiment, the heteroatom-doped carbon nanotube comprises a specific surface of about 190 m²/g, 180 m²/g, 170 m²/g, 160 m²/g, 150 m²/g, 140 m²/g, 130 m²/g, 120 m²/g, 110 m²/g, as measured by BET measurement. In an embodiment, the heteroatom-doped carbon nanotube comprises a specific surface area of about 170 m²/g as measured by BET measurement. Without wishing to be bound by any particular theory, the methods of forming Fe—N bonds creates rough defects and more porous surfaces than pristine carbon nanotubes, providing a surface area in the heteroatom-doped carbon nanotubes of the present disclosure that is greater than the pristine carbon nanotubes.

In certain embodiments, the heteroatom-doped carbon nanotube has an efficient CO₂ reduction performance with a CO Faradaic efficiency greater than 90% from −0.6 to −0.8 V vs. RHE for CO₂ reduction as measured in a H-Cell.

In certain embodiments, the heteroatom-doped carbon nanotube has an efficient CO₂ reduction performance with a 13-15 mA/cm² of CO partial current density at −0.8 V vs. RHE as measured in an H-Cell.

In certain embodiments, the heteroatom-doped carbon nanotube has an efficient CO₂ reduction performance with a CO selectivity greater than 90% at a current density in the range of 50-500 mA/cm² as measured in a flow cell.

In certain embodiments, the heteroatom-doped carbon nanotube has a stable CO₂ reduction performance maintaining 99% CO selectivity for 45 hours at a fixed current density of 100 mA/cm².

### Catalytic Electrodes

In another aspect, the present disclosure provides a catalytic electrode, such as for reducing a molecule. In an embodiment, the catalytic electrode comprises a heteroatom-doped carbon nanotubes according to any embodiment of the present disclosure.

In an embodiment, the catalytic electrode comprises an electrode, such as a carbon electrode, and a heteroatom-doped carbon nanotubes according to any embodiment of the present disclosure disposed on a surface of the carbon electrode.

The heteroatom-doped carbon nanotubes may be applied to the electrode with any deposition or adherence method, such as by dip coating, spin coating, spray coating, drop casting,

As discussed further herein with respect to reactors according to the present disclosure, the catalytic electrodes of the present disclosure may be used in reactor, such as for reducing a molecule.

### Reactor

In another aspect, the present disclosure provides a reactor, such as to catalytically reduce carbon dioxide to provide carbon monoxide. In an embodiment, the reactor comprises a catalytic electrode as described with respect to other aspects of the present disclosure. In this regard, the catalytic electrode comprises a heteroatom-doped carbon nanotubes according to any embodiment of the present disclosure or made according to any methods of the present disclosure.

In an embodiment, the reactor comprises a first fluid compartment; a second fluid compartment; an ion exchange membrane fluidically separating the first fluid compartment and the second fluid compartment and configured to allow passage of ions therethrough; a first electrode in electrically conductive communication with an interior portion of the first fluid compartment; and the catalytic electrode according to any embodiment of the present disclosure in electrically conductive communication with an interior portion of the second fluid compartment.

In an embodiment, the ion exchange membrane is a Nafion membrane. In an embodiment, the ion exchange membrane is an anion exchange membrane.

In an embodiment, the ion exchange membrane is configured to allow passage of dissolved ions through the membrane, but to block passage of, for example, certain other ions, such as on the basis of charge, or neutral molecules also dissolved in a common solvent.

In an embodiment, the first fluid compartment and/or the second fluid compartment contain or carry a KHCO₃ solution comprising dissolved CO₂. In an embodiment, the first fluid compartment and/or the second fluid compartment contain or carry a KOH solution comprising dissolved CO₂.

### Methods of Making Heteroatom-Doped Carbon Nanotubes

In another aspect, the disclosure provides methods for making the heteroatom-doped carbon nanotubes described herein.

In certain embodiments, the method for making heteroatom-doped carbon nanotubes having M-N—C sites for use as an electrocatalyst to convert carbon dioxide to carbon monoxide, comprises pyrolyzing a mixture, such as a solid or dry mixture, of a solid nitrogen precursor and carbon nanotubes having intrinsic metal impurities (single atomic metal-nitrogen-carbon (M-N—C) sites) at a temperature and for a time sufficient to provide a heteroatom-doped carbon nanotube catalyst having M-N—C sites effective for electrochemical carbon dioxide reduction.

In certain embodiments, the solid nitrogen precursor is organic nitrogen-containing compound. In certain of these embodiments, the solid nitrogen precursor is selected from the group consisting of urea, melamine, dicyandiamide, or other short-chain nitrogen containing species such as thiourea.

In an embodiment, the mixture of the solid nitrogen precursor and the carbon nanotubes has a mass in a range of about 0.01 g to about 10 kg, in a range of about 1 g to about 5 kg, in a range of about 1 g to about 1 kg, in a range of about 1 g to about 100 g, or in a range of about 1 g to about 10 g. While particular mixture masses are described, it will be understood that the methods described herein are generally scalable to produce desired quantities of heteroatom-doped carbon nanotubes as described herein, such as commercially useful quantities of such heteroatom-doped carbon nanotubes.

In an embodiment, the method includes preparing the mixture of solid nitrogen precursor and the carbon nanotube having intrinsic metal impurities. In an embodiment, such preparation comprising pulverizing or mixing the components, such as in a mortar and pestle and the like.

In other embodiments, the method for making a heteroatom-doped carbon nanotubes having M-N—C sites for use as an electrocatalyst to convert carbon dioxide to carbon monoxide, comprises (a) contacting a solution comprising nitrogen precursors with carbon nanotubes comprising intrinsic metal impurities, whereby the carbon nanotubes adsorb nitrogen precursors from the solution to provide a suspension comprising organic-adsorbed carbon nanotubes comprising metal sites and adsorbed nitrogen precursors; (b) separating the organic-adsorbed carbon nanotubes from a solvent of the suspension to provide a mixture including the organic-adsorbed carbon nanotubes, (c) drying the mixture to provide a carbon nanotubes comprising metal sites and adsorbed nitrogen precursors; and (d) pyrolyzing the carbon nanotubes comprising metal sites and adsorbed nitrogen precursors at a temperature and for a time sufficient to provide a heteroatom-doped carbon nanotube catalyst comprising M-N—C sites effective for electrochemical carbon dioxide reduction. In certain embodiments, the nitrogen precursors are organic nitrogen-containing compounds (preferably with an aromatic ring structure or other extended conjugated network of bonds that provides a strong interaction between the nitrogen precursors and the carbon nanotubes). An example of such a method is schematically illustrated in FIG. 1.

In certain embodiments, the solution containing nitrogen precursors is an organic solution. In certain of these embodiments, the organic solution is either a synthetic solution or a waste solution (e.g., as found in real world situation, such as an industrial waste or a pharmaceutical waste), each containing dissolved organic nitrogen-containing compounds. In certain embodiments, the organic nitrogen-containing compound is selected from the group consisting of sulfamethoxazole (SMX), methylene blue (MB), and methylene orange (MO) (or other nitrogen-containing organics with aromatic ring structure).

Regarding nitrogen precursor selection, the use of traditional nitrogen sources such as urea and melamine conventionally includes an excess amount to guarantee sufficient doping, making it a less sustainable synthesis. In contrast, common pharmaceutical products (e.g., sulfamethoxazole (SMX)), which also contain nitrogen elements, have been demonstrated to have a strong interaction with carbon materials in water due to π-π bonding. In certain embodiments, such as when using a solution containing the nitrogen precursor and CNT, this can make these materials better candidates as M-N—C nitrogen precursors than traditional smaller nitrogen-containing molecule (e.g., urea, melamine, etc.) because they uniformly bond throughout the carbon surface, thus having a larger chance during pyrolysis to react with the metal impurities found in CNT and form M-N active sites. In addition, the over treatment of livestock with these antibiotics has led to an increase of pharmaceutical wastes in water sources as well as existing as solid wastes. Notably, these organics also contain elements such as S, Cl, or F, which were demonstrated to boost the activity of M-N—C catalysts further. The utilization of these organics as heteroatom dopants could not only enhance the cost-effectiveness of M-N—C synthesis, but also potentially contributes to the waste treatment of water or landfills.

In an embodiment, a wt:wt ratio of carbon nanotube to nitrogen precursor is in a range of about 10:1 to about 1:100, in a range of about 1:1 to about 1:1000, in a range of about 1:1 to about 1:100, in a range of about 1:1 to about 1:10, or about 1:1.

Regarding the methods described herein above, in certain embodiments, the heteroatom-doped carbon nanotube having metal sites is derived from its intrinsic metal impurities (e.g., no additional metal is added and no additional treatment is needed to increase the number of metal sites). The metal impurities often found in CNTs from the industrial synthesis can be utilized as the metal precursors for the M-N—C catalyst, eliminating the additional metal requirement and post-pyrolysis acid-washing. This makes the commercial CNTs a potential candidate to be directly applied in a ‘greener’ synthesis with fewer pollutant treating steps when given the suitable nitrogen precursors.

In certain of these embodiments, the heteroatom-doped carbon nanotube metal sites are residual sites from metals used as seeds to grow the carbon nanotubes. In certain embodiments, the carbon nanotube is a commercially available carbon nanotube.

In an embodiment, the carbon nanotube used as a source material has an intrinsic metal weight percent before pyrolization of about 10 wt % or less. In an embodiment, the carbon nanotube has an intrinsic metal weight percent before pyrolization in range of about 15 wt % to about 0.1 wt %, in range of about 10 wt % to about 0.1 wt %, in range of about 10 wt % to about 1 wt %, in range of about 10 wt % to about 5 wt %, or in range of about 15 wt % to about 10 wt %.

In an embodiment, the carbon nanotube has an intrinsic Fe weight percent of about 0.4 wt % and an intrinsic Ni weight percent of about 1.4 wt %.

In certain embodiments of the above methods, the pyrolysis temperature is from about 650° C. to about 950° C. In certain of these embodiments, the temperature is about 650° C. (e.g., for optimal catalyst performance). In certain of these embodiments, the temperature is less than 800° C. In certain of these embodiments, the time is from about 1 to about 6 hours (e.g., about 3 hours). In certain embodiments, the pyrolysis occurs in an inert atmosphere, such as in an inert gas comprising selected from Ar, N₂, and the like.

In an embodiment, metal sites of the heteroatom-doped carbon nanotube comprising metal sites are derived from its intrinsic metal impurities of the carbon nanotube. In an embodiment, the heteroatom-doped carbon nanotube metal sites are residual sites from metals used as seeds to grow the carbon nanotubes. In an embodiment, the intrinsic metal impurities comprise Fe and Ni impurities. As discussed elsewhere herein, in an embodiment, the Fe metal impurities form single atom Fe—N catalytic sites, whereas Ni metal impurities can form Ni metal nanoparticles, such as Ni metal nanoparticles disposed in joints of the heteroatom-doped carbon nanotubes or encapsulated by graphitic carbon layers of the heteroatom-doped carbon nanotube.

In another aspect, the present disclosure provides a heteroatom-doped carbon nanotube having M-N—C sites prepared by a method according to any aspect or embodiment of the present disclosure. In an embodiment, the methods of the present disclosure are suitable for or configured to prepare the heteroatom-doped carbon nanotubes according to the present disclosure.

### Methods for Using Heteroatmo-Doped Carbon Nanotubes

In a further aspect, the disclosure provides methods for using the heteroatom-doped carbon nanotubes described herein. In certain of these embodiments, the disclosure provides methods for electrochemically reducing a molecule, such as for reducing carbon dioxide to carbon monoxide, comprising contacting the molecule, such as carbon dioxide, with a heteroatom-doped carbon nanotube prepared as described herein.

In an embodiment, the heteroatom-doped carbon nanotube contacts the carbon dioxide in a reactor according to an embodiment of the present disclosure.

In certain embodiments, the method selectively reduces carbon dioxide to carbon monoxide over hydrogen production with above 90% CO selectivity at a current density in the range of 50-500 mA/cm² as measured in a flow cell.

While carbon dioxide is discussed herein as an example of a reactant, it will be understood that other reactants, such as oxygen (e.g., O₂) or nitrogen (e.g., N₂, nitrate, nitrite), are possible with the heteroatom-doped carbon nanotubes of the present disclosure and within the scope of the present disclosure. In this regard, the heteroatom-doped carbon nanotubes of the present disclosure are configured to catalyze several reactions, thus converting several sets of reactants to products.

### EXAMPLES

### Example 1: Heteroatom-Doped Carbon Nanotube Synthesis

The present Example describes synthesis and testing of (e.g., N₂) carbon nanotubes made according to embodiments of the present disclosure.

### Materials

SMX (Tokyo Chemical Industry, >98%) and melamine (Acros Organics, >99%) were purchased from VWR. All chemicals were used directly without any treatment.

### Smx Adsorption

SMX was in water to simulate an SMX wastewater in the concentration range of 20-250 ppm (or mg/L). Typically, 50 mg of commercial CNT were dispersed into 50 mL of a SMX solution (20-250 ppm) under stirring at 300 rpm and room temperature. At certain time intervals, 1 mL of solution was taken out for analysis. CNT powders with adsorbed SMX were filtered out by a 45 nm PTFE filter. The liquid samples were diluted by 100 times for HPLC detection of SMX. The adsorption capacity was calculated based on the following equation:

$${Q}_{e} = {V}_{O} * \frac{{C}_{O} - {C}_{C}}{{m}_{CNT}} \qquad ( 1 )$$

In this equation, V_{O} represents the volume of the organic solution, C_{O} is the original organic concentration, C_{C} is the current SMX concentration at the time the 1 mL sample was removed, and m_{CNT} is the mass of CNT.

The organic adsorption isotherm was plotted using the equilibrium organic concentration (Cₑ) as the x-axis and the adsorbed quantity (Qₑ) as the y-axis.

### Synthesis of Catalysts

### Cnt-Smx-X.

To begin 50 mg of commercial CNTs without treatment (denoted as CNT) was added to 50 mL of an X ppm SMX solution (X=20-250) and stirred at 300 rpm for 24 h. The CNT adsorbed with SMX was collected by centrifuging, pouring off the supernatant, and then dried at the 60° C. oven overnight. The dried powders were then pyrolyzed at 650° C. for 3 h under an Ar environment. The as-prepared powder was denoted as CNT-SMX-X.

### Cnt-Ht.

The control sample CNT-HT was synthesized by pyrolyzing 50 mg of CNT at 650° C. for 3 h under an Ar environment.

### CNT-Mel-250.

To compare the nitrogen doping level on CNT between SMX and the traditional precursor (melamine is selected in this work), CNT-Mel-250 was prepared using the same method except replacing 250 ppm of SMX solution by 250 ppm of melamine.

### CNT-Mel-Excessive.

To achieve a similar nitrogen doping level and CO₂RR performance using melamine as the nitrogen precursor to that from SMX, excess amount of melamine was used with similar carbon/nitrogen precursor weight ratio to the literature (at least 1:10). Typically, 50 mg of CNT and 500 mg of melamine were dispersed in 20 mL DI water. The water was then fully evaporated on a hotplate at 60° C. The as-mixed power was then transferred to a tube furnace and pyrolyzed at 650° C. for 3 h under an Ar environment. The as-synthesized sample is denoted as CNT-Mel-excessive.

### Adsorption Isotherm Models:

$$\begin{matrix}Freundlich isotherm & \\ {Q}_{e} = {K}_{f} {C}_{e}^{\frac{1}{nf}} & ( S - 1 )\end{matrix}$$

$$\begin{matrix}Langmuir isotherm & \\ {Q}_{e} = \frac{{Q}_{m} {K}_{L} {C}_{e}}{1 + {K}_{L} {C}_{e}} , {R}_{L} = \frac{1}{1 + {K}_{L} {C}_{0}} & ( S - 2 )\end{matrix}$$

$$\begin{matrix}Temkin isotherm & \\ {Q}_{e} = \frac{RT}{{b}_{T}} ln ( {K}_{T} {C}_{e} ) & ( S - 3 )\end{matrix}$$

Qₑ: adsorption capacity (mg/g) at equilibrium time.
Cₑ: equilibrium concentration at liquid phase (mg/L)
K_{f}: distribution coefficient (mg/g), it implies that the energy of adsorption on a homogeneous surface is independent of surface coverage.

$$\frac{1}{nf} :$$

related to the surface heterogeneity, closer to zero means more heterogenous surface.
Qₘ: maximum adsorption capacity (mg/g) from monolayer adsorption.
K_{L}: Langmuir constant (L/g) describing the adsorption/desorption equilibrium for each reactant in contact with a surface.
R_{L}: separation constant: the adsorption is irreversible R_{L}=0, favorable 0<R_{L}<1, linear R_{L}=1, and unfavorable R_{L}>1.
R: universal gas constant (8.314 J/mol·K).
T: temperature in Kelvin.
b_{T}: Temkin constant (J/mol), defined as variation of adsorption energy; the adsorption is exothermic b_{T}>1 or endothermic if b_{T}<1.
K_{T}: equilibrium bond constant related to maximum energy of bond (mg/L).

### Product Selectivity Calculation

The Faradaic efficiency (FE) of gaseous products in H-cell setup at each applied potential was calculated based on the equation:

$$FE = \frac{z \cdot P \cdot F \cdot V \cdot {v}_{i}}{R \cdot T \cdot J}$$

Where z is the number of electrons transferred per mole of gas product (z is 2 for CO and H₂), P is pressure (1.01×10⁵ Pa), F is Faraday constant (96500 C mol⁻¹), V is the gas volumetric flow rate (5.67×10⁻⁷ m³/s), vi is the volume concentration of gas product determined by GC, R is the gas constant (8.314 J/mol·K), T is the temperature (298.15 K), and J is the steady-state current at each applied potential (A).

The product selectivity in the flow cell is calculated based on the product concentration normalization in the downstream outlet gas mixtures.

### Computational Methods

Spin-polarized density functional theory (DFT) calculations with a plane-wave basis set were performed using the Vienna ab initio simulation package (VASP). The energy cutoff of plane wave basis set was set as 500 eV for plane wave expansion. Electronic exchange and correlation term was described by generalized gradient approximation (GGA) of the revised Perdew, Burke and Ernzernhof (RPBE) functionals. Projector augmented wave (PAW) pseudopotential was used to describe the core electrons. During structure optimization, the atomic positions were allowed to relax until the force on each ion fell below 0.02 eV Å⁻¹. A p(4×4) Ni(111) cell containing four layers of Ni atoms was used to model the encapsulated Ni nanoparticles and the top two layers of Ni atoms were allowed to relax during structure optimization calculations. The FeN₄ active site was constructed by substituting two carbon atoms with one Fe atom and four carbon atoms with four nitrogen atoms in a p(4×4) graphene layer. A vacuum layer of 14 Å thickness was added perpendicularly to the surface to minimize the interaction between periodic images. The Brillouin Zone was sampled using a gamma-centered scheme with 3×3×1 k-point mesh for all calculations. The computational hydrogen electrode (CHE) was used to calculate the free energy of each intermediate state from reactants to products. The free energy of a chemical reaction was calculated by

$$Δ G = Δ {E}_{DFT} + Δ {E}_{ZPE} + Δ {E}_{solv} + Δ {H}_{0 to T} - T Δ S$$

where ΔE_{DFT} is the energy change calculated by DFT, ΔE_{ZPE} is the zero-point energy correction, ΔEₛₒₗᵥ is the solvation energy correction, ΔH₀ to T is the reaction enthalpy change from 0 to T K, and ΔS is reaction entropy change. The solvation effect correction was 0.25 eV stabilization of COOH*, 0.1 eV stabilization of CO*. ZPE corrections were calculated as

$$ZPE = \sum \frac{1}{2} {hv}_{i} ,$$

where h is Planck's constant and vi is the frequency of the corresponding vibrational mode of binding molecules. ΔH_{0 to T} was calculated by the vibrational heat capacity integration ∫₀^{t} Cₚ dT.

### Example 2: Characterization of Heteroatom-Doped Carbon Nanotubes

The present Example describes characterization of heteroatom-doped carbon nanotubes made in Example 1.

### Morphology, Structure, and Composition of the Catalysts

Morphology, structure, and composition of the catalysts were characterized by scanning electron microscopy (SEM, JEOL JSM7500F), transmission electron microscopy (TEM, FEI Tecnai G2 F20 ST), Brunauer-Emmett-Teller (Micromeritics ASAP 2420 physisorption analyzer), high-angle angular dark-field scanning transmission electron microscopy (FEI 200 kV Titan Themis), X-ray diffraction (XRD, BURKER D8), and X-ray photoelectron spectroscopy (XPS, Omicron. The X-ray absorption spectroscopy (XAS) measurements were performed at the 12-BM beamline of the Advanced Photon Source (APS) at the Argonne National Laboratory (ANL).

### Measurement of the Smx Concentration

The concentration of SMX was measured by high-performance liquid chromatography (HPLC-2030C, Shimadzu) equipped with a reversed-phase C18 column in the low-pressure gradient mode. A mixture of deionized water, acetonitrile, and 25 mM of formic acid was used as the mobile phase at a flow rate of 1 mL/min.

### Electrochemical CO₂RR Activity Measurements

Two types of cells were used in this work to evaluate the CO₂RR performance. A traditional H-Cell was used to conduct electrochemical characterizations and study fundamental catalytic performance-structure correlations. A flow cell setup was used to analyze the scale-up potentials of the catalyst while operating at higher current densities.

### H-Cell

The traditional H-Cell contains two compartments, separated by a proton exchange membrane (Nafion 115 membrane, Beantown Chemical, 0.125 mm thick). It is a three-electrode system, comprising of a working electrode and a reference electrode (Ag/AgCl, 3 M KCl) in the cathode chamber, and a counter electrode (1 cm×1 cm Pt foil) in the anode chamber. The electrolyte is the CO₂-saturated 0.5 M KHCO₃ solution. The measured potentials after iR compensation are rescaled to the reversible hydrogen electrode by E (RHE)=E (Ag/AgCl)+0.210 V+0.0591 V×pH. The working electrode is prepared by drop-casting the catalyst onto a Toray carbon paper with an active catalytic geometric area of 1 cm². The catalyst ink is prepared by dispersing 3 mg of catalysts in a mixture of 370 μL of ethanol, 200 μL of water, and 30 μL of 5% Nafion solution under sonication for 3 h. High-purity CO₂ (99.999%, Airgas) at a flow rate of 30 standard cubic centimeters per minute (secm) is introduced in the cathode chamber for 30 min to fully saturate the catholyte and the flow rate is maintained throughout the test. The products are analyzed via an online gas chromatograph (GC, Fuel Cell GC-2014ATF, Shimadzu) equipped with a thermal conductivity detector (TCD) and a methanizer-assisted flame ionization detector (FID).

### Flow Cell

A customized flow cell electrolyzer is used to evaluate the feasibility of applying the catalyst at commercially viable current densities. The flow cell has two compartments separated by an anion exchange membrane (Fumasep PK 130, Fuel Cell Stores). Nickel foam is used as the anode for oxygen evolution reaction (OER) with an active geometric area of 1 cm², and the anolyte (1 M KOH) is circulated in the anode chamber (flow rate 10 mL/min) and removes the oxygen generated at the anode. The catholyte (1 M KOH) is circulated in the cathode chamber between the membrane and cathode at a flow rate of 1.5 mL/min. The cathode is prepared by airbrushing the catalyst ink (10 mg catalyst, 3 mL ethanol, 300 μL of 5% Nafion solution) onto the gas diffusion layer (GDL) (Sigracet 39 BC, Fuel Cell Store) with an active geometric area of 1 cm². The catalyst loading is about 1 mg/cm² based on the electrode weight gain after airbrushing. The CO₂ gas, circulated at the backside of the GDL, diffuses into the GDL, and reacts at the catalyst-electrolyte interface. A Hg/HgO electrode (1 M KOH) is used as the reference. The flow cell tests were powered by a DC power supply (Agilent E3633A) and the potential between the reference and cathode is measured by a multimeter (AidoTek VC97+). All the measured potentials were reported without iR compensation. The products in the flow cell systems are analyzed via an online gas chromatograph (GC, GC-2010, Shimadzu) equipped with a thermal conductivity detector (TCD) and flame ionization detector (FID). Both CO and H₂ are detected by the TCD, and methane and hydrocarbons are measured by the FID detector.

### Example 3: Results and Discussions

The present Example provides analysis of the performance of heteroatom-doped carbon nanotubes made in Example 1.

### Adsorption Kinetics and Isotherm

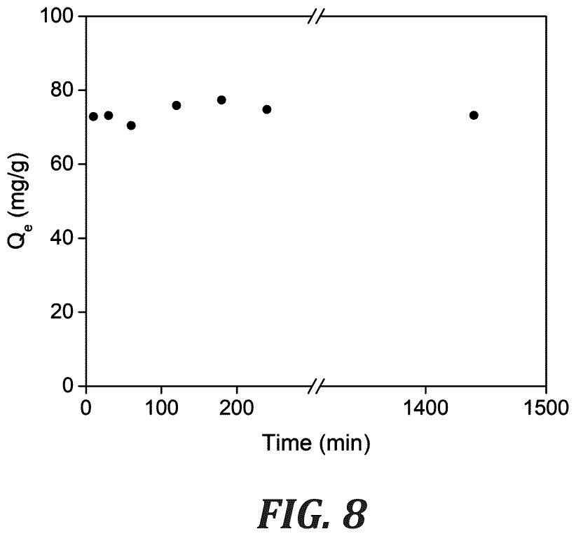

Detailed analysis of different organic adsorption characteristics by CNT was investigated. The adsorption kinetics were determined by the adsorption capacity of organics onto CNT via time. The adsorption capacity of CNT rapidly reached its maximum within 10 min as shown in FIG. 8 indicating the efficient and fast adsorption capability on commercial raw CNT.

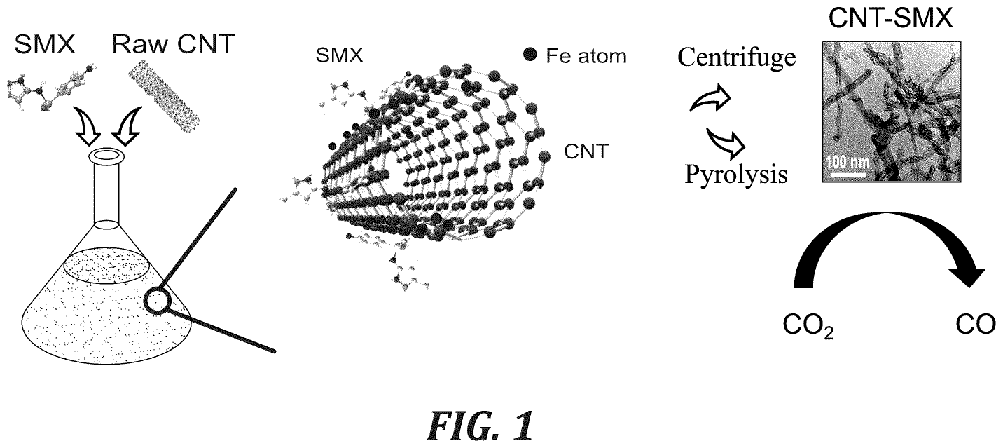

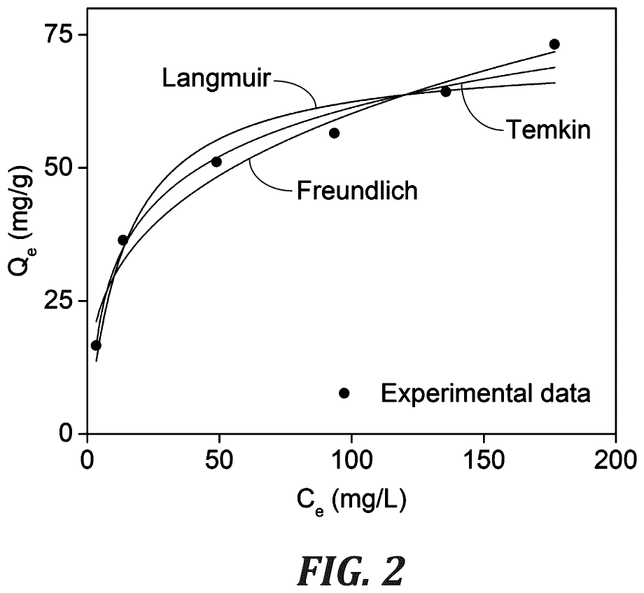

To further understand the interactions between organics and CNT, adsorption isotherms were carried out and fitted with multiple isotherm models. As revealed in FIG. 2 and Table 1, different models fit well to the experimental data. In particular, the Freundlich model was better fitted to the experimental results than Langmuir model, indicating a multilayer adsorption of SMX molecules onto the heterogeneous CNT surface. The efficient adsorption of SMX by CNT provides a good interaction between CNT and SMX, benefiting the following nitrogen doping step during pyrolysis.

TABLE 1
Organic adsorption isotherm fitting parameters.

| SMX Adsorption | Freudlich Model | Langmuir Model | Temkin Model |
|---|---|---|---|
| R² (%) | 97.3 | 94.8 | 98.2 |
| Fitting parameters | 1/n = 0.3 | | b_{T} = 187 |

### Material Characterization

Inductively coupled plasma mass spectrometry (ICP-MS) was first conducted to understand the concentrations of residual Fe and Ni remained from the industrial synthesis process in CNT, CNT-HT, and CNT-SMX-250. As revealed in Table 2, the precursor CNT has 0.4 wt. % and 1.0 wt. % of Fe and Ni, respectively. After adsorption and pyrolysis, the catalyst CNT-SMX-250 has 0.4 wt. % of Fe and 1.5 wt. % of Ni. The control CNT-HT has 0.3 wt. % of Fe and 1.7 wt. % of Ni, respectively. These results indicate that metals are preserved after the adsorption/pyrolysis processes.

TABLE 2
Elemental concentration measured by inductively
coupled plasma mass spectrometry (ICP-MS).

| Sample | Fe wt. % | Ni wt. % |
|---|---|---|
| CNT | 0.4 | 1.0 |
| CNT-HT | 0.3 | 1.7 |
| CNT-SMX-250 | 0.4 | 1.5 |

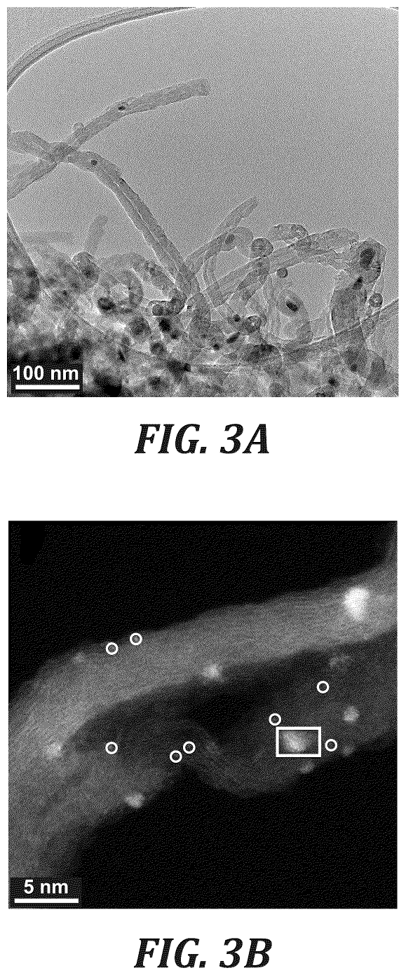

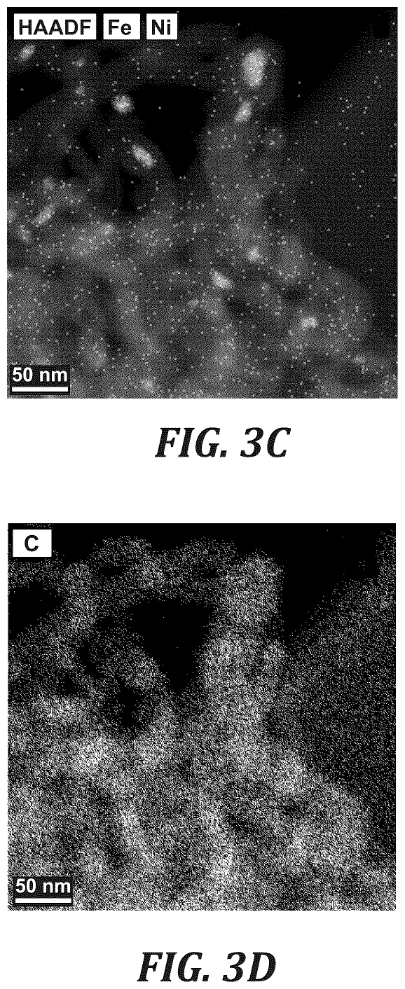

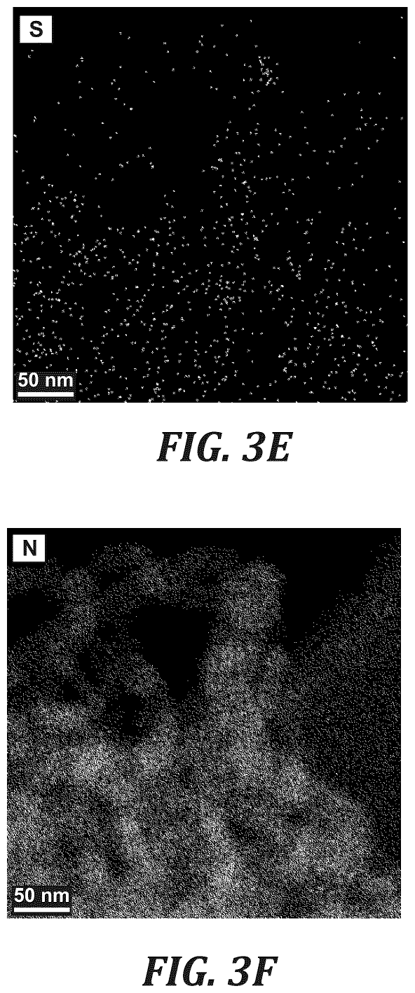

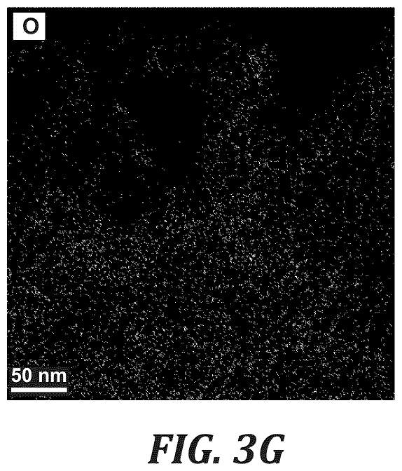

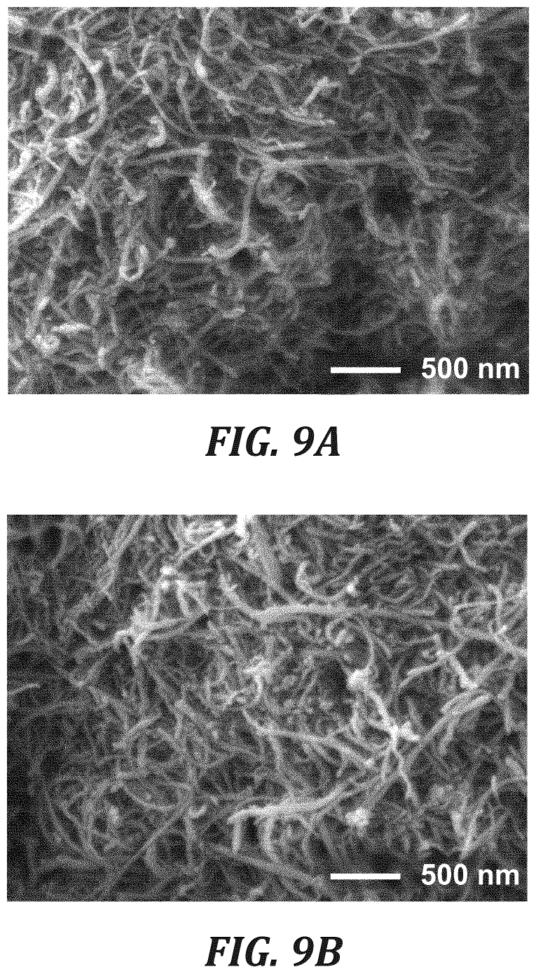

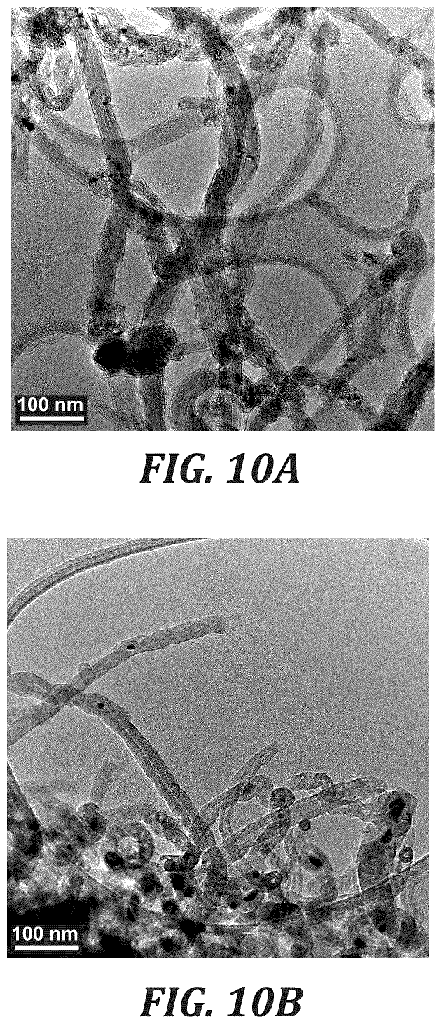

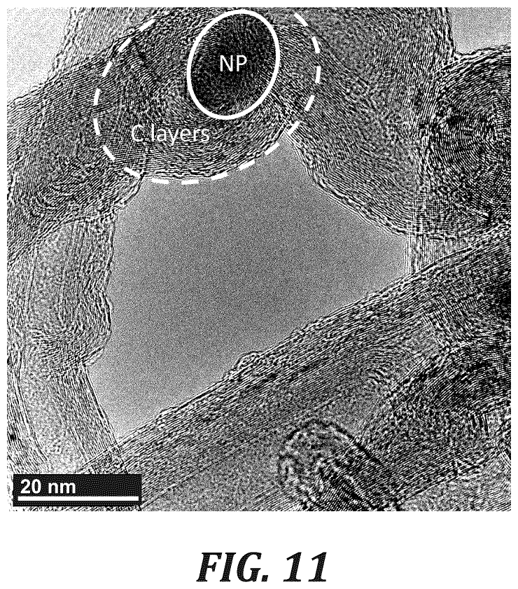

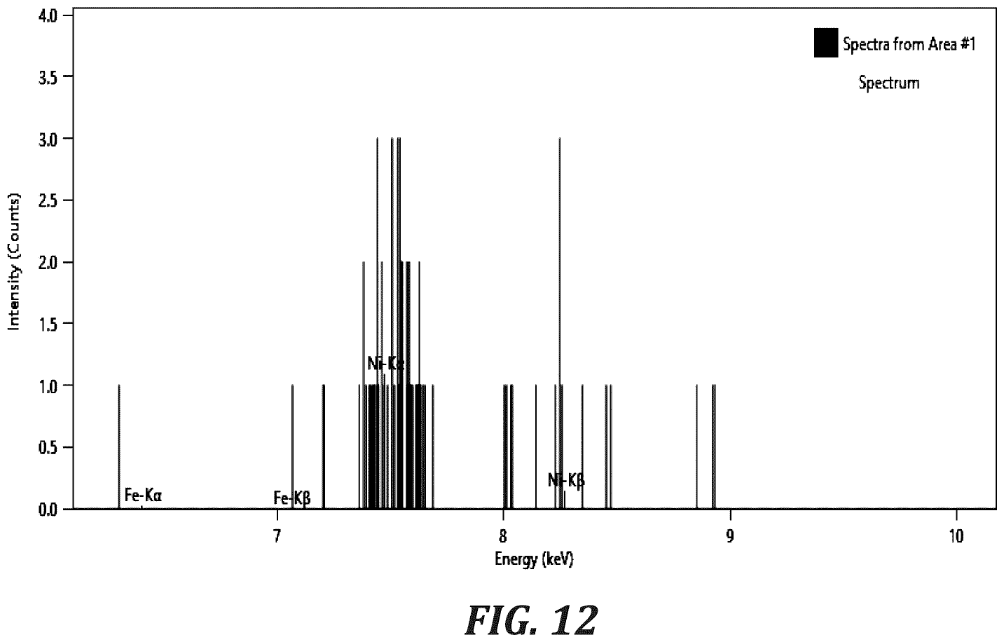

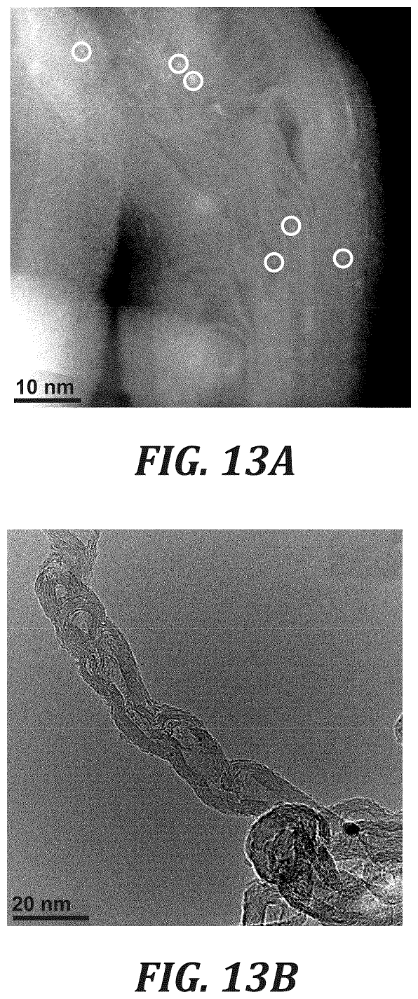

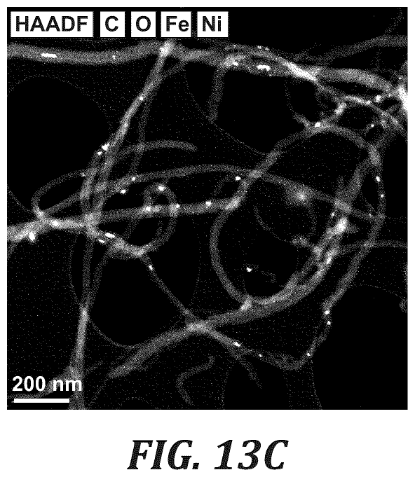

Multiple characterization techniques are used to further understand the material structure, morphology, and element composition. Firstly, scanning electron microscope (SEM) was carried out to determine the structure differences between CNT and CNT-SMX-250. From FIGS. 9A and 9B, all samples depict tube structures with similar diameters and lengths, indicating the structure of CNT well preserved after the pyrolysis. Transmission electron microscope (TEM) of CNT-SMX-250 (FIG. 3A) and CNT (FIGS. 10A and 10B) reveal a similar tube structure with nanoparticles being encapsulated at the joint of tubes. In FIG. 11, the encapsulation of a Ni nanoparticle by carbon layers is revealed by high-resolution TEM in CNT-SMX-250. As shown in FIG. 3B, high angle annular dark-field aberration-corrected scanning transmission electron microscopy (HAADF-STEM) reveals scattered bright spots, indicating the single atomic metal sites. Further energy dispersive spectroscopy (EDS) mapping (FIGS. 3C-3G) reveals uniform distribution of Fe elements, while Ni elements concentrated inside the tubes, forming nanoparticles. This indicates that the Fe sites more likely form smaller atomic sites while Ni elements exist in the system as nanoparticles. In particular, small nanoparticles could also be observed in the high-resolution STEM image (FIG. 3B). From the EDS spectrum to the red-square area of FIG. 3B, it is revealed that the nanoparticles comprise Ni elements primarily (FIG. 12). The STEM and EDS images of commercial CNTs are revealed in FIGS. 13A-13C. Bright dots are also observed from the precursor CNT indicating the existence of single atomic sites in the raw CNTs without treatment. Fe elements can form stable sites as isolated atoms on the defects of CNT surface while Ni elements are more likely to diffuse instantaneously and form aggregates. This is consistent with the EDS observation (FIG. 3C) where majority of Ni exist as nanoparticles in the system.

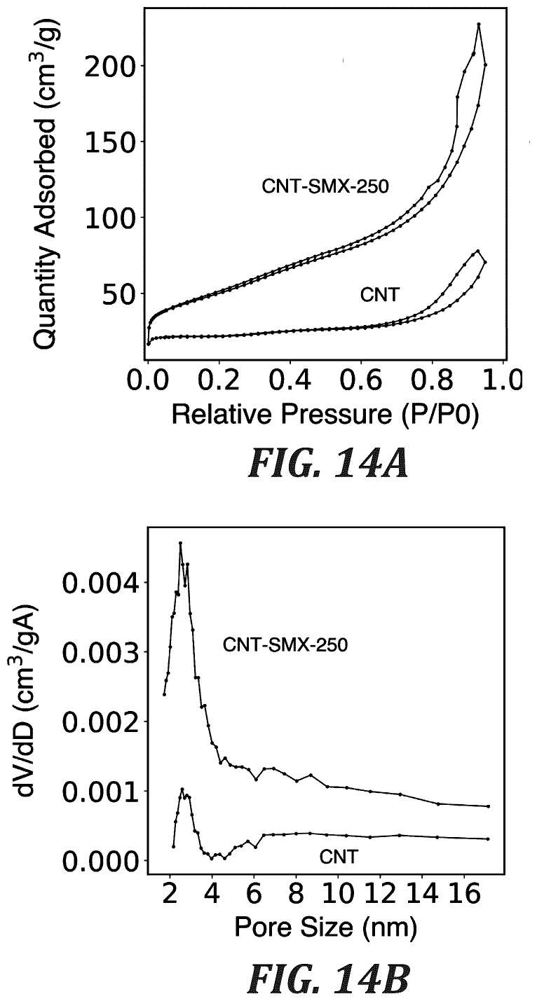

Brunauer-Emmett-Teller (BET) was conducted to determine the porosity and pore size distribution of CNT and CNT-SMX-250. As shown in FIGS. 14A and 14B, both CNT and CNT-SMX-250 reveal a distinct hysteresis loop in the larger pressure range (P/P0>0.5), corresponding to mesopores. CNT-SMX-250 also has a stronger absorption in the low relative pressure range (P/P0=0-0.1), indicating the existence of micropores. The BET specific surface area of CNT-SMX-250 is 170.6 m²/g, larger than that of CNT, 81.1 m²/g. It is likely due to the formation of metal and nitrogen doped sites on the CNT surface provided by the introduction of SMX, creating rough defects and more porous surfaces than the pristine CNTs. The pore size distributions of the two samples are similar with a major pore size in the mesopore range at around 3 nm.

To better understand the surface metal composition and distribution, X-ray photoelectron spectroscopy (XPS) was further conducted. Differing from the results of ICP, the surface concentrations of Ni and Fe do not show a similar trend. As depicted in Table 3, the Ni contents in all samples are extremely low, less than 0.05 at. %, indicating the Ni contents exist mostly as nanoparticles that are encapsulated by the carbon layers other than exposed on the surface, consistent with the STEM/EDS observation. The surface Fe content in the CNT is much larger than that of Ni, around 0.5 at. % vs. 0.05 at. %. This indicates that after the industrial process, larger quantities of Fe elements distribute on the surface, while Ni elements exist as nanoparticles encapsulated by graphitic carbon layers. This observation is consistent to the literatures, where Fe elements could form isolated atoms on the CNT surface while Ni elements tend to instantaneously form aggregates. This leads to a higher Fe concentration than that of Ni on the surfaces of CNT and CNT-SMX-250 even if Ni has higher bulk concentrations as detected by ICP-MS (Table 2). The surface Ni contents in both CNT and CNT-SMX-250 are less than 0.05 at. %, indicating Ni nanoparticles are encapsulated after pyrolysis, agreeing with the STEM/EDS observations. Combining TEM/ICP/XPS observations, the surface metal elements that exist in the system are primarily single atomic Fe while Ni elements mostly exist as nanoparticles encapsulated by the graphitic carbon layers.

TABLE 3
Elemental concentration measured by X-
ray photoelectron spectroscopy (XPS).

| Sample | Fe at. % | Ni at. % | N at. % | S at. % | O at. % |
|---|---|---|---|---|---|
| CNT | 0.5 | <0.05 | | | 9.4 |
| CNT-SMX-250 | 0.2 | <0.05 | 0.8 | 0.2 | 3.7 |

Furthermore, surface element concentrations of heteroatoms are revealed in Table 3. CNT has a larger surface O concentration, 9.4 at. %, as compared to CNT-SMX-250, 3.7 at. %. This is possibly due to the adsorption of O-containing species or the oxidation of surface iron species in CNT during storage. No obvious N or S could be detected from CNT, while 0.8 and 0.2 at. % of N and S are detected in CNT-SMX-250, respectively, indicating the successful heteroatom doping by introducing SMX.

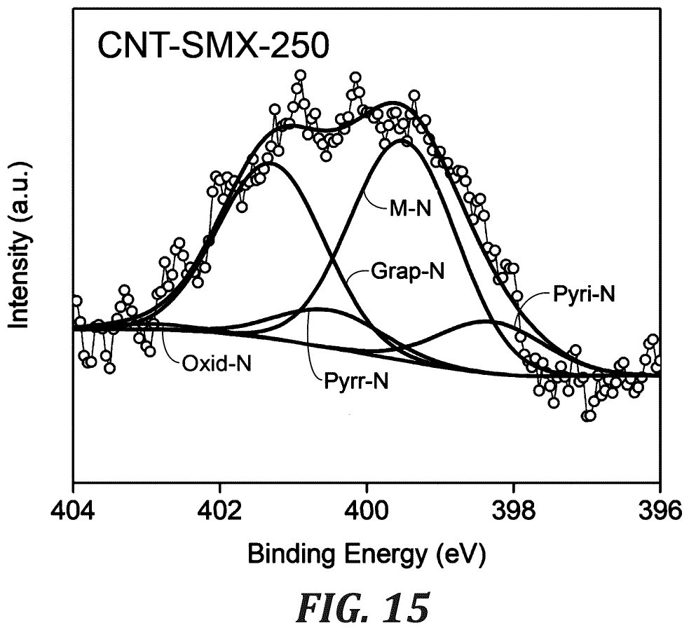

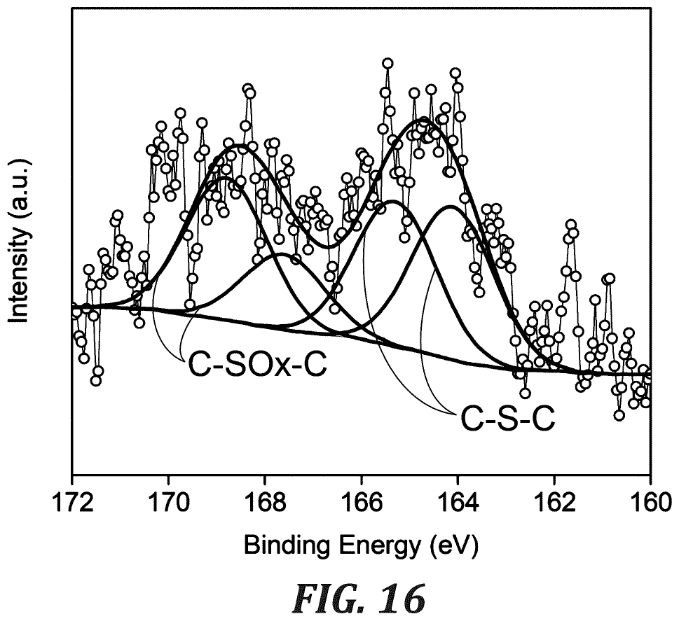

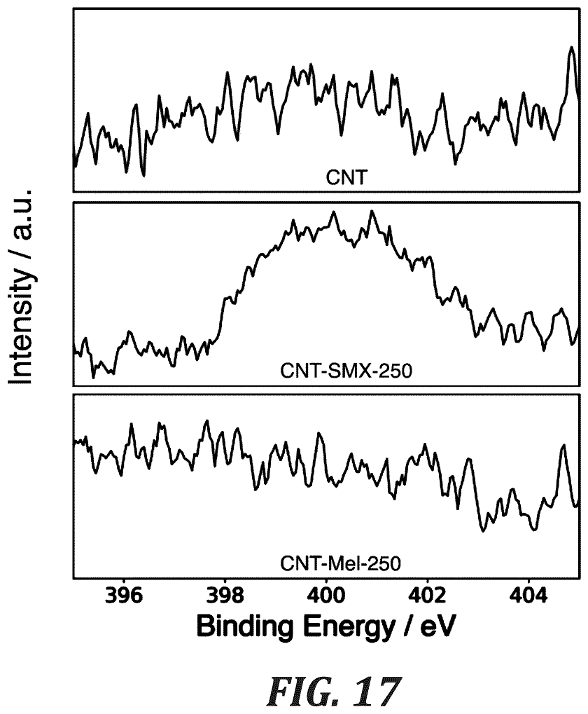

High-resolution N is spectra of CNT-SMX-250 (FIG. 15) reveals the presence of five different N species, including pyridinic N (398.2 eV), metal-N(M-N) (399.5 eV), pyrrolic N (400.3 eV), graphitic N (401.2 eV), and N-oxides (403.7 eV). The presence of the M-N content reveals the formation of metal-nitrogen bond. Particularly, the M-N species dominate the N contents, indicating the effectiveness of forming M-N bonds using SMX as the N precursor. The formation of a large amount of M-N bonds is possibly because the surface Fe atoms have already been stabilized as isolated sites by the industrial fabrication process, while the uniform distribution of SMX molecules on the CNT surfaces provides effective formation of Fe—N bonds. As revealed in FIG. 16, the S 2p spectra of CNT-SMX-250 at lower binding energy can be assigned to C—S—C(2p_{3/2} at 164.1 and 2p_{1/2} at 165.3 eV), and the peaks centered at 167.6 and 168.8 eV correspond to oxidized species (C—SOx-C). The incorporation of S atoms could boost the CO₂RR activity in the nitrogen doped carbon catalyst system by decreasing the reaction barrier of intermediate formation and promoting the active nitrogen species. This further demonstrates the advantages of using SMX and CNT as raw precursors for M-N—C synthesis. In contrast, the commercial CNTs reveal no N peak (FIG. 17), indicating no N exists in the raw materials.

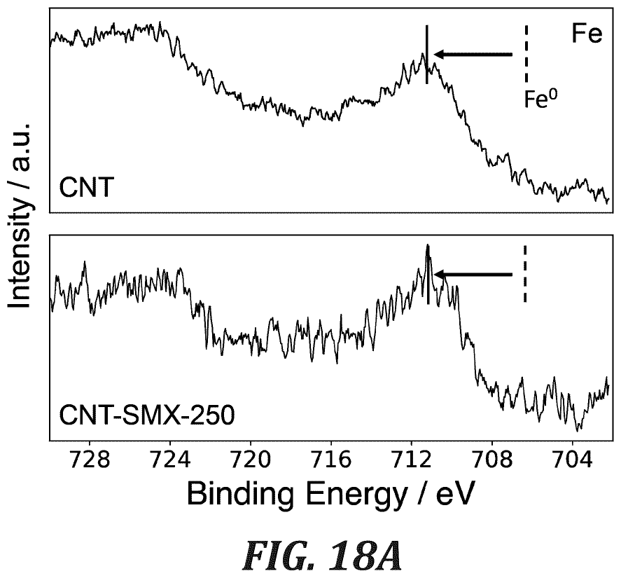

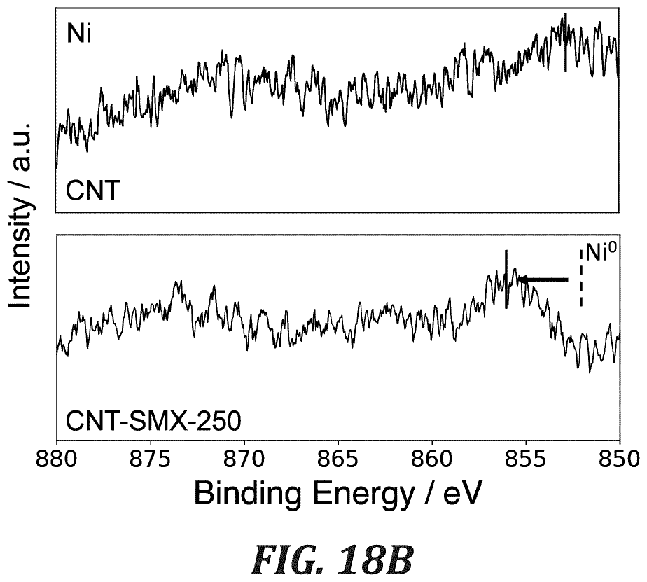

In addition, high-resolution XPS analysis of metal species in CNT and CNT-SMX-250 are shown in FIGS. 18A and 18B. Both samples reveal similar Fe spectra, indicating no significant changes of Fe after pyrolysis. As shown in FIGS. 18A and 18B, both Fe peaks show a shift towards higher binding energy compared to the standard Fe⁰ value, suggesting a positive oxidation state. In contrast, the XPS of Ni spectrum of raw CNTs does not show any obvious peak due to the extremely low concentration (less than 0.05 at. %, Table 3) on the surface, because Ni NPs are wrapped by carbon layers. After pyrolysis with SMX, a small Ni peak occurs at around 855 eV, likely due to the formation of Ni—N sites, with an oxidation state larger than 0.

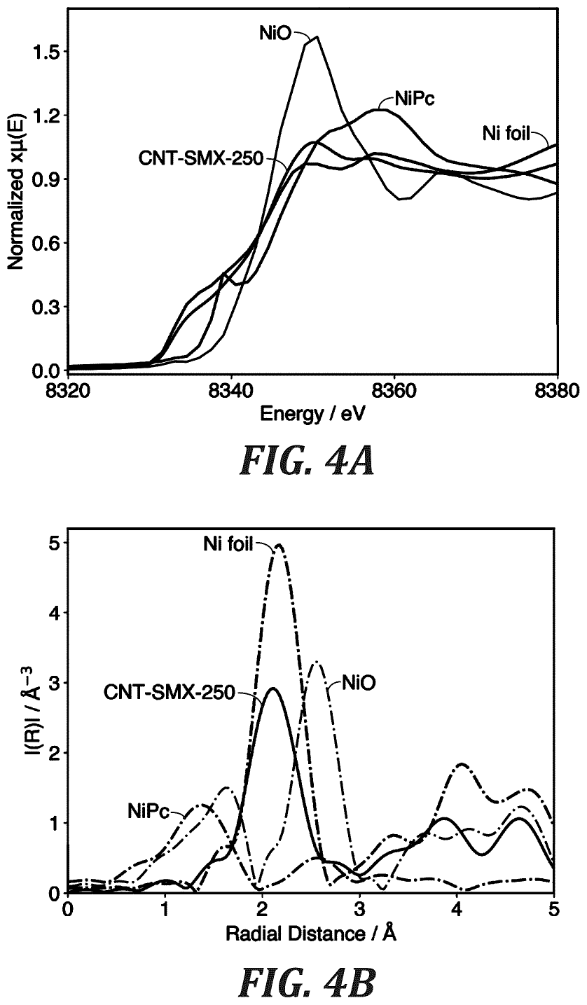

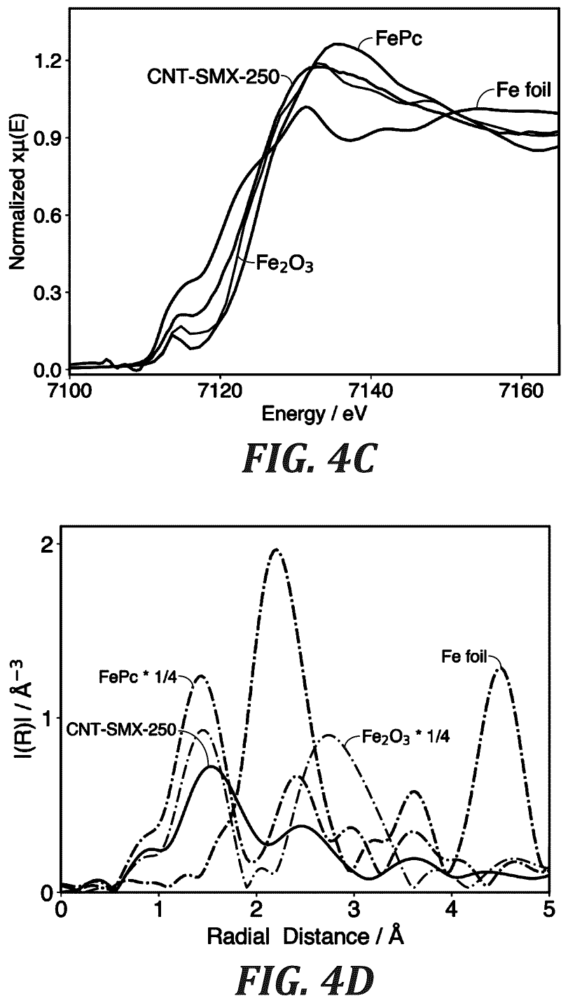

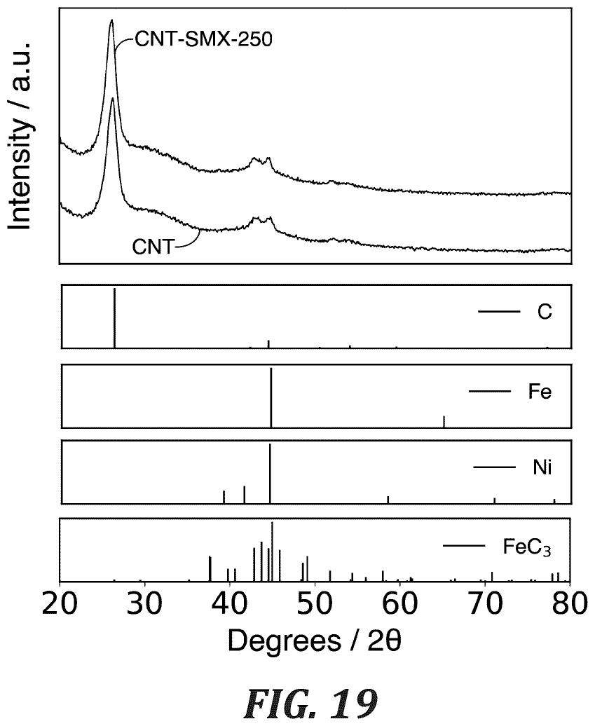

To further understand the local arrangement of metal atoms, X-ray absorption spectroscopy (XAS) was conducted on CNT-SMX-250. Fe foil, Fe₂O₃, Ni foil, iron phthalocyanine (FePc), and nickel phthalocyanine (NiPc) were used as the standards. The X-ray absorption near edge structure (XANES) spectra of Ni (FIG. 4A) in CNT-SMX-250 are all close to Ni foil, indicating a dominating Ni⁰ state. Notably, the edge of Ni in CNT-SMX-250 is slightly larger than 0, indicating some Ni elements possibly form Ni—N or Ni—O bonds. As shown in FIG. 4B, extended X-ray absorption fine structure (EXAFS) spectra of Ni atoms reveal a single peak at around 2 Å, close to Ni—Ni peak in Ni foil. No other Ni peaks are found, indicating the dominating Ni structure in CNT-SMX-250 being Ni nanoparticles, consistent with the STEM results (FIG. 3C). This is consistent with the XRD observation (FIG. 19) where a metal nanoparticle peak appears at around 45 degrees.

In contrast, the XANES spectra of Fe (FIG. 4C) shows different Fe oxidation state in CNT-SMX-250. CNT-SMX-250 reveals an adsorption edge profile between Fe foil and Fe₂O₃, indicating a Fe oxidation state in CNT-SMX-250 between 0 and 3+, in consistent to the XPS results (FIGS. 18A and 18B). This is possibly due to the formation of Fe—N bonds, where the Fe oxidation state is found to be close to 2+ in the Fe—N—C materials.

Moreover, as shown in FIG. 4D, CNT-SMX-250 exhibits a peak at around 1.5 Å, corresponding to either Fe—N in FePc or Fe—O in Fe₂O₃. Notably, CNT-SMX-250 also shows a peak at around 2.2 Å, possibly corresponding to Fe—Fe peak in Fe foil or bimetallic Ni—Fe peak. This is consistent with the observation of STEM/EDS (FIG. 12) where Fe peak intensity can be observed, indicating a small quantity of Fe element in the Ni nanoparticles.

Since Ni and Fe elements exist in the system based on the ICP/EDS/XPS results, it is impossible to exclusively exclude Ni atomic site formation. As a result, it is hypothesized that the nanoparticle structure comprises Ni elements with small quantities of Fe while the atomic sites primarily comprise Fe—N sites with small quantities of Ni. These nanoparticles are encapsulated in the CNT branch/tip and are preserved even after an industrial acid purification process that removes the exposed metal nanoparticles.

### CO₂RR Performance Evaluation

### Traditional H-Cell

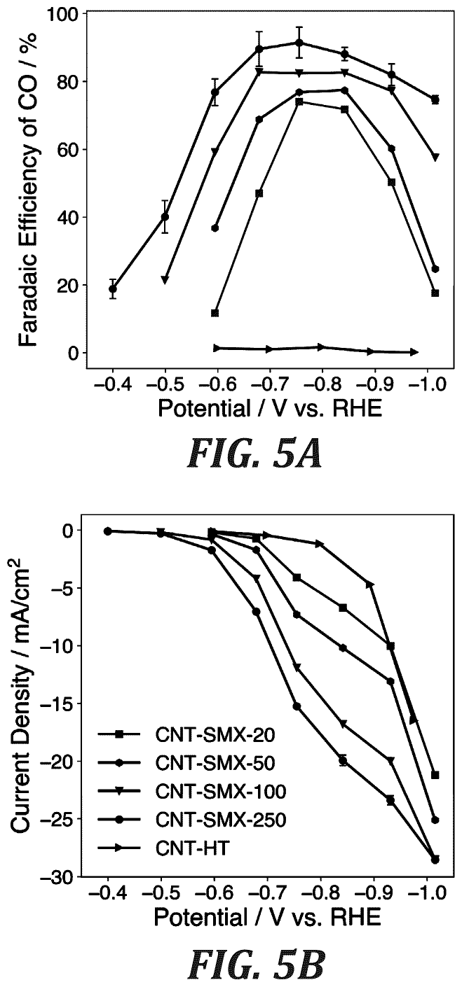

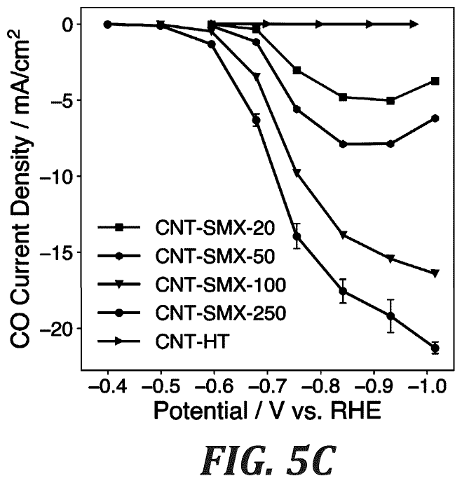

The CO₂RR performance of the as-prepared catalysts was firstly evaluated in a traditional H-Cell. The Faradaic efficiency of CO (FE(CO)) of CNT-SMX-X and CNT-HT at different applied potentials are depicted in FIG. 5A. The highest FE(CO) of CNT-SMX-X is achieved at −0.76 V vs. RHE of 91.5% with a partial CO current density of 14 mA/cm² (FIGS. 5B and 5C) by CNT-SMX-250. As concentration of precursor SMX solution increases, FE(CO) and current density of CNT-SMX-X increase. FE(CO) and current density in all CNT-SMX-X are significantly larger than that of CNT-HT, 1.6% of FE(CO) with a CO current density of 0.02 mA/cm². This demonstrates the significance of Fe—N active sites formed by SMX adsorption/pyrolysis process. Since the physical properties of CNT-SMX-X samples and pristine CNTs (e.g., BET surface area, structure, etc.) are similar, the differences are more likely due to the nitrogen doping level resulted from different SMX adsorption quantities. As shown in FIG. 2, the SMX equilibrium adsorption capacity (Qe) by CNTs in the 250-ppm SMX solution (corresponds to CNT-SMX-250 in FIGS. 5A-5C) is about 1.5 times of that in the 100-ppm solution (CNT-SMX-100), and 5 times of that in the 20-ppm solution (CNT-SMX-20). In comparison, CNT-HT (i.e., CNT-SMX-0) shows almost no activity. The different amount of adsorbed SMX on CNTs correlates to the nitrogen doping level after pyrolysis and is believed to be a major contributor to the different CO₂RR performance as observed in FIG. 5. As the adsorbed SMX amount increases, the CO₂RR performance increases. Further increase of SMX adsorption on the CNTs is limited according to the adsorption equilibrium isotherm (FIG. 2) and the low SMX solubility in water at room temperature.

Specifically, the FE(CO) of CNT-SMX-250 remains at above 90% from −0.7 to −0.9 V vs. RHE even if metal nanoparticles co-exist with atomic sites, as shown in FIGS. 3A, 3D. Exposed transition metal nanoparticles normally have a negative effect on the CO₂RR as they promote competing hydrogen evolution reaction (HER) due to their strong bonding with *H. The coverage of the Ni NPs by graphitic carbon layers during the CVD synthesis could help block bulk Ni from interacting with the reactants to suppress HER. The utilization of the commercial CNT derived catalyst may greatly benefit from the encapsulation advantage because the CNTs have been purified by the industrial process to move bulk metal particles, thus the metal NPs left are mostly encapsulated by the CNT carbon layers, as revealed by FIG. 3A. Thus, such materials are excellent to suppress HER on the nanoparticles, indicating the commercial CNT an excellent CO₂RR carbon precursor candidate.

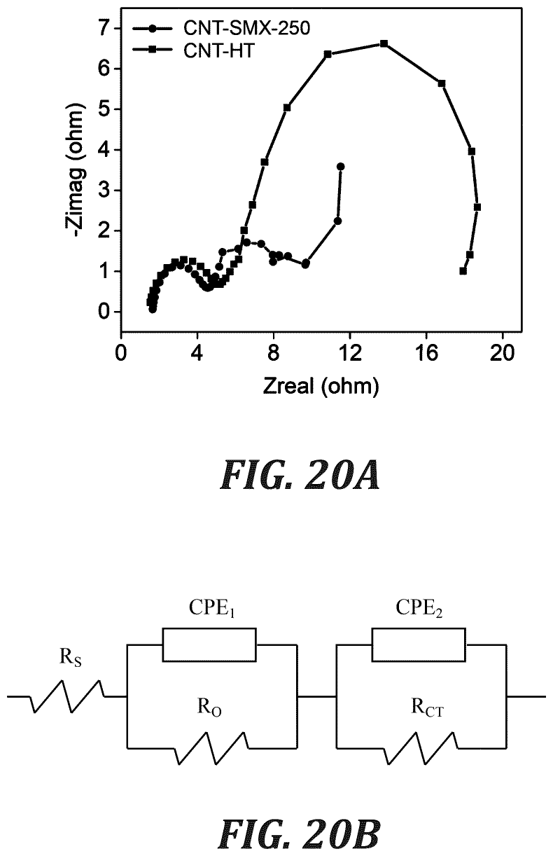

Electrochemistry characterizations were carried out to further investigate the electrochemical properties of each sample. The Nyquist plots by electrochemical impedance spectroscopy (EIS) are obtained as in FIG. 20A, and the equivalent circuit model in the cathode compartment is defined in FIG. 20B. The equivalent circuit model contains solution resistance (R_{S}), Ohmic resistance (R_{Ω}), and charge-transfer resistance (R_{CT}). The charge-transfer resistance represents the resistance for the electrons to transfer from the catalyst to the reactants. CPE₁ and CPE₂ represent the constant phase element, corresponding to the capacitance. The fitting results shown in Table 4 reveal that CNT-SMX-250 and CNT-HT have similar solution resistance (R_{S}) and ohmic resistance (R_{Ω}), while CNT-SMX-250 has significantly higher charge-transfer resistance (R_{CT}), 14 Ω versus 6Ω, suggesting a more favorable electron transfer process at CNT-SMX-250 surface than that at CNT-HT when CO₂ reduction occurs. This is due to the heteroatom doping that is present in CNT-SMX-250 while absent in CNT-HT.

TABLE 4
Electrochemical impedance spectroscopy (EIS) fitting results.

| | CNT-SMX-250 | CNT-HT |
|---|---|---|
| R_{S} (Ω) | 1.6 | 1.3 |
| R_{Ω} (Ω) | 2.6 | 4.3 |
| R_{CT} (Ω) | 6.1 | 13.9 |

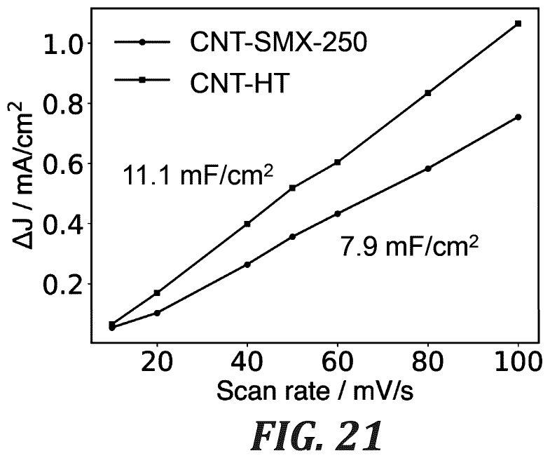

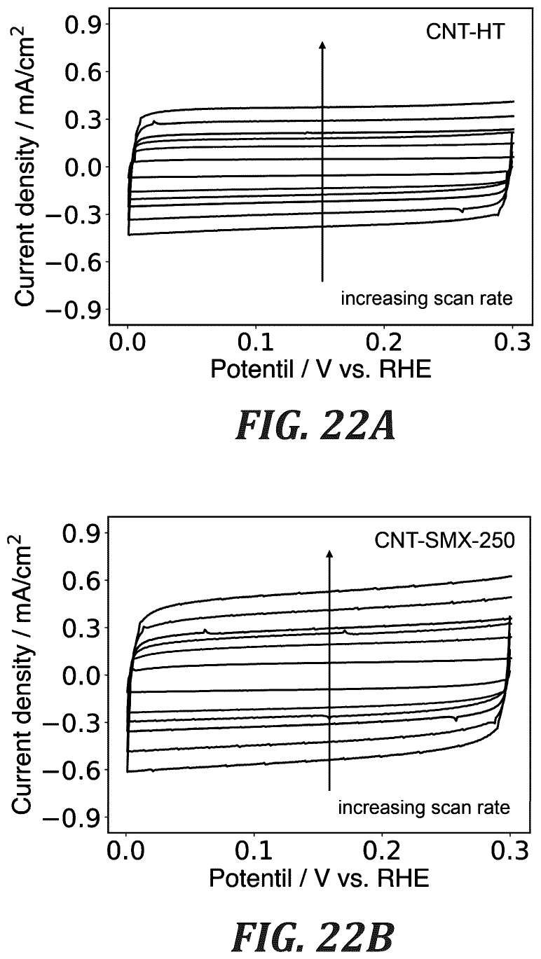

The double-layer capacitances (C_{dl}) of the samples are compared in FIG. 21. The C_{dl} is obtained and calculated by cyclic voltammetry (CV) in a non-Faradaic potential range from 0 to 0.3 V vs. RHE (FIGS. 22A and 22B) using the slope of the plots of current density differences as a function of applied potential scanning rates. CNT-SMX-250 has a larger C_{dl}, 11.1 mF/cm², than that of CNT-HT, 7.9 mF/cm². C_{dl} is proportional to the electrochemical surface area (ECSA), indicating a larger ECSA of CNT-SMX-250. To further analyze CO₂RR activity of the electrochemical sites, the partial current density of CO divided by ECSA (J_{CO}/ECSA) has been calculated for both samples at −0.76 V vs. RHE, where maximum Faradaic efficiency of CO is achieved. CNT-SMX-250 shows a J_{CO}/ECSA of 1.3 mA/mF, while CNT-HT only has 0.002 mA/mF. This indicates that with the incorporation of SMX adsorption for N doping, CNT-SMX-250 has a significant enhancement on the activity of the electrochemical sites.

### Flow Cell

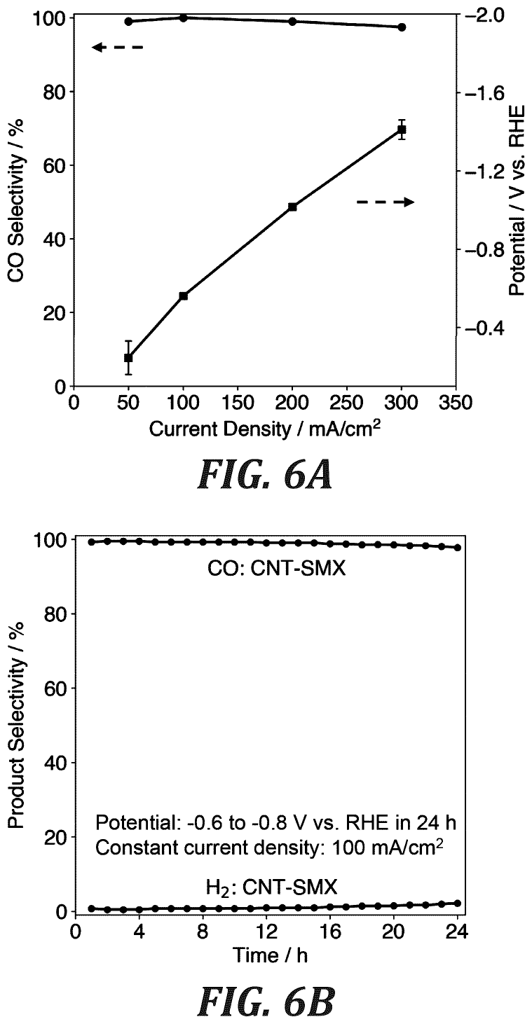

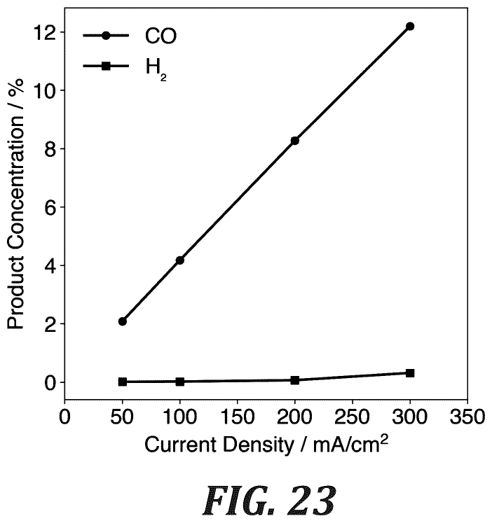

As revealed in FIG. 6A, the CO selectivity remains above 95% at a wide range of current densities, from 50 to 300 mA/cm² with good repeatability. In specific, the average CO selectivity is 97.5% at 300 mA/cm² and −1.4 V vs. RHE, as revealed in FIG. 6A. This indicates an excellent CO₂RR performance suitable at commercially viable production rates. The CO concentration increases as the current density with H₂ concentration less than 1% in FIG. 23, indicating that the catalyst could suppress HER in a wide current density range.

The stability test of CO₂RR was evaluated at 100 mA/cm² for 24 hours. The CO selectivity, as revealed in FIG. 6B, decreases slightly during the 24-h stability test from 99% to 98% due to the slight increase of HER which competes with the CO generation. The stability result is among the most stable performances reported in the literature at similar conditions. Moreover, as revealed in FIG. 23, the catalyst has achieved up to 12% of CO concentration in the downstream cathode outlet, indicating a comparable CO₂ conversion at similar conditions to the state-of-the-art works.

### Nitrogen Element Usage

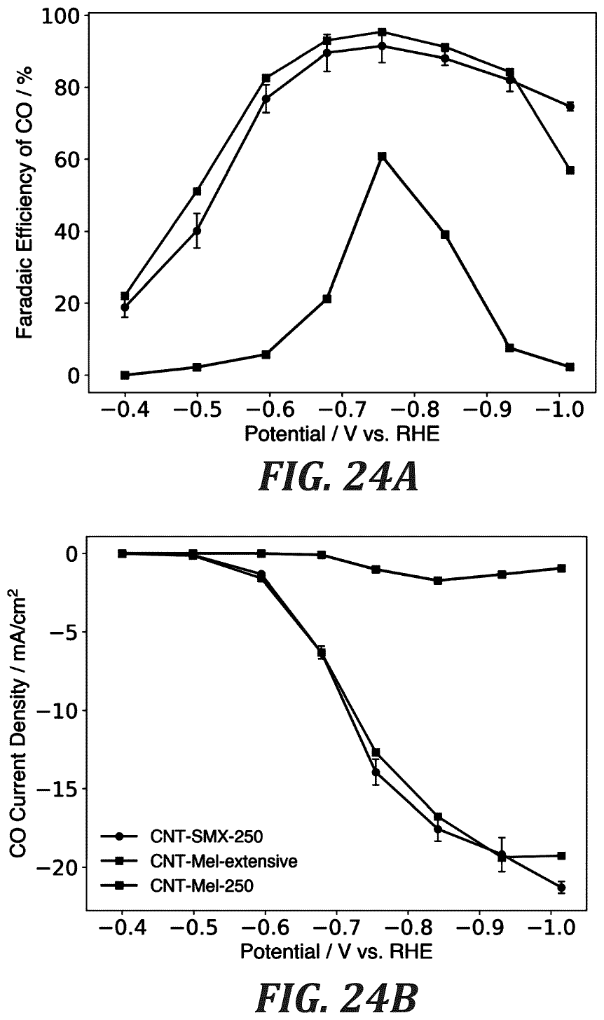

To further demonstrate the effects on nitrogen doping by the organic wastes, melamine is used as a control sample to replace SMX as the nitrogen precursor as it is a widely applied agent for nitrogen doping on the CNT surface. Firstly, melamine at the same quantity of nitrogen element as SMX was adsorbed onto CNTs to generate CNT-Mel-250 catalyst. The as-synthesized CNT-Mel-250 in FIGS. 24A and 24B reveals much worse CO₂RR performance than that of CNT-SMX-250. The maximum Faradaic efficiency of CO in CNT-Mel-250 is 60.8% compared to 91.5% in CNT-SMX-250 at −0.76 V with a CO current density of −1 vs. −14 mA/cm². The high-resolution N XPS spectrum of CNT-Mel-250 reveals no obvious N peak, indicating no N doping (FIGS. 24A and 24B). This is possibly due to the weak π-πinteraction between traditional short-chain nitrogen precursors (e.g., melamine, urea, etc.) and CNTs, leading to a very small amount of melamine being adsorbed on CNT surfaces.

To increase the loading of melamine on CNTs, CNT-Mel-excess was synthesized by using a 10:1 melamine/carbon mass ratio for pyrolysis, and this ratio is within the range to ensure sufficient nitrogen doping. As revealed in the FIGS. 24A and 24B, CNT-Mel-excessive shows similar performance to that of CNT-SMX-250, indicating a successful nitrogen doping by melamine. The XPS spectra revealed that the nitrogen atomic concentration in CNT-Mel-excessive, 0.77 at. %, is close to that of CNT-SMX-250, 0.80 at. %. However, the total nitrogen amount used in CNT-Mel-excessive synthesis is 100 times larger than that in CNT-SMX-250, indicating a significantly higher utilization efficiency of nitrogen using SMX as the precursor, and even more sustainable when adsorbing it from a pharmaceutical waste. Since SMX and melamine has a similar decomposition temperature, it is probable that the nitrogen doping difference is due to SMX being adsorbed to the CNT surface by 7L-7L interaction with multi-layers thus the metal elements on CNTs have a larger chance to form M-N bonds with the decomposed N-containing intermediates. In contrast, melamine does not fully cover the CNT surface, requiring much more melamine in the process to achieve a similar level of nitrogen doping.

We further compared the nitrogen usage in our catalyst to the literature. As shown in Table 5, CNT-SMX-250 shows significantly less (2 to 4 orders of magnitude less) nitrogen precursor usage than those in the literature, indicating an efficient and cost-effective synthesis.

TABLE 5
Nitrogen usage comparison the literature.*

| | Weight ratio of the N |
|---|---|
| Catalyst | precursor to catalyst |
| CNT-SMX-250 (this work) | 0.07 |
| Fe—N₅ | 2000 |
| Fe—N—PC | 12.5 |
| NC@Fe | 10 |
| Fe—N-CNT@GNR-2 | 20 |
| Fe—N-G-p | 20 |

*We compare the nitrogen usage of the catalyst in this work with several Fe—N—C catalysts that are derived from carbon, in particular carbon nanotubes, graphene, and carbon black (assume the weight of the carbon support is well preserved after synthesis).

We also compared the CO₂RR performance of CNT-SMX-250 with those of Fe-based catalysts reported in the literature, as shown in Table 6. Our catalyst ranked among the top ones in terms of both FE(CO) and CO current density.

TABLE 6
Comparison of H-cell CO2RR performance by the catalyst in this work with
the state-of-the-art Fe-based catalysts reported in the literature.

| | | Post- | Metal | Synthesis | | | | Jco | | Potential | | KHCO₃ |
|---|---|---|---|---|---|---|---|---|---|---|---|---|
| Catalyst | Pre-treat | wash | precursor | condition | | FE(CO) | | (mA/cm²) | | (V vs RHE) | | (M) |
| CNT- | No | No | No | 650° | C. | 91.5% | | 14 | | −0.76 | | 0.5 |
| SMX-250 | | | | | | | | | | | | |
| Fe_{0.5}d | ZIF-8 Synthesis | Yes | Yes | 1050° | C. | 80% | (50%) | 4.5 | (6) | −0.5 | (−0.8) | 0.5 |
| Fe—N₅ | GO synthesis | Yes | Yes | 800° | C. | 97% | (50%) | 2 | (4.5) | −0.46 | (−0.8) | 0.1 |
| Fe—N/O—C | Freeze drying | Yes | Yes | 1000° | C. | 96% | (80%) | 5.6 | (12) | −0.57 | (−0.77) | 0.1 |
| Fe—NS—C | Polymerization | Yes | Yes | 900° C., | | 93% | | 12.1 | | −0.56 | | 0.5 |
| | | | | twice | | | | | | | | |
| Fe—N—C | Silica template | Yes | Yes | 1000° C., | | 81% | (50%) | 2.8 | (4) | −0.57 | (−0.8) | 0.5 |
| | | | | twice | | | | | | | | |
| Fe—N—C | ZIF-8 | No | Yes | 1000° | C. | ~90% | (40%) | ~1 | (~2) | −0.5 | (−0.8) | 0.5 |
| SMFeSCN | SBA-15 template | Yes | Yes | 900° C., | | 99% | (60%) | ~3.5 | (~11) | −0.55 | (−0.8) | 0.1 |
| | | | | twice | | | | | | | | |
| Fe—N—PC | Strong | No | Yes | 900° | C. | 63% | (20%) | 3.2 | (~5) | −0.5 | (−0.8) | 0.5 |
| | acid/oxidant | | | | | | | | | | | |
| NC@Fe | Wet | Yes | Yes | 800° | C. | 90.6% | (~45%) | 0.75 | (~1.1) | −0.6 | (−0.8) | 0.1 |
| | impregnation | | | | | | | | | | | |
| Fe—N- | Strong | No | No | 900° | C. | 95% | | 10.7 | | −0.76 | | 0.1 |
| CNT@GNR-2 | acid/oxidant | | | | | | | | | | | |
| Fe-CNPs | Silica | Yes | Yes | 1000° | C. | 98.8% | (~80%) | ~6 | (~11) | −0.58 | (−0.78) | 1 |
| | template/ZIF | | | | | | | | | | | |
| Fe—N-G-p | GO synthesis/ | No | Yes | 900° | C. | 94% | (~60%) | 4.3 | (6.5) | −0.58 | (~−0.75) | 0.1 |
| | H₂O₂ etching | | | | | | | | | | | |
| Fe—N—C | ZIF, washing | No | Yes | 1000° | C. | ~90% | (~50%) | ~5 | (~9) | −0.5 | (−0.8) | 0.5 |
| Fe/NG | GO synthesis, | No | Yes | 750° | C. | 80% | (60%) | ~1.5 | (~2.5) | −0.6 | (−0.8) | 0.1 |
| | freeze drying, | | | | | | | | | | | |
| | etc. | | | | | | | | | | | |

### Additional Experimental Investigation of the Active Sites

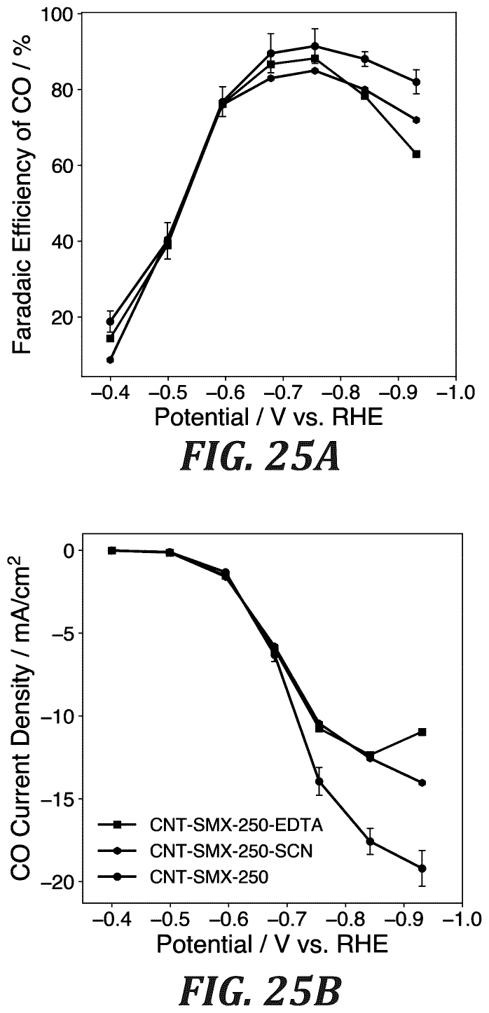

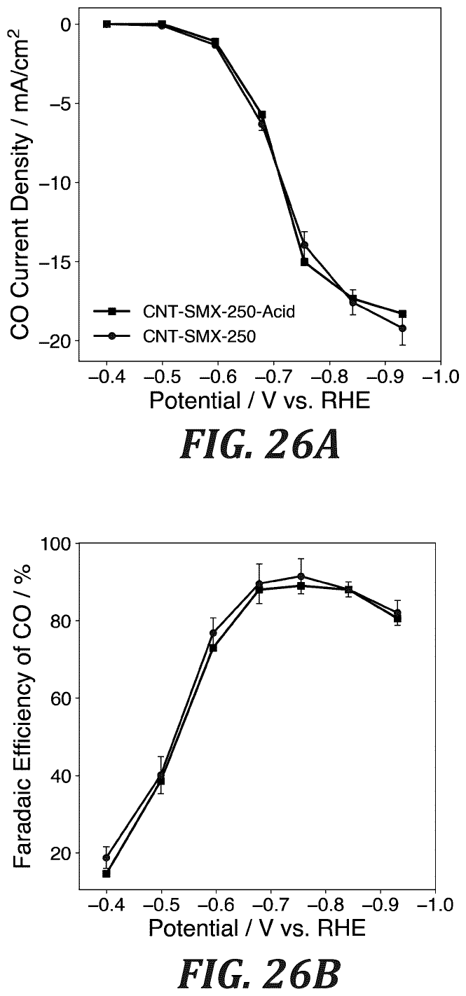

In order to investigate the active sites, multiple experiments were further conducted. Firstly, ethylenediaminetetraacetic acid (EDTA) and potassium thiocyanate (KSCN), two most widely used poisoning agents to metal sites in electrolysis, were used to investigate the active site distribution in H-Cell testing. As shown in FIGS. 25A and 25B, CNT-SMX-250 poisoned by EDTA and KSCN has a reduced CO₂RR performance, indicating the poisoning of active sites to certain extent, although not completely deactivating the catalyst. KSCN has a higher poisoning effect to metal NP than EDTA. As a result, the different performance between EDTA- and KSCN-poisoned samples is usually an indicator of the metal NP contribution. As shown in FIGS. 25A and 25B, both EDTA- and KSCN-poisoned samples show similar performance, suggesting no major contribution from metal NPs alone and the poisoning effects mainly occur on the single atomic Fe—N sites. This is reasonable as Ni NPs are wrapped by several carbon layers and thus are not accessible to poisons. The similar performance of CNT-SMX-250 and CNT-SMX-250-Acid (with post acid washing) also confirms no obvious metal NP contribution to CO₂RR (FIGS. 26A and 26B).

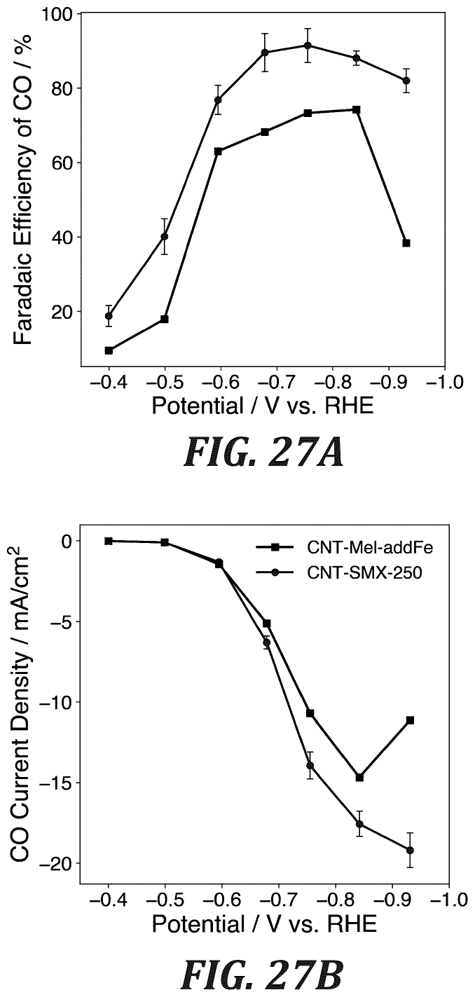

The typical metal content is around 0.2-2 wt. %, which is in line with the Fe content in this work, 0.4 wt. %. Nevertheless, we have conducted the experiment of introducing additional metal precursors (1 wt. % of Fe to the weight of carbon by wet impregnation) along with extensive amount of melamine. As shown in FIGS. 27A and 27B, CNT-Mel-addFe reveals even lower Faradaic efficiency and current density of CO, suggesting no additional active sites are created. This may be because of the lower pyrolysis temperature used in this work (i.e., 650° C.) than those in the literature (typically above 800° C. as shown in Table 6) to introduce metal doping from precursors such as metal nitrates. We have also conducted an extensive-nitrogen precursor experiment, as shown in FIGS. 24A and 24B, where CNT-Mel-extensive shows similar performance to that of CNT-SMX-250, indicating the N dopant in CNT-SMX-250 is sufficient. All the above experiments suggest that the single atomic Fe—N sites derived from intrinsic metal impurities from raw CNTs are the main active sites.

### DFT Investigation on the Synergy Between Single Atomic Fe—N Sites and Ni NPS

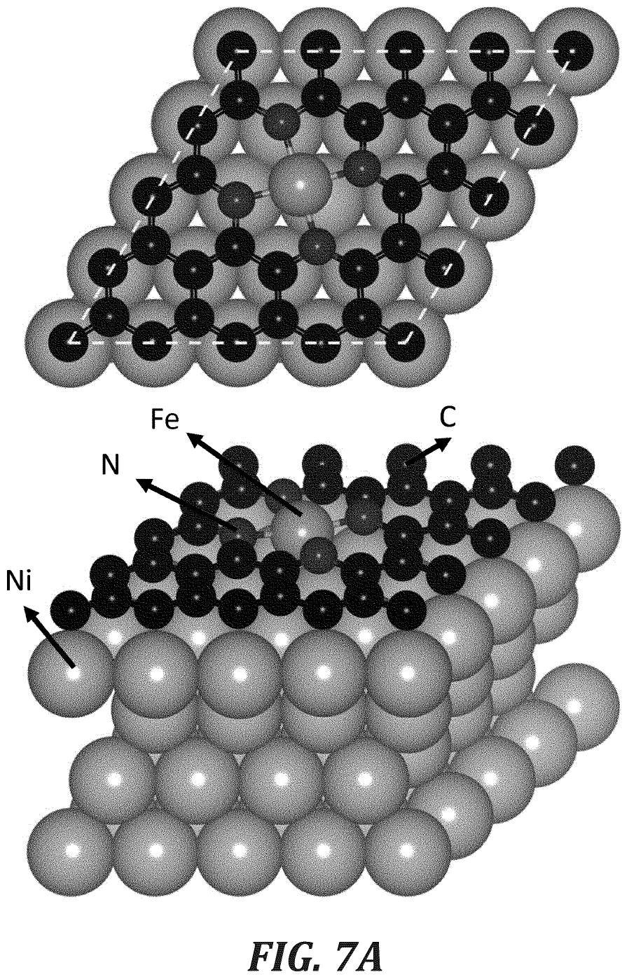

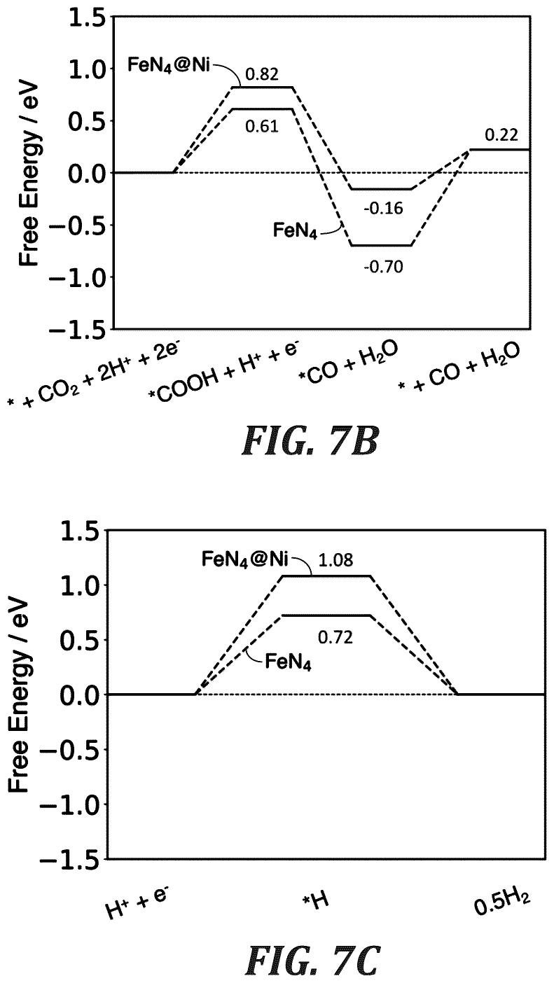

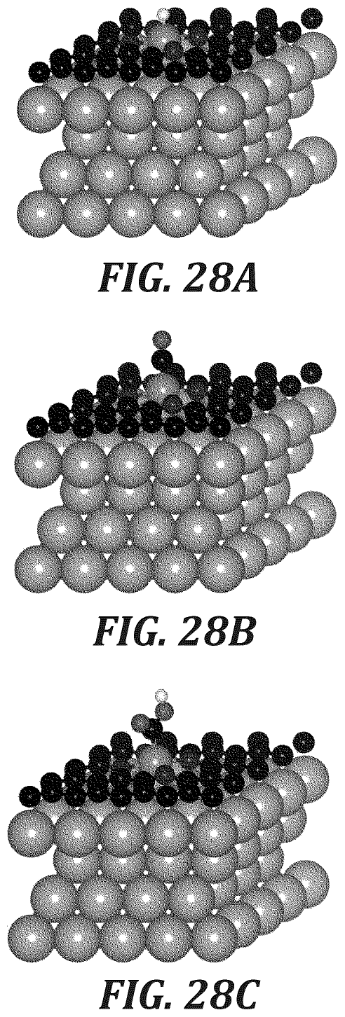

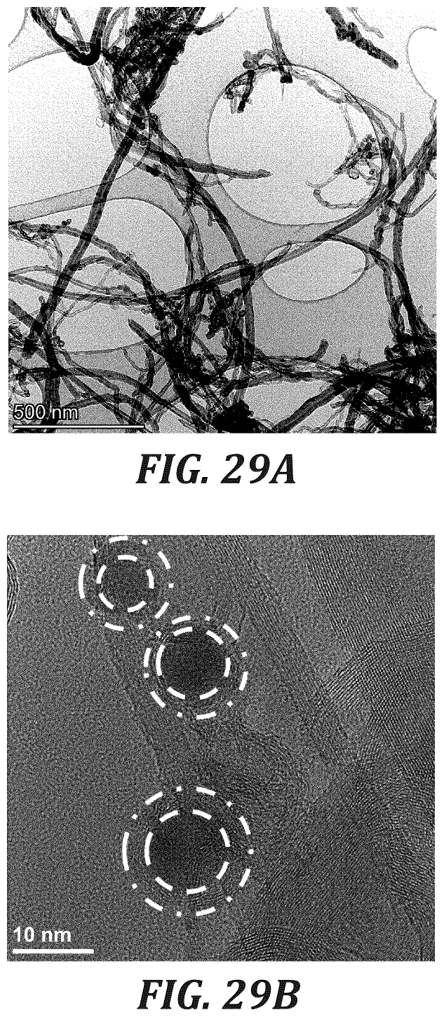

The STEM/EDS/XAS result (FIG. 3 and FIG. 4) indicates that CNT-SMX-250 catalyst is comprises Ni nanoparticles wrapped by carbon layers containing Fe and N dopants. We further performed density functional theory (DFT) calculations to gain understanding whether there exists a synergy between Ni nanoparticles and Fe—N—C that could affect CO₂RR performance. In this study, a FeN₄ moiety embedded in a graphene layer was used to model the Fe, N doped carbon because FeN₄ site was recognized as the most common site in Fe—N—C catalyst active for CO₂RR. For comparison, we constructed atomistic models containing a FeN₄ moiety doped graphene layer with a Ni NP underneath as the support (denoted as FeN₄@Ni in FIG. 7A) and without Ni NP support (denoted as FeN₄). We employed the computational hydrogen electrode (CHE) method to predict the free energy evolution along the 2e⁻ CO₂RR pathway (FIG. 7B), which involves the well-accepted *COOH and *CO as reaction intermediates. The optimized adsorption configurations of COOH and CO on FeN₄@Ni site were shown in FIGS. 28A-28C. The limiting potential of CO₂RR, defined as the highest potential to make each electrochemical step involved exothermic, was predicted to be −0.82 V on FeN₄@Ni site and −0.61 V on FeN₄ site, respectively. In addition, the CO desorption energies were predicted to be 0.38 eV and 0.92 eV on FeN₄@Ni and FeN₄ site, respectively. Our previous study suggests that a more negative limiting potential corresponds to a more negative onset potential, and a higher CO desorption energy leads to a lower current density of CO. Therefore, we predicted that FeN₄@Ni site would use a more negative potential to promote CO₂RR but could generate a higher current density than FeN₄ site, in agreement with our experimental results which show that CNT-SMX-250 has the maximum FE(CO) achieved at around −0.7˜−0.8 V and CO partial current density of −14 mA/cm² at −0.76 V, while most of the state-of-the-art Fe-based catalysts having the largest FE(CO) at around −0.5˜−0.6 V. The CO partial current density achieved by CNT-SMX-250 at around −0.8 V is larger than most of the literature at a similar applied potential, as revealed in Table 6, agreeing with the above DFT calculation.

Moreover, we predicted the free energy evolution of hydrogen evolution reaction (HER), which is a major side reaction competitive with CO₂RR, on FeN₄ sites (FIG. 7C). The limiting potential of HER was calculated to be −1.08 V on FeN₄@Ni and −0.72 V on FeN₄ site, respectively. The limiting potential difference between CO₂RR and HER, denoted as U_{L}(CO₂RR)—U_{L}(HER), is used as a descriptor to gauge the selectivity of a catalyst for CO₂ reduction, and a large, positive value of U_{L}(CO₂RR)—U_{L}(HER) indicates a high selectivity toward CO₂ reduction. We calculated the value of U_{L}(CO₂RR)-U_{L}(HER) to be 0.26 V on FeN₄@Ni site and 0.11 V on FeN₄ site, respectively, implying that both FeN₄ sites on the two structures show good selectivity of CO₂RR over HER while the hybrid structure Fe—N₄@Ni shows slightly higher CO selectivity than that of FeN₄ alone. These DFT predictions are consistent with the experimental observation that CNT-SMX-250 shows a high CO Faradaic efficiency of 91.5%. Overall, the DFT calculations predict that FeN₄ sites containing carbon layers on Ni nanoparticles as the substrate could boost the production rate of CO₂RR with a high CO selectivity compared with FeN₄ sites alone, despite a small sacrifice on the applied potential, a slight increase in energy consumption.

In summary, the experimental and theoretical investigations have revealed that the high performance of CNT-SMX-250 in this work is contributed by at least two major factors. The first major contribution is the existence of single atomic sites (primarily Fe). Secondly, the synergetic effect between Ni NP and Fe—N—C also promotes the CO₂RR reaction rate and CO selectivity by lowering the CO* desorption energy barrier as predicted by the DFT calculations. The multiple contributions to enhanced CO₂RR performance suggest the advantage of using commercial CNTs and their intrinsic metal impurities to generate active metal active sites. A possible reason is that the commercial CNTs have gone through industrial process of removing the majority of exposed metal nanoparticles and unstable metal phases, leaving the most rigid and stable metal sites on the CNT surfaces. These metal sites are efficient in adsorbing SMX from the solution and form active M-N—C sites at a lower pyrolysis temperature. Based on the results in this work, this method shows a much higher nitrogen precursor utilization than in the literature (Table 5).

In summary, we directly utilized commercial multi-walled carbon nanotubes to adsorb pharmaceutical wastes such as SMX and transformed the mixture to an efficient CO₂RR catalyst through a simple synthesis process. The metal impurities in commercial CNTs bond with nitrogen from SMX to form single atomic M-N—C sites that are active for CO₂RR. These single atomic sites were dominated by Fe, while Ni nanoparticles also exist but are generally not active due to encapsulation by carbon layers. Interestingly, DFT calculations suggest the existence of a synergetic effect between Fe atomic sites and Ni NPs that promote the CO₂RR performance by lowering the *CO desorption energy, thus increasing the CO partial current density. The CNT-SMX-250 catalyst achieved excellent H-Cell performance that is among top ones reported in the leading literature. In a flow cell testing, the CNT-SMX-250 catalyst reached 300 mA/cm² of total current density with a CO selectivity larger than 95%. The catalyst also delivers a stable performance at a fixed current density of 100 mA/cm² for 24 hours. Furthermore, the nitrogen utilization rate of SMX in this synthesis method is significantly higher than that using conventional nitrogen precursor, melamine, to achieve a similar level of nitrogen doping and CO₂RR performance. More importantly, this synthesis method converts a waste to a useful product, and it does not require any metal precursors or additional pre- or post-treatment to produce the efficient catalyst, thus a truly environmentally benign and cost-effective method.

### Example 4: Catalyst Synthesis

The present Example describes synthesis of heteroatom-doped carbon nanotubes according to embodiments of the present disclosure.

### CNT-MEL

Typically, 100 mg of raw multi-walled CNTs (>95 wt % purity, denoted as Raw-CNT) was mixed with 1.0 g of melamine by mortar and pestle. The powder mixture was then placed in a combustion boat and loaded into a tube furnace (Thermal Scientific, Lindberg Blue M). The sample was pyrolyzed in an Ar atmosphere at a flow rate of 80 standard cubic centimeters per minute (sccm) with a ramping rate of 5° C./min until 650° C., then maintained at this temperature for 3 h.

The as-prepared catalyst was denoted as CNT-Mel or CNT-Mel (650° C.). Two other samples were synthesized under the same condition except at different pyrolysis temperatures of 800° C. and 950° C., they were denoted as CNT-Mel (800° C.) and CNT-Mel (950° C.), respectively.

To demonstrate a larger scale synthesis capability, 500 mg of raw CNTs and 2.0 g of melamine were pyrolyzed at 650° C. for 3 h. The product was denoted as CNT-Mel-500 mg. Compared with CNT-Mel, the relative amount of melamine used for CNT-Mel-500 mg was reduced to lower the materials cost per unit mass of the catalyst. CNT-Mel-10 g was prepared using similar method as CNT-Mel-500 mg, except using 10 g of commercial CNT and 40 g of melamine.

A control experiment using high-purity CNTs (>99.9% carbon) with minimal amount of metal impurities, denoted as Pure-CNT, was also conducted to compare with Raw-CNT (>95% carbon). Pure-CNT was then doped with N through pyrolysis with melamine following the same procedure, and the sample is denoted as Pure-CNT-Mel.

### CNT-Heat

A control sample was synthesized using the same pyrolysis process as CNT-Mel except that no melamine was added, and therefore no nitrogen doping was expected. The sample was donated CNT-Heat.

### CNT-Mel-Acid

A control sample was synthesized by acid washing the CNT-Mel sample after pyrolysis, denoted as CNT-Mel-acid.

### CNT-Urea AND CNT-DY

CNT-Urea and CNT-DY were synthesized under the same condition as CNT-Mel except using urea or dicyandiamide as the nitrogen precursor, respectively, instead of using melamine.

### CNT-Mel-V1 and CNT-Mel-V2

Raw CNTs from two different vendors were used to synthesize CNT-Mel-V1 and CNT-Mel-V2. Unless otherwise mentioned, the CNT-Mel presents CNT-Mel-V1 in this work, i.e., using CNTs from vendor V1. Same for the other catalysts including CNT-Urea and CNT-DY.

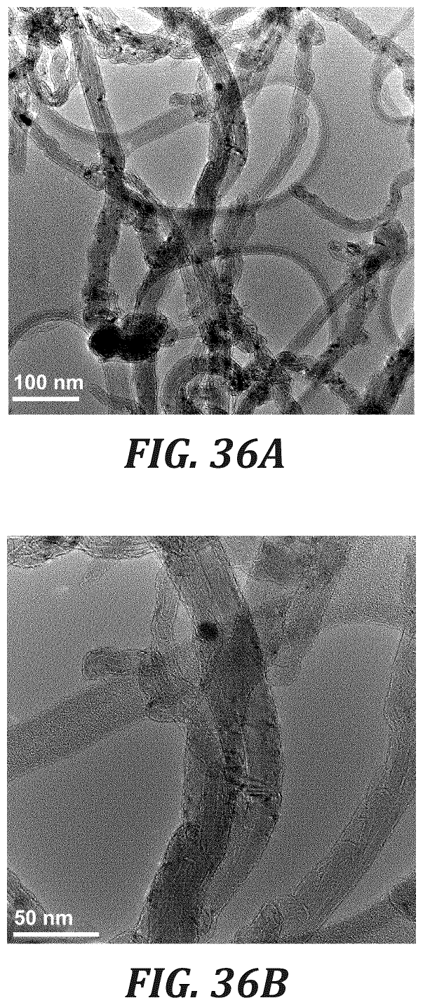

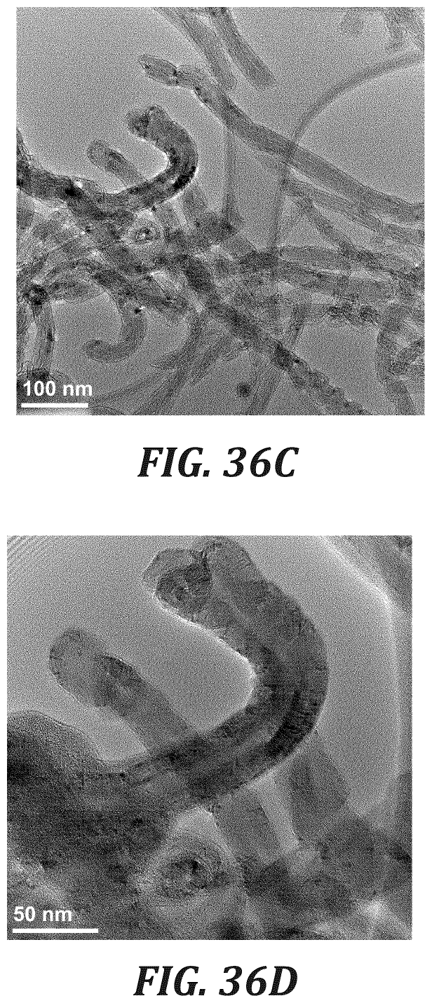

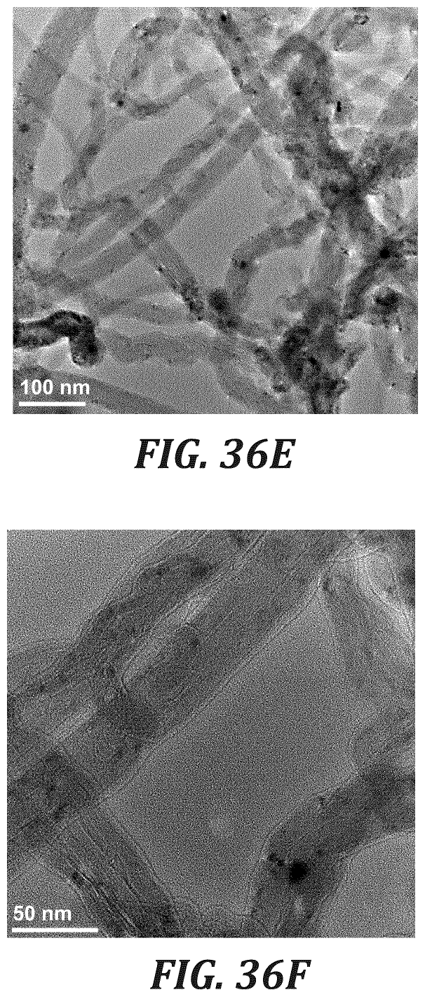

FIGS. 36A-36F are TEM images of (36A and 36B) Raw-CNT, (36C and 36D) CNT-Mel, and (36E and 36F) CNT-Heat, according to embodiments of the present disclosure.

### Example 5: Evaluation of Co2Rr

The present Example provides testing of the heteroatom-doped carbon nanotubes made in Example 4.

### H-Cell

The traditional H-Cell contains two compartments, separated by a proton exchange membrane (Nafion 115 membrane, Beantown Chemical, 0.125 mm thick). It is a system comprising three electrodes, a working electrode (WE) and a reference electrode (RE: Ag/AgCl, 3 M KCl) at the cathode side, and a counter electrode (CE: 1 cm×1 cm Pt foil) as the anode. The CO₂-saturated 0.5 M KHCO₃ solution was used as both catholyte and anolyte. The measured potentials after iR compensation are rescaled to the reversible hydrogen electrode by E (RHE)=E (Ag/AgCl)+0.210 V+0.0591 V×pH. The catalyst ink (3 mg of catalysts in a mixture of 370 μL of ethanol, 200 μL of water, and 30 μL of 5% Nafion solution) was sonicated for 3 h. The working electrode was prepared by drop-casting 200 μL of the catalyst ink onto a Toray carbon paper with an active catalytic geometric area of 1 cm². High-purity CO₂ (99.999%, Airgas) at a flow rate of 30 seem was introduced in the cathode chamber for 30 min to fully saturate the catholyte and the flow rate was maintained throughout the test. The products were analyzed via an online gas chromatograph (GC, Fuel Cell GC-2014ATF, Shimadzu) equipped with a thermal conductivity detector (TCD) and a methanizer-assisted flame ionization detector (FID).

### Flow Cell

A customized flow cell electrolyzer was used to evaluate the feasibility of applying the catalyst at commercially viable current densities. The flow cell is a two-compartment system, comprising anode and cathode chambers separated by an anion exchange membrane (Fumasep PK 130, Fuel Cell Stores). Nickel foam (active area: 1 cm²) was used as the anode for oxygen evolution reaction (OER), and the anolyte (1 M KOH) was circulated in the anode chamber at a flow rate of 10 secm. The cathode was prepared by airbrushing the catalyst ink (10 mg catalyst, 3 mL ethanol, 300 μL of 5% Nafion solution) onto a gas diffusion layer (GDL) (Sigracet 39 BC, Fuel Cell Store) with a geometric area of 2*3 cm² and was cut and used for the following tests. The catalyst was loaded to approximately 1 mg/cm² based on the difference in electrode weight before and after airbrushing with an active area of 1 cm². The catholyte (1 M KOH) was circulated in the cathode chamber between the membrane and cathode at a flow rate of 1.5 secm. The CO₂ gas, circulated at the backside of the GDL, diffused into the GDL and reacted at the catalyst-electrolyte interface. A Hg/HgO electrode (1 M KOH) was used as the reference. The flow cell tests were powered by a DC power supply (Agilent E3633A) and the potential between the reference and cathode was measured by a multimeter (AidoTek VC97+). All the measured potentials were reported without iR compensation. The products in the flow cell systems were analyzed via an online gas chromatograph (GC, GC-2010, Shimadzu) equipped with a thermal conductivity detector (TCD) and flame ionization detector (FID). Both CO and H₂ were detected by the TCD, and methane and hydrocarbons were measured by the FID detector.

A varied CO₂ partial pressure environment (75%, 50%, or 25%) was produced by diluting pure CO₂ with N₂ gas (Airgas, UHP grade). Unless otherwise indicated, the experiments were conducted at pure or 100% CO₂ environment.

### Example 6: Results and Discussions

The present Example describes morphology and performance of the heteroatom-doped carbon nanotubes synthesized in Example 4.

### Morphology, Structure, and Composition

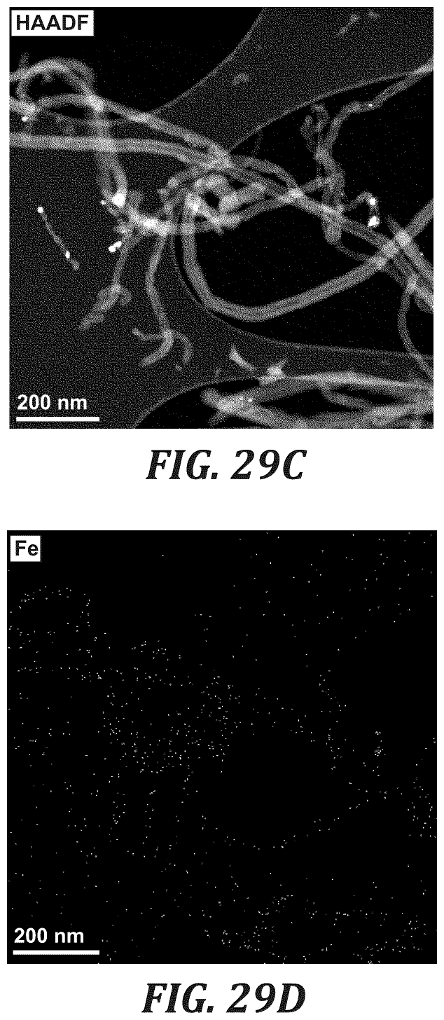

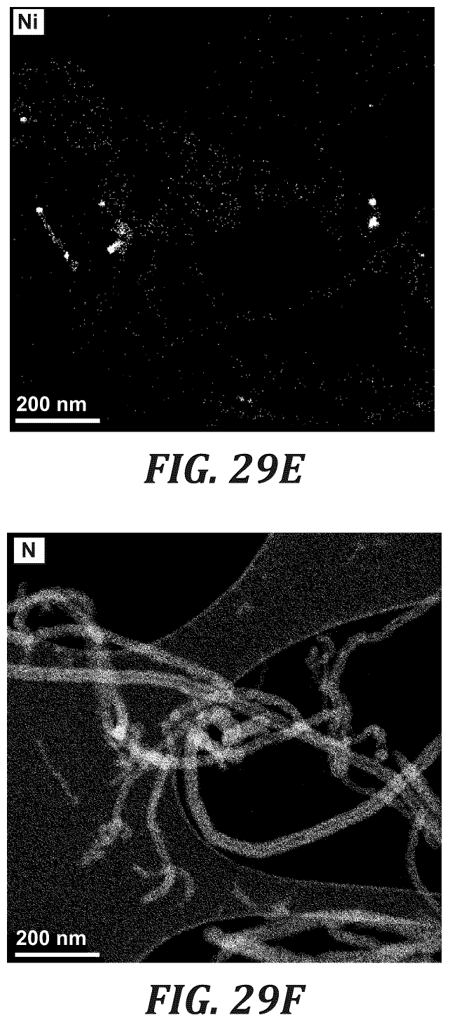

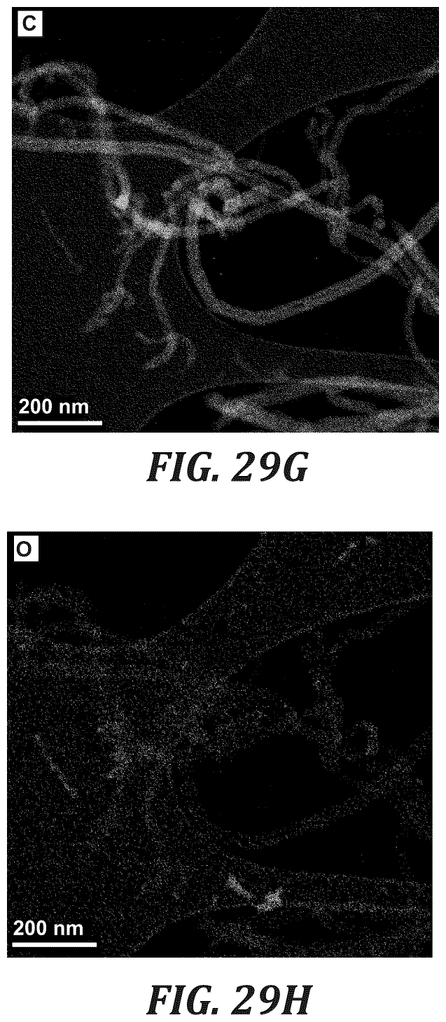

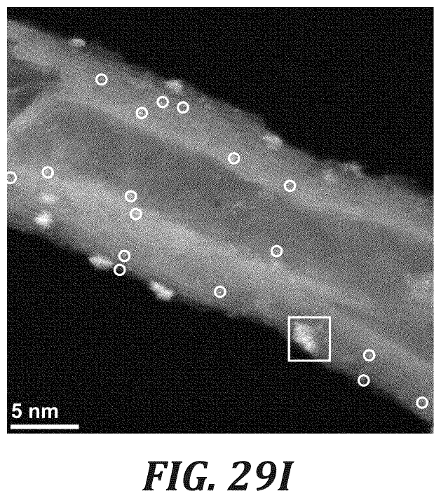

Transmission electron microscopy (TEM) analyses were conducted to reveal the structure of Raw-CNT (FIGS. 29A and 29B), CNT-Mel (FIG. 29A, FIGS. 29C and 29D), and CNT-Heat (FIGS. 29E and 29F). CNT-Mel and CNT-Heat maintain the tubular feature similar to Raw-CNT, with the presence of metal impurities in the form of either nanoparticle or nanocluster at varied sizes, indicating no major CNT morphology changes after pyrolysis with or without melamine. For CNT-Mel, no melamine residues are observed, indicating complete melamine decomposition. The metal impurities in the form of nanoparticles and nanoclusters are likely residues of metal catalysts used for manufacturing CNTs in the industrial process. The high-resolution TEM (HR-TEM) image in FIG. 29B shows that metal nanoparticles are encapsulated by graphitic carbon layers. Exposed nanoparticles were not identified from HR-TEM, likely because the industrial purification process has removed the exposed nanoparticles by acid treatments, leaving the remaining nanoparticles encapsulated. The industrial purification process typically involves multiple physical/chemical steps including sonication, oxidation, acid washing, and thermal annealing. These treatments are proven to be effective for removing exposed metal impurities and amorphous carbons in the CNTs, thus generating high-purity products. Besides intrinsically encapsulated metal particles from the raw CNTs, there are still chances that the decomposition of melamine during the pyrolysis process in this work may result in additional encapsulation of metal impurities by N-doped carbon layers. It is challenging, though, to distinguish such sites from the original encapsulated metals in the pristine CNTs.

The dispersion of metal atoms was revealed by high-angle annular dark-field aberration-corrected scanning transmission electron microscopy (HAADF-STEM). First, the elemental mapping images demonstrate the uniform distribution of N and Fe dopants throughout the CNT branches (FIG. 29C-29H), but the distribution of Ni (FIG. 29E) is much less uniform with clear and dense Ni aggregation, suggesting the formation of Ni nanoparticles on CNT-Mel. Furthermore, a higher resolution STEM image of the CNT branch is shown in FIG. 291. Bright dots (circled in red, average diameter about 0.2 nm) are dispersed throughout the CNT branch, corresponding to single metal atoms. Besides the distribution of metal single atoms, nanoparticles (larger than 2 nm) and nanoclusters (less than 2 nm) are also observed on the CNT branch (FIG. 29I). These results indicate that the metal impurities are in the form of both single atoms and nanoparticles/nanoclusters. In addition, the existence of bimetallic Fe—Ni sites are possible within nanoparticles/nanoclusters, given that Fe and Ni are the most popular metals used as the seeds for industrial and economical CNT manufacturing; however, the number of such sites should be small based on the elemental mapping results.

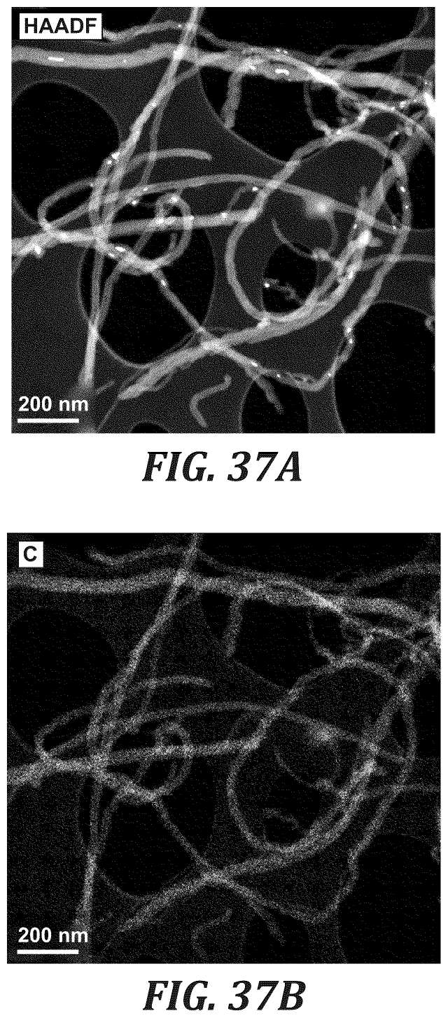

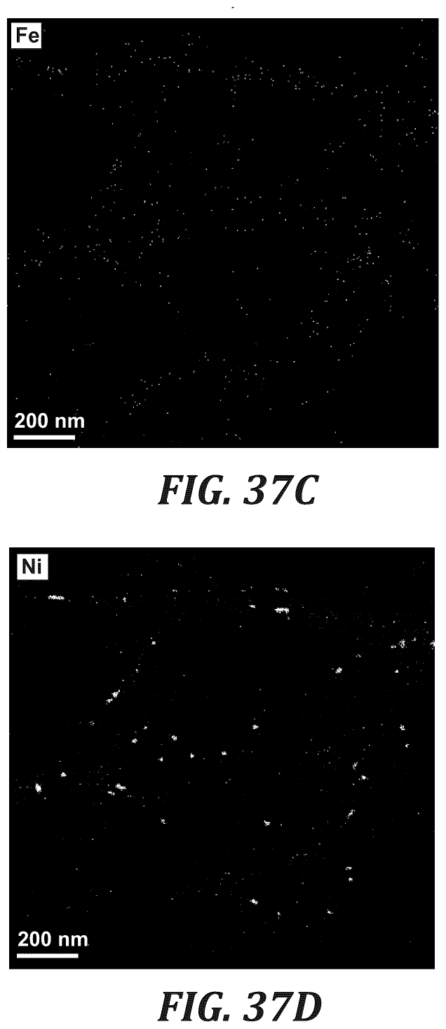

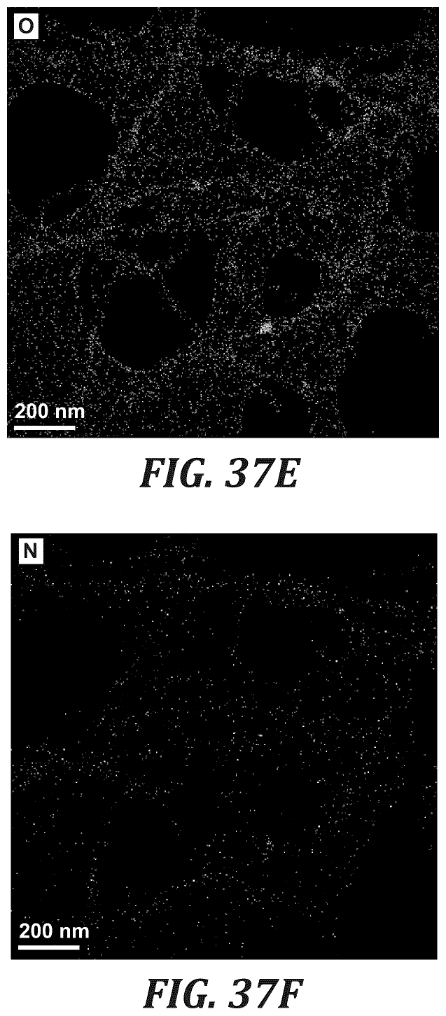

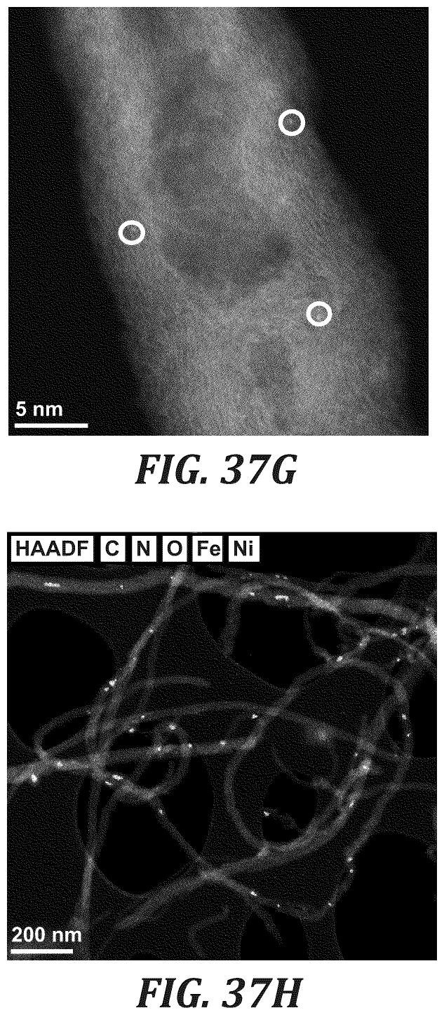

HAADF-STEM and elemental mapping were further conducted on the raw CNT (denoted as Raw-CNT) in FIGS. 37A-37H. Raw-CNT reveals similar metal structures to that of CNT-Mel, where aggregated Ni nanoparticles are clearly observed, and Fe elements are very well dispersed. High-resolution STEM image of Raw-CNT (FIG. 37G) also shows the existence of metal single atoms. These results confirm the commercial CNTs have intrinsic single atomic sites of metals, possibly in the form of metal atoms coordinate with C and/or O. These single atomic sites are likely to coordinate with nitrogen during pyrolysis with organic precursors to form M-N—C sites.

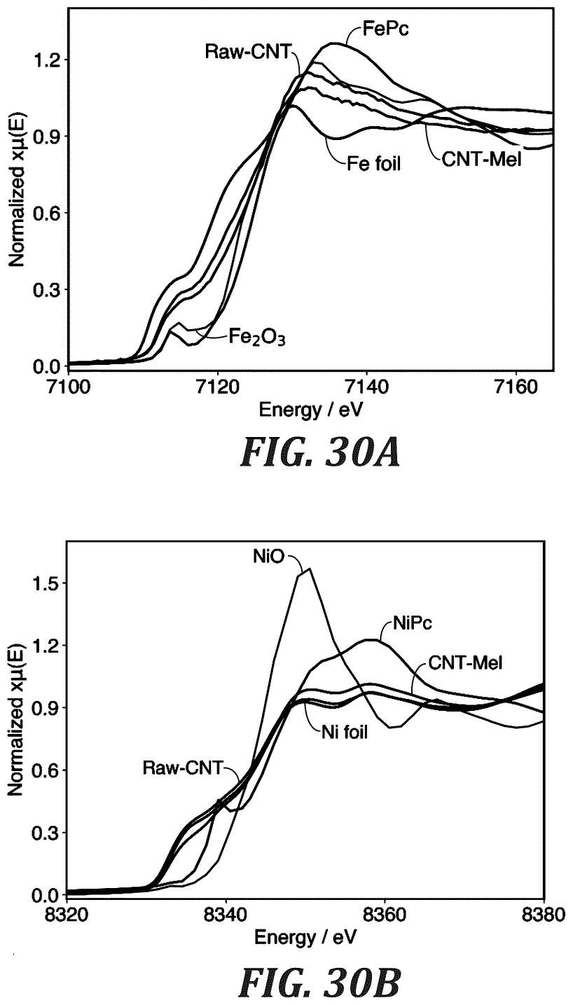

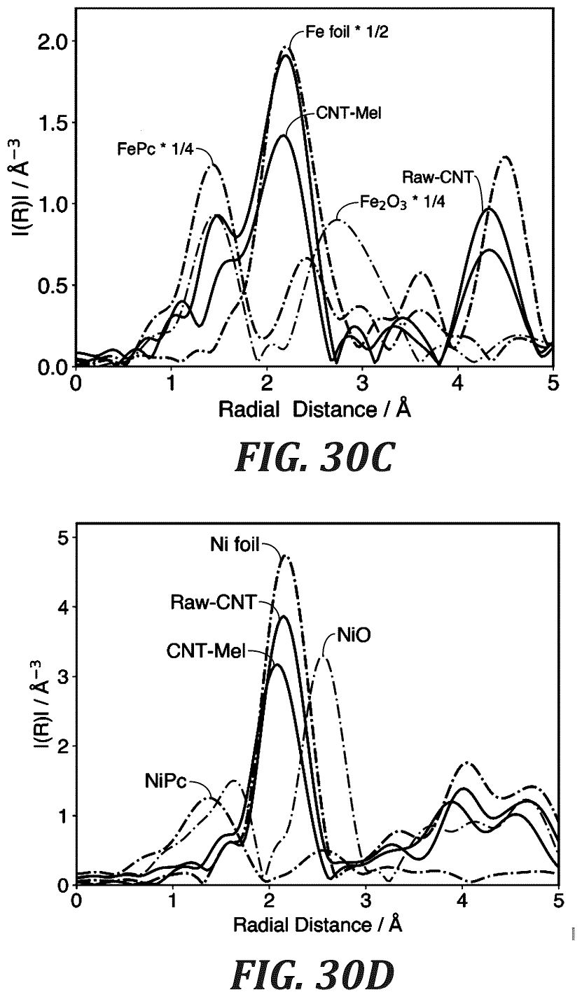

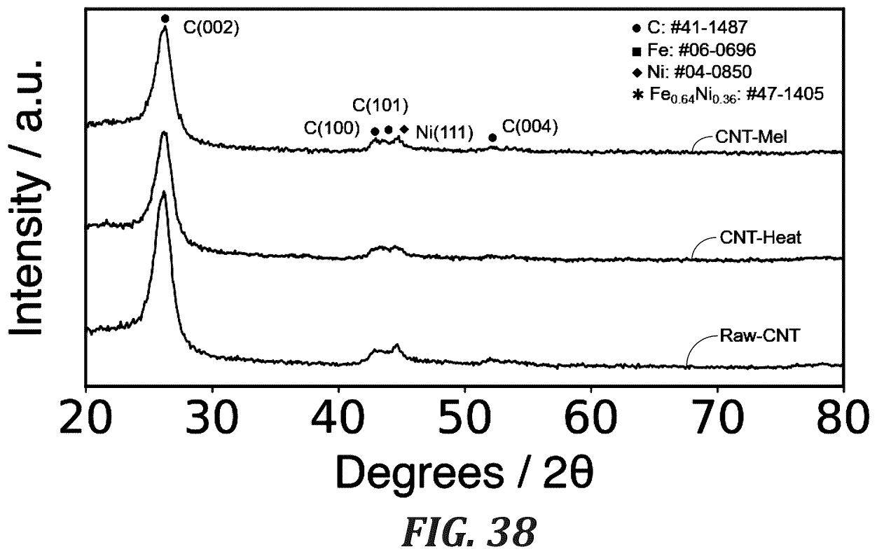

X-ray Diffraction (XRD) were conducted to analyze the crystal structure of the catalysts. As shown in FIG. 38, all samples reveal similar diffraction patterns, indicating a similar crystal structure. A major peak at 26° corresponds to C (002). A broad peak comprising two minor peaks between 42° and 43° correspond to the two-dimensional carbon lattice, C (100) and C (101), respectively, agreeing with a typical carbon nanotube XRD pattern. A minor peak close to 44° could be assigned to either Ni (111) or Fe (110) since they overlap. However, from STEM/EDS (FIG. 29), Ni elements exist primarily as nanoparticles, while Fe elements dominate the single atom sites; thus, the peak at 44° more likely corresponds to Ni metal nanoparticles because Fe single atomic sites cannot be detected by XRD. The existence of bimetallic FeNi cannot be ruled out because the FeNi peak overlaps with C (100) peak that is close to 42°; however, the quantity of such bimetallic sites is small, if any, because no major NiFe peaks are observed, unlike those reported in the literature. This is consistent with the observations by STEM/EDS (FIG. 29) and XAS (FIG. 30) analyses, which demonstrate most of the Ni elements exist in the system as nanoparticles encapsulated by carbon layers.

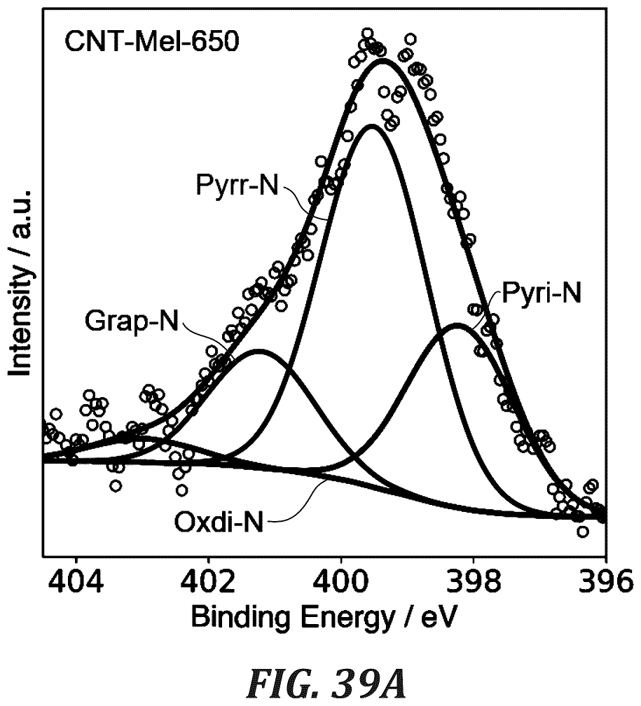

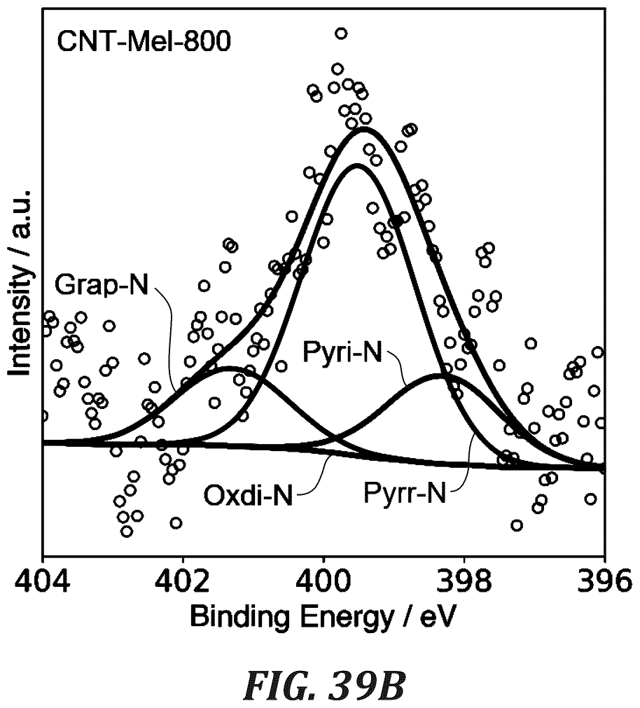

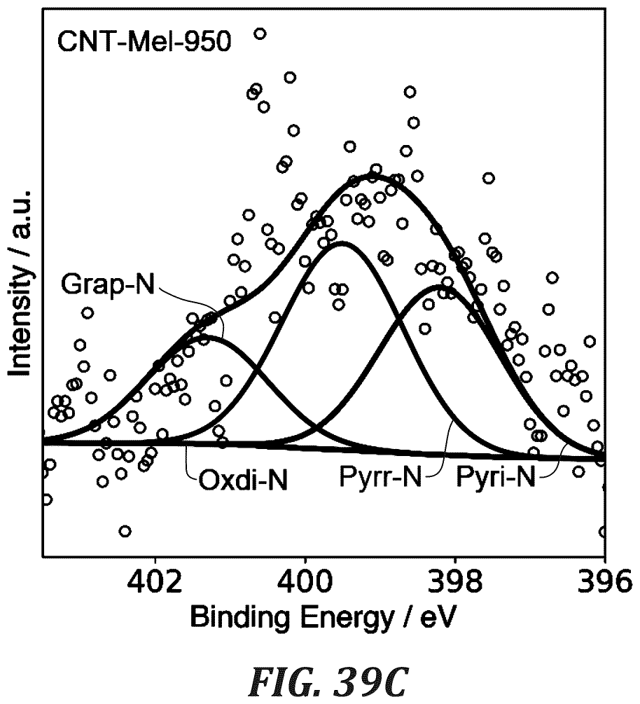

To further understand the surface element composition, X-ray photoelectron spectroscopy (XPS) was conducted. As revealed in Table 7, the surface N content decreases with the pyrolysis temperature, from 1.3 at. % on CNT-Mel (650° C.) to 0.7 at. % on CNT-Mel (800° C.) and 0.6 at. % on CNT-Mel (950° C.). This is possibly because the nitrogen doping sites are less stable at a higher pyrolysis temperature. The surface Fe concentrations of the three samples are in the similar range of 0.4˜0.5 at. %, regardless of the pyrolysis temperature. The surface Ni concentration is much less than that of Fe, with less than 0.1 at. % at 650° C. and almost undetectable at 800° C. and 950° C. Because XPS is only sensitive to a depth of 5 to 10 nanometers from the surface, the result that Ni is at an extremely low content or even not detected by XPS further confirms that the majority of Ni elements are encapsulated by carbon layers and more Fe elements are exposed on the surface as single atom sites, which is consistent with the findings from the TEM/STEM analyses. These findings are also consistent with the theoretical calculation from the literature that Fe elements are stable as isolated atoms on the graphitic carbon surface while Ni tends to diffuse instantaneously at a high temperature. Furthermore, N is spectra are fitted to analyze the surface N composition, as shown in FIGS. 39A-39C. Four possible types of nitrogen species are fitted to the raw data, pyridinic N (398.2 eV), pyrrolic N (399.5 eV), graphitic N (401.3 eV), and N oxides (403 eV). The first three N species are found in the system, with pyrrolic N having the largest content. As pyrolysis temperature increases, the overall nitrogen peak becomes smaller with larger noises, representing the decrease of surface nitrogen content. Regardless of the pyrolysis temperature, the edge-located N species (pyrrolic N and pyridinic N) are dominating in CNT-Mel that contribute to active M-N sites responsible for catalyzing CO₂ to CO reduction.

TABLE 7
Surface nitrogen and metal concentration detected by XPS.

| | N concentration | Ni concentration | Fe concentration |
|---|---|---|---|
| Catalyst | (at. %) | (at. %) | (at. %) |
| CNT-Mel | 1.3 | ~0.1% | 0.4 |
| (650° C.) | | | |
| CNT-Mel | 0.7 | Not detected | 0.5 |
| (800° C.) | | | |
| CNT-Mel | 0.6 | Not detected | 0.4 |
| (950° C.) | | | |
| Raw-CNT | Not detected | ~0.1% | 0.5 |

X-ray absorption spectroscopy (XAS) was performed on Raw-CNT and CNT-Mel to compare their local arrangements of Ni and Fe atoms. Fe foil, Fe₂O₃, iron phthalocyanine (FePc), Ni foil, NiO, and nickel phthalocyanine (NiPc) were used as the standard references. As shown in FIG. 30A, X-ray absorption near edge structure (XANES) spectra, the Fe adsorption edge profiles of Raw-CNT and CNT-Mel are between Fe foil and Fe₂O₃, suggesting the oxidation state of these samples between 0 and +3. This is in agreement with the literature that single atomic sites of Fe typically possess an oxidation state between metallic (0) and fully oxidized state (+3). In CNT-Mel, this could be also due to the formation of Fe—N bonds, resulting in the increase of the oxidation state of the transition metals. In contrast, the XANES spectra of Ni edges of Raw-CNT and CNT-Mel in FIG. 30B reveal almost identical edge profiles, all close to that of Ni foil. This again confirms the oxidation states of Ni in both samples are close to 0.

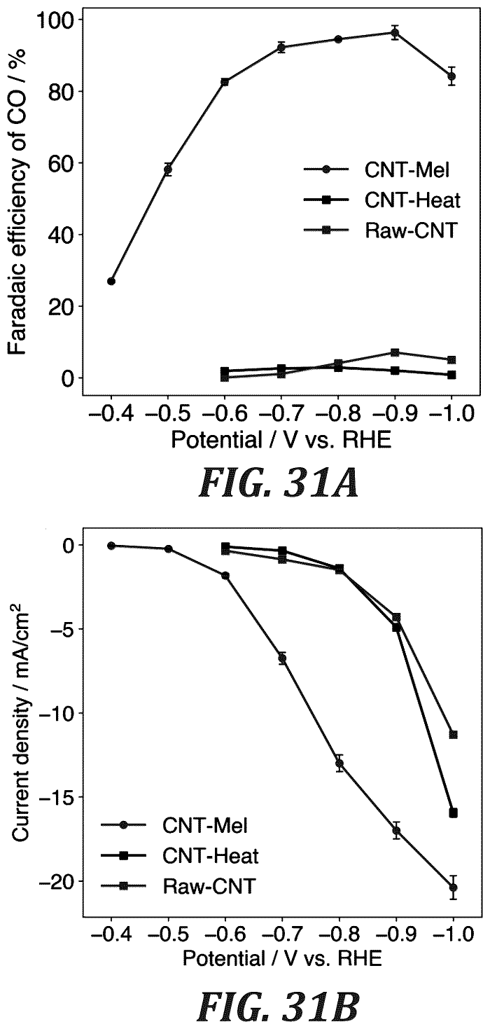

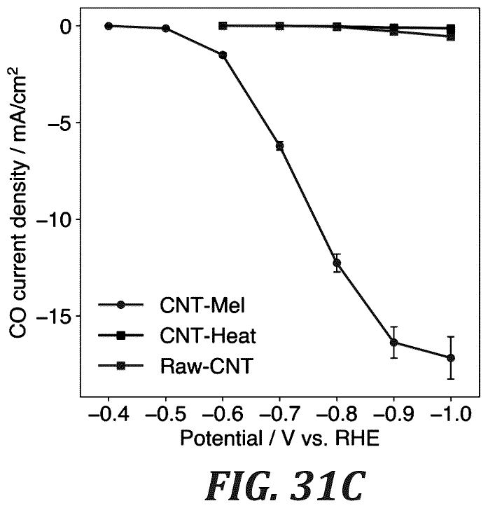

Furthermore, extended X-ray absorption fine structure (EXAFS) was analyzed to uncover the coordination environment of Fe (FIG. 30C) and Ni (FIG. 30D) atoms. In FIG. 30C both Raw-CNT and CNT-Mel show a peak at around 1.4 Å, which could be assigned to Fe—C, Fe—O (as in Fe₂O₃), and/or Fe—N(as in FePc), since they all have a similar bond length. Since N element is not present on Raw-CNT according to XPS (Table 7) and EDS (FIGS. 37A-37H) results, it is likely that Fe—C or Fe—O sites (due to oxidation of CNTs) exist on Raw-CNT. On the other hand, it is more likely that CNT-Mel is rich in Fe—N sites since N-doping in CNT-Mel is clearly evidenced by EDS (FIG. 29F) and XPS (Table 7) results; possible minor Fe—C or Fe—O sites may exist on CNT-Mel as well. However, based on the CO₂RR performance of Raw-CNT as shown in FIGS. 31A-31C, almost no CO production is observed, indicating the presence of Fe—C or Fe—O, if any, makes little contribution to CO₂ conversion to CO. Given all the evidence that Fe is atomically dispersed (STEM/EDS), Fe content on the surface is much higher than Ni (XPS), Fe oxidation state is in between 0 and 3 (EXANES), and Fe—N bonds are identified (EXAFS), it is concluded that Fe elements are present primarily as single atoms coordinated with N to form Fe—N sites on CNT-Mel. It is noticed that a peak at around 2.1 Å also exists in both Raw-CNT and CNT-Mel, likely corresponding to Fe—Fe or Fe—Ni bond. These bonds possibly exist inside the encapsulated nanoparticles or nanoclusters from the pristine CNTs.

The EXAFS plots of Ni edges in Raw-CNT and CNT-Mel in FIG. 30D show a predominate peak at 2.1 Å, corresponding to the Ni—Ni peak. Both samples reveal almost identical Ni bonding environments to that of Ni foil, while no obvious Ni—N bonds are observed. Combing the result that the Ni oxidation states are all close to 0 (FIG. 30B), it is confirmed that the Ni elements in these materials are primarily in the form of nanoclusters/nanoparticles encapsulated in carbon layers as shown in FIG. 29. Although the existence of single atomic Ni—N sites cannot be fully excluded, the lack of Ni—N bond from XAS and much less surface distribution of Ni than Fe from XPS suggest the quantity of such is small.

In summary, the above characterization results suggest the existence of both Fe and Ni elements in CNT-Mel. Both single-atomic sites and metal nanoparticles/nanoclusters are observed in the system. Single atomic sites are mostly Fe—N sites while Ni exists primarily as metal nanoparticles/nanoclusters encapsulated by the graphitic carbon layers.

### CO₂RR Performance Evaluation in H-Cell

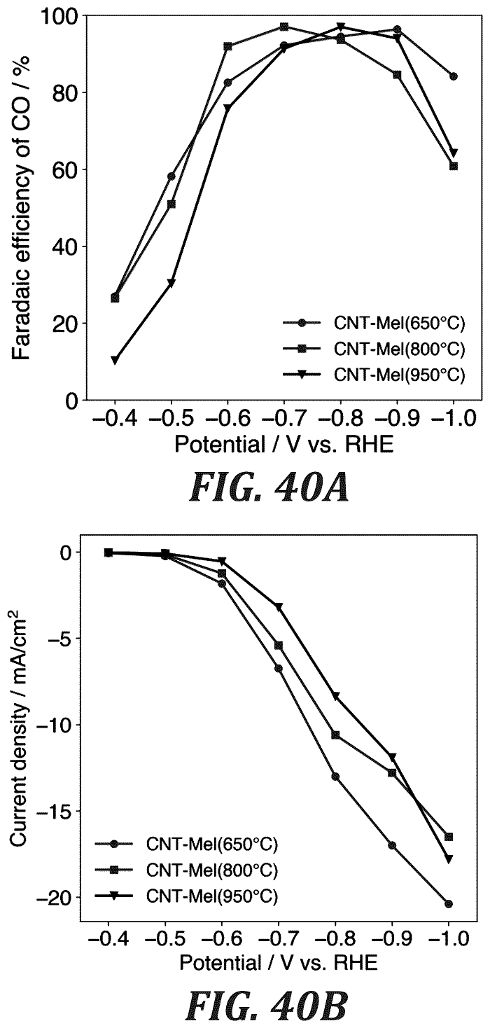

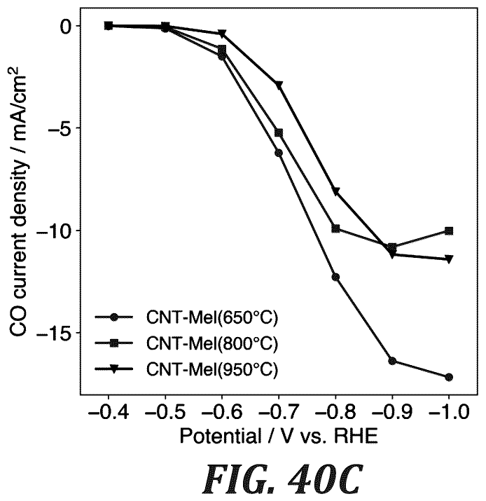

The electrochemical CO₂ reduction performance of CNT-Mel and CNT-Heat (no nitrogen doping) were evaluated firstly in a three-electrode H-Cell reactor. Synthesis of CNT-Mel at different pyrolysis temperatures (650, 800, and 900° C.) was conducted to investigate the optimal synthesis condition (FIGS. 40A-40C). From FIGS. 40A and 40B, the three samples do not exhibit very different FE(CO) and total current density, but CNT-Mel (650° C.), i.e., CNT-Mel in previous sections, shows a larger CO current density than the samples prepared at higher temperatures over the entire potential range tested (FIG. 40C). The lower CO₂RR performance for higher pyrolysis temperature samples may be due to the decreased surface nitrogen content, as revealed by the XPS results (Table 7), which may have led to a reduced number of M-N sites. We attempted to further decrease the pyrolysis temperature to 550° C., but a certain amount of the melamine precursor did not fully decompose, leading to a dark brown colored product instead of black CNT-based catalysts. As a result, 650° C. was identified as the optimal pyrolysis temperature, which is lower than those reported in many other studies required for producing single atomic M-N—C catalysts using other precursors and methods (Table 8). This is another advantage of the synthesis method of the present disclosure.

TABLE 8
Comparison between the catalyst in this work with state-of-the-art Fe-based/Ni-based catalysts in the H-Cell.

| | | Post- | Metal | Synthesis | | | | Jco | | Potential | | KHCO₃ |
|---|---|---|---|---|---|---|---|---|---|---|---|---|
| Catalyst | Pre-treat | wash | precursor | condition | | FE(CO) | | (mA/cm²) | | (V vs RHE) | | (M) |
| CNT-Mel | No | No | No | 650° | C. | 94% | | 12.3 | | −0.8 | | 0.5 |
| Fe_{0.5}d | ZIF-8 Synthesis | Yes | Yes | 1050° | C. | 80% | (50%) | 4.5 | (6) | −0.5 | (−0.8) | 0.5 |
| Fe—N₅ | GO synthesis | Yes | Yes | 800° | C. | 97% | (50%) | 2 | (4.5) | −0.46 | (−0.8) | 0.1 |
| Fe—N/O—C | Freeze drying | Yes | Yes | 1000° | C. | 96% | (80%) | 5.6 | (12) | −0.57 | (−0.77) | 0.1 |
| Fe—NS—C | Polymerization | Yes | Yes | 900° C., | | 93% | | 12.1 | | −0.56 | | 0.5 |
| | | | | twice | | | | | | | | |
| Fe—N—C | Silica template | Yes | Yes | 1000° C., | | 81% | (50%) | 2.8 | (4) | −0.57 | (−0.8) | 0.5 |
| | | | | twice | | | | | | | | |
| Fe—N—C | ZIF-8 | No | Yes | 1000° | C. | ~90% | (40%) | ~1 | (~2) | −0.5 | (−0.8) | 0.5 |
| SMFeSCN | SBA-15 | Yes | Yes | 900° C., | | 99% | (60%) | ~3.5 | (~11) | −0.55 | (−0.8) | 0.1 |
| | template | | | twice | | | | | | | | |
| Fe—N—PC | Strong | No | Yes | 900° | C. | 63% | (20%) | 3.2 | (~5) | −0.5 | (−0.8) | 0.5 |
| | acid/oxidant | | | | | | | | | | | |
| NC@Fe | Wet | Yes | Yes | 800° | C. | 90.6% | (~45%) | 0.75 | (~1.1) | −0.6 | (−0.8) | 0.1 |
| | impregnation | | | | | | | | | | | |
| Fe—N- | Strong | No | No | 900° | C. | 95% | | 10.7 | | −0.76 | | 0.1 |
| CNT@GNR-2 | acid/oxidant | | | | | | | | | | | |
| Fe-CNPs | Silica | Yes | Yes | 1000° | C. | 98.8% | (~80%) | ~6 | (~11) | −0.58 | (−0.78) | 1 |
| | template/ZIF | | | | | | | | | | | |
| Fe—N-G-p | GO synthesis/ | No | Yes | 900° | C. | 94% | (~60%) | 4.3 | (6.5) | −0.58 | (~−0.75) | 0.1 |
| | H₂O₂ etching | | | | | | | | | | | |
| Fe—N—C | ZIF, washing | No | Yes | 1000° | C. | ~90% | (~50%) | ~5 | (~9) | −0.5 | (−0.8) | 0.5 |
| Fe/NG | GO synthesis, | No | Yes | 750° | C. | 80% | (60%) | ~1.5 | (~2.5) | −0.6 | (−0.8) | 0.1 |
| | freeze drying, | | | | | | | | | | | |
| | etc. | | | | | | | | | | | |

| | | | | | | | | | |
|---|---|---|---|---|---|---|---|---|---|
| NC-CNT(Ni) | Polymerization, | No | No | 800° | C. | 90% | ~7 | −0.8 | 0.1 |
| | hydrothermal | | | | | | | | |
| Ni-PACN | Polymerization | No | Yes | 900° | C. | 99% | −21 | −1.1 | 0.1 |
| Ni/NC | Wet | No | Yes | 950° | C. | 92.3% | −5 | −0.8 | 0.1 |
| | impregnation | | | | | | | | |
| Ni—NCH-1000 | Silica template | Yes | Yes | 1000° | C. | 94% | −25.4 | −0.9 | 0.1 |
| Ni—N—C | Silica template | Yes | Yes | 1000° | C. | 87% | −1.5 | −0.57 | 0.5 |
| Ni1000 | Polymerization | Yes | Yes | 1000° | C. | 90% | −4.4 | −0.8 | 0.1 |
| Ni—N/CNT-50 | MOF synthesis | Yes | Yes | 800° | C. | ~100 | −22 | −0.8 | 0.5 |
| Ni-SAs | MOF synthesis | Yes | Yes | 1000° | C. | 97 | ~−8 | −0.8 | 0.5 |
| Ni-NG | GO synthesis, | No | Yes | 750° | C. | 95 | −11 | −0.75 | 0.5 |
| | wet impregnation | | | | | | | | |
| Ni—N—C | Wet | Yes | Yes | 900° | C. | ~80 | −12 | −0.85 | 0.1 |
| | impregnation, | | | | | | | | |
| | hydrothermal | | | | | | | | |

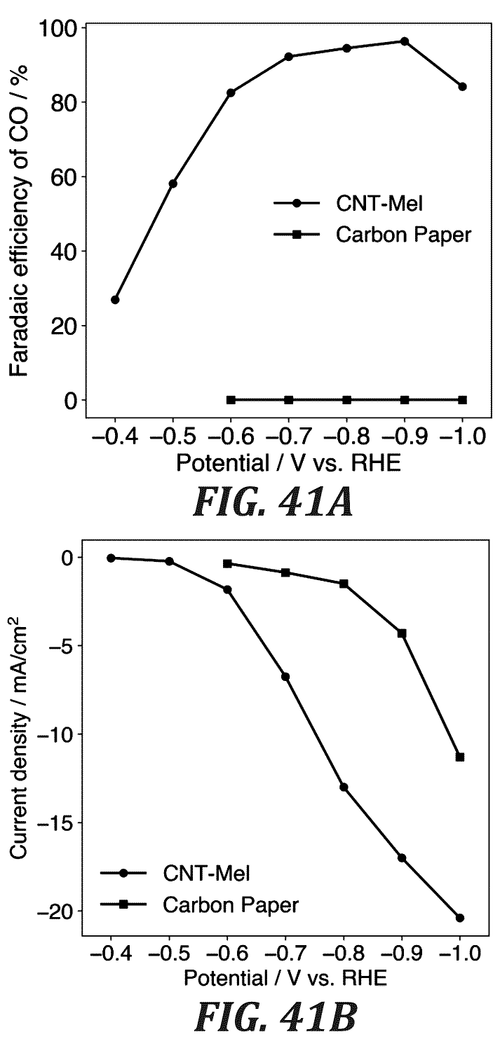

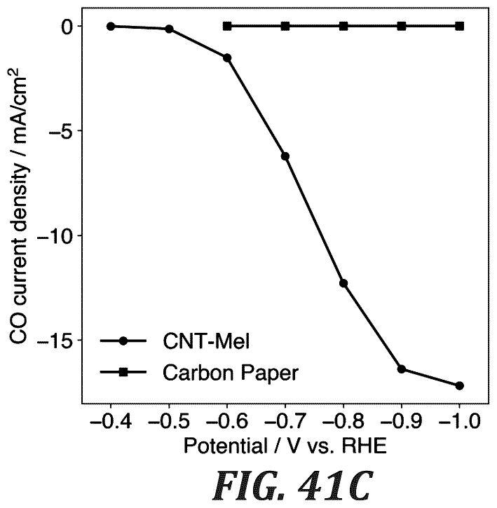

The Faradaic efficiency of CO (FE(CO)), total current density, and the partial CO current density of the optimized sample CNT-Mel (corresponding to 650° C. pyrolysis temperature if not mentioned otherwise) are shown in FIGS. 31A-31C. As revealed in FIG. 31A, FE(CO) of CNT-Mel reached a high value (above 90%) in a wide potential range, from −0.7 V to −0.9 V vs. RHE, and the current density of CO reached 12.3 mA/cm² at −0.8 V vs. RHE (FIGS. 31B and 31C). In contrast, the control sample CNT-Heat and Raw-CNT had near zero FE(CO) and CO current density, and the total current produced was exclusively attributed to hydrogen evolution (FIGS. 31A-31C). In the CO₂RR process, it has been widely accepted that the single atomic metal-nitrogen active sites (primarily Fe—N and Ni—N) are efficient to facilitate the formation of COOH* intermediates and the desorption of CO*. The much lower reaction rate of the control CNT-Heat and Raw-CNT samples than that of CNT-Mel is aligned with the literature findings. This also indirectly proves that the single atomic sites that exist in CNT-Mel are mostly Fe—N instead of Fe—O or Fe—C that exists in Raw-CNT. In addition, no CO₂RR performance is observed with plain carbon paper, as shown in FIGS. 41A-41C. Furthermore, the carbon in the CO product has been widely proven to originate from CO₂ instead of carbon catalyst or carbon paper through isotope studies in the literature. Thus, the CO produced in this work is from CO₂ not from carbon content in the catalyst or carbon paper.

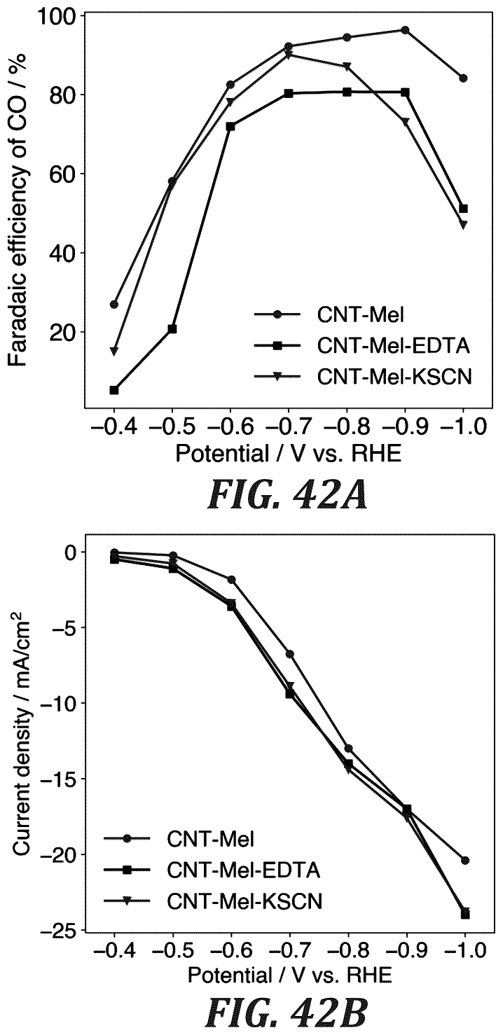

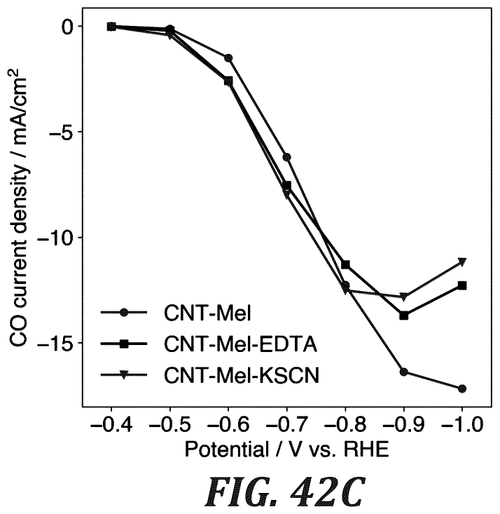

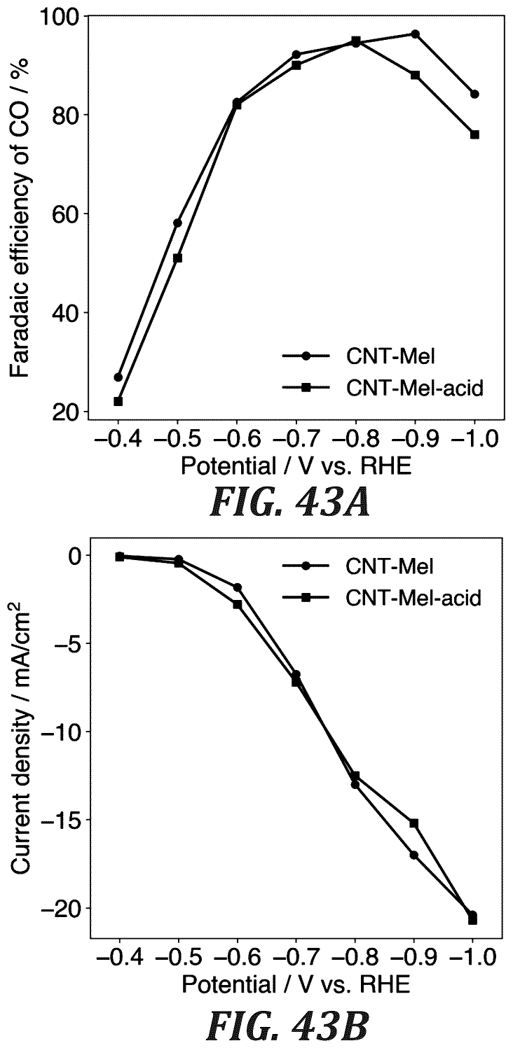

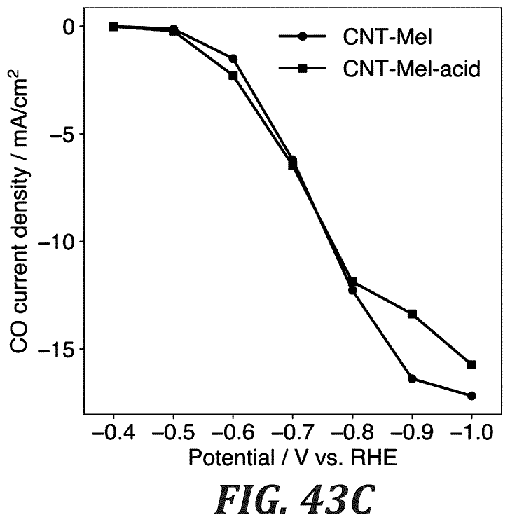

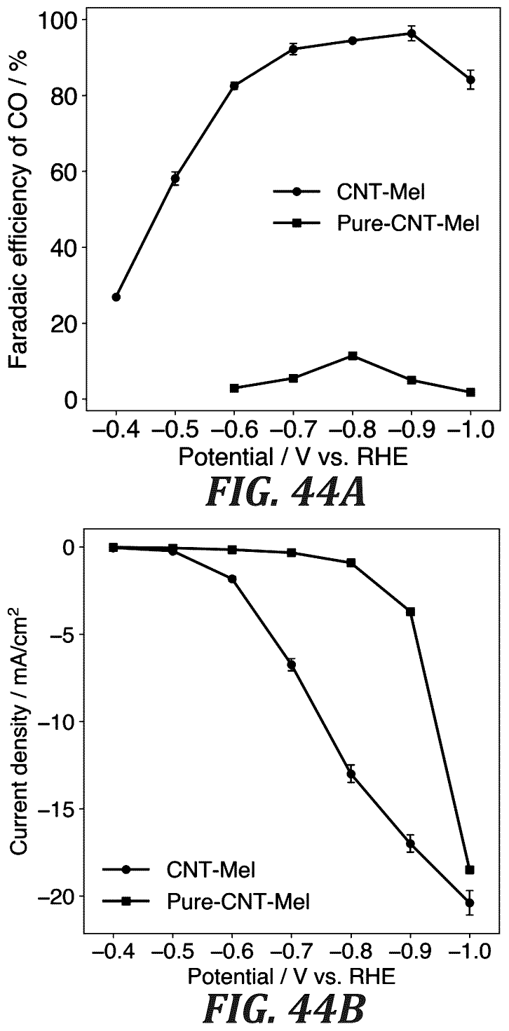

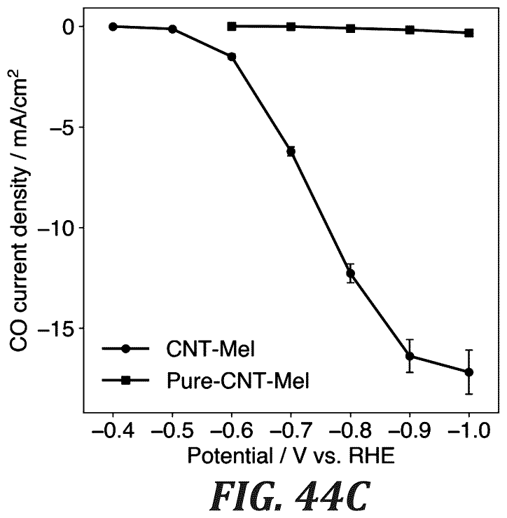

To better understand the active sites, poisoning experiments were conducted using ethylenediaminetetraacetic acid (EDTA) and potassium thiocyanate (KSCN). As shown in FIGS. 42A-42C, CNT-Mel with both KSCN and EDTA poisoning show a reduced CO₂RR performance, indicating the poisoning effect on the active sites. EDTA tends to bind only with single atomic sites, and thus, the reduction of CO₂RR performance of both Faradaic efficiency of CO and CO partial current density in CNT-Mel-EDTA suggests single atomic site being the major contributor to the high CO₂RR performance. Moreover, KSCN tends to bind with both metal single atomic sites and metal nanoparticles, and thus a higher poisoning effect by KSCN than by EDTA would be anticipated if metal nanoparticles contribute to the electrochemical performance. The similar performances of CNT-Mel-EDTA and CNT-Mel-KSCN in FIGS. 42A-42C indicate minimal contribution from metal nanoparticles in CNT-Mel, likely because these metal nanoparticles are encapsulated by carbon layers and are inaccessible to the poisoning reagents. This conclusion is further confirmed by comparing the activity of CNT-Mel with the acid-washed sample, the latter of which should have no exposed metal nanoparticles. As shown in FIGS. 43A-43C, CNT-Mel and CNT-Mel-acid samples show similar CO₂RR performance, indicating no significant amount of exposed metal nanoparticle on the catalyst surface.

To study whether N-doped CNTs (without single metal atoms) are active for CO₂RR, we have conducted a control experiment using high-purity CNTs (>99.9% carbon) from the same vendor that has minimal metal impurity (Pure-CNT) to compare with the Raw-CNT (>95% carbon) that has up to 5% metal impurity. Pure-CNT was then doped with N through pyrolysis with melamine to form Pure-CNT-Mel following the same procedure as preparing CNT-Mel. As shown in FIGS. 44A-44C, almost no activity of CO₂RR was found in Pure-CNT-Mel, indicating N-doping alone without metal on CNTs has little contribution. Meanwhile, Raw-CNT and CNT-Heat samples, both having metal impurities but no N-dopants, showed little CO₂RR activity as well. These results confirm the importance of having both metal and nitrogen doping to activate CO₂RR.

There is one scenario that metal nanoparticles could possibly contribute to CO₂RR when the encapsulating carbon layer is composed of single atomic M-N sites or N-doped carbon. Such metal nanoparticles coupled with pyrrolic N species (FIGS. 39A-39C) have been found effective to resist the poisoning test. As also revealed in our prior work, through density functional theory (DFT) calculations, there exists a synergetic effect from Fe—N sites and encapsulated Ni nanoparticles that enhances CO₂RR performance by reducing the desorption energy of *CO intermediates. Such a synergy may exist on the CNT-Mel catalyst in this work, but it is experimentally challenging to decouple this synergistic effect from the single atomic sites alone, which is believed to be the major contributor to the catalytic performance.

It should be noted that because of the coexistence of Fe and Ni impurities of commercial CNTs with atomic metal forms being mostly from Fe elements and Ni nanoparticles being encapsulated in carbon, it is impossible to completely remove one of the metals to form pure Fe—N—C or Ni—N—C catalysts as control samples to compare with the CNT-Mel where Fe and Ni coexist. Nevertheless, the characterization, various control experiments and poisoning-experiment results in correlation with the activity data suggest the major contribution to CO₂RR performance is from Fe—N single atomic sites on CNTs and possible secondary contribution is from the synergetic effect between Fe—N or N-doped carbon and the encapsulated Ni NPs.

Co₂RR Performance in Flow Cell in Different Co₂ Partial Pressure Environments

### Co₂RR Performance at Different Current Densities

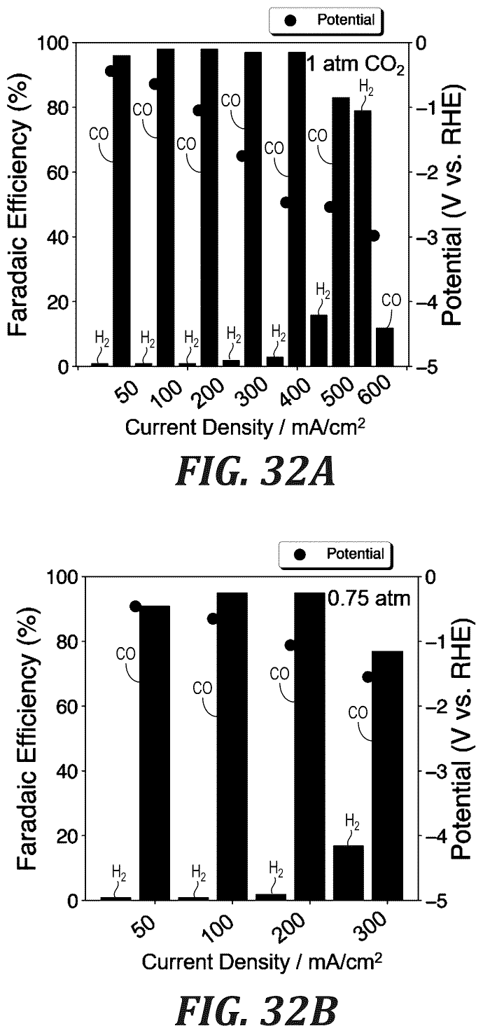

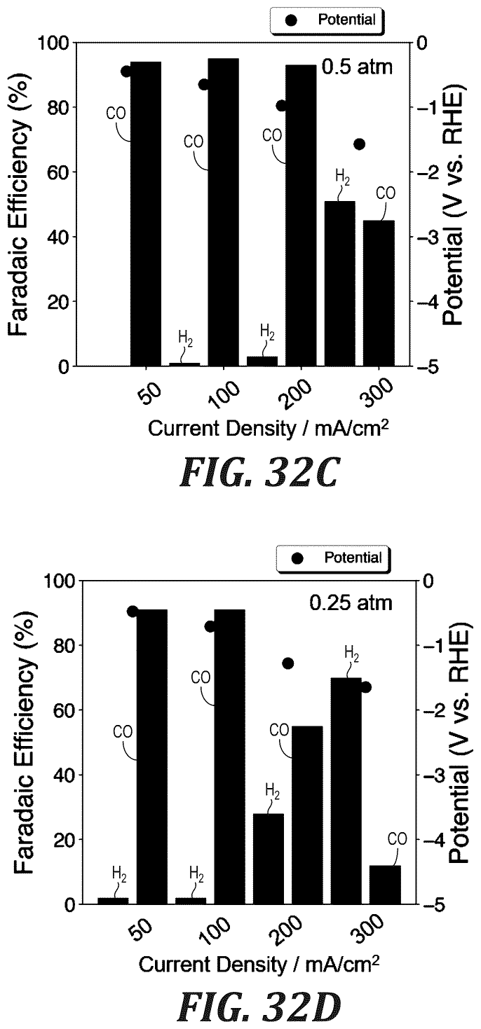

As revealed in FIG. 32A, the selectivity of CO remained above 90% at a wide range of current densities, from 50 to 500 mA/cm². Specifically, the Faradaic efficiency of CO is 98% at 100 mA/cm² and 97% at 400 mA/cm². The cathode potential is measured to be −0.64 V vs. RHE without iR compensation at 100 mA/cm² with a total cell voltage of 2.98 V. These results indicate commercially-viable current densities.⁴

Furthermore, different concentrations of CO₂ sources were used for the flow cell tests to study the effects of CO₂ partial pressure. As revealed in FIGS. 32A-32D, four samples show similar cathode potentials, indicating that no additional energy input is required when switching to the diluted environment. However, the CO selectivity starts to decrease to around 77% at a current density of 300 mA/cm² in 75% CO₂ environment (FIG. 32B). In FIG. 32C, the CO selectivity in 50% CO₂ environment reaches around 45% at 300 mA/cm². In 25% CO₂ environment (FIG. 32D), the CO selectivity is around 12% at 300 mA/cm². These results show a trend that electrolysis starts to generate more H₂ and less CO at a lower current density, as feed CO₂ concentration decreases. This is likely because smaller areas of the catalyst surface are covered by CO₂ in a more diluted environment, leading to a higher HER reaction rate at higher current densities.

### CO₂RR Stability Tests

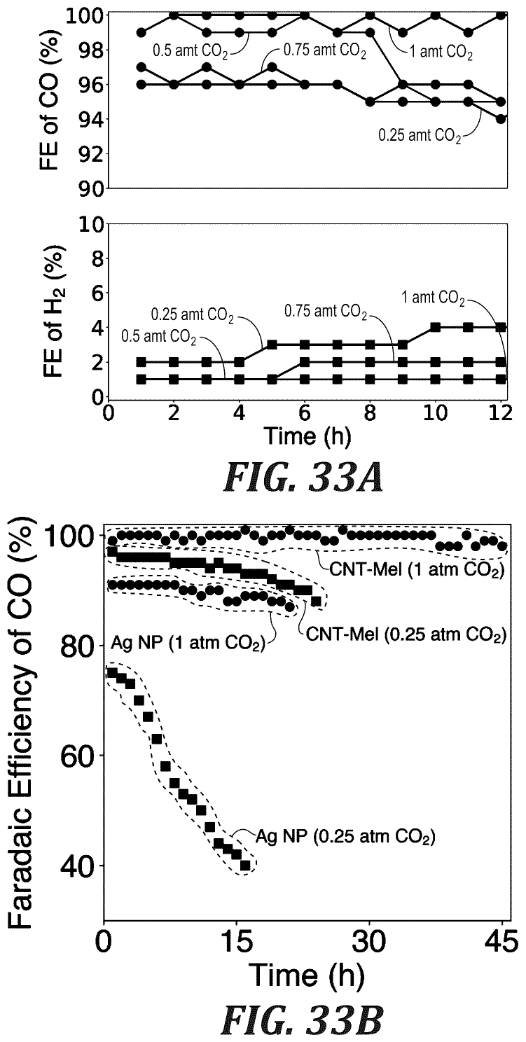

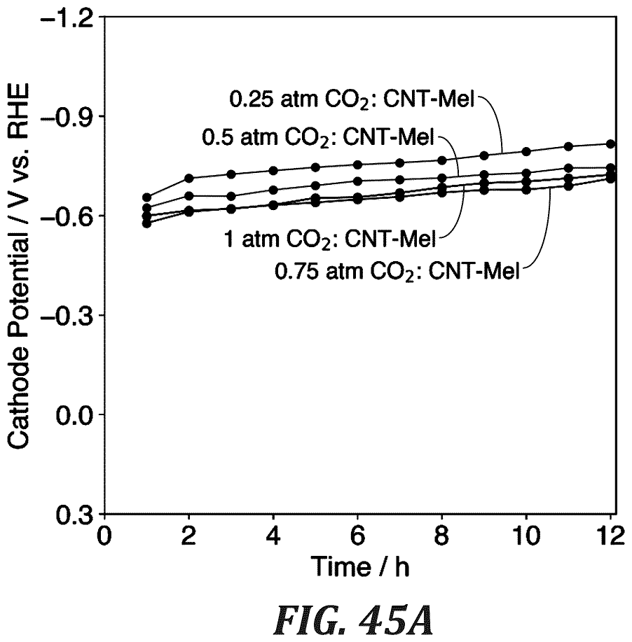

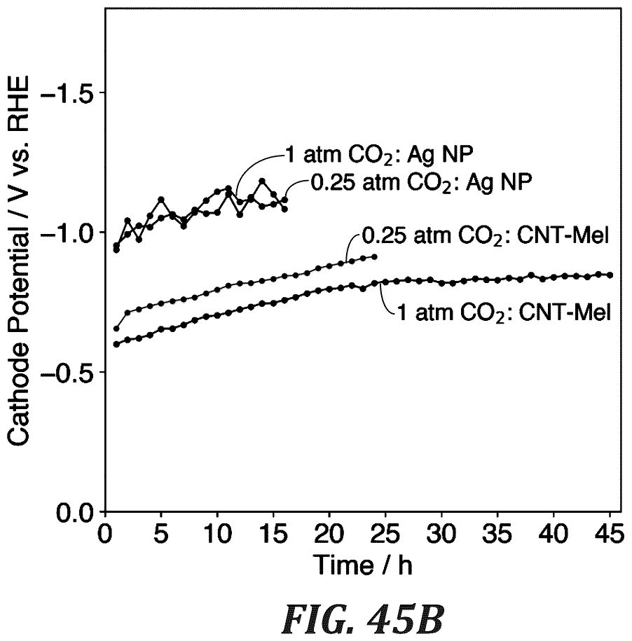

To demonstrate the stability of CNT-Mel, longer term tests at different CO₂ partial pressure environments were conducted at a current density of 100 mA/cm². As revealed in FIG. 33A, the performance of CNT-Mel does not show an obvious decrease in the 12-h test at all four CO₂ concentrations, maintaining a high FE(CO) above 90%. In an even longer-term testing as shown in FIG. 33B, CNT-Mel shows stable performance with more than 95% FE(CO) for 45 h in 100% (1.0 atm) CO₂ environment, while in 0.25 atm CO₂ environment, the CO selectivity slightly decreases from 99% to 90% after 24 h. For comparison, a benchmark catalyst, commercial silver nanoparticles (Ag NPs) were tested, which showed a lower stability in both 1.0 and 0.25 atm CO₂ environments. In particular, the stability of Ag catalyst in 0.25 atm CO₂ is much worse, with FE(CO) dropping from 76% to 39% in 24 h. This demonstrates the significant advantage of the prepared M-N—C catalysts as a cost-effective solution for CO₂RR in large scale applications. The stability of cathode potential is shown in FIGS. 45A and 45B. The cathode potentials of all samples (including Ag catalyst) showed a slight increase at about 0.1 V in 12 h. In a longer term 45 h test of CNT-Mel, the potential increased by about 0.2 V and appeared to level off after 24 h. It is worth noting that all samples showed the same trend, independent to the catalytic selectivity performance as shown in FIGS. 33A and 33B, suggesting this is unlikely a catalyst-specific issue. Common issues in alkaline CO₂ flow cells caused by (bi)carbonates formation during electrolysis. Generation of these (bi)carbonates consumes OH⁻ and increases the cathode impedance. Separate studies on electrolyzer design are needed to overcome the practical challenges in large-scale CO₂RR application.

### Universality and Scalability in Materials Synthesis Investigation of the Method Universality by Using Different Types of Nitrogen Precursors and Brands of CNTS

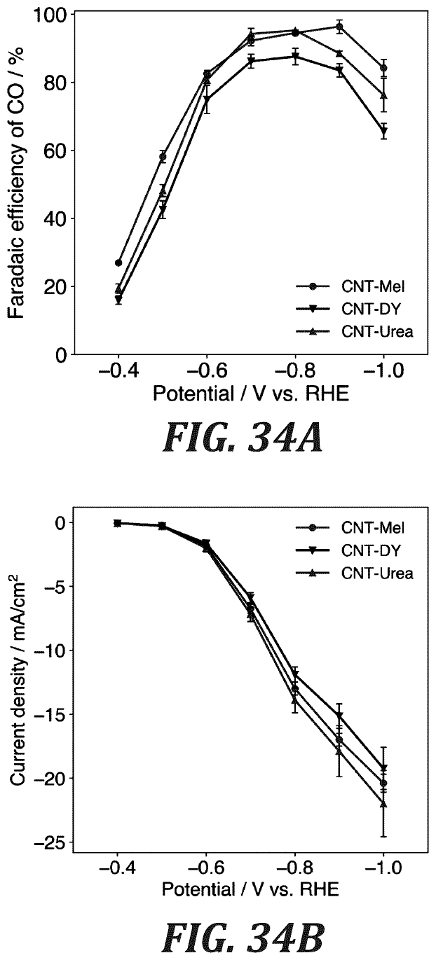

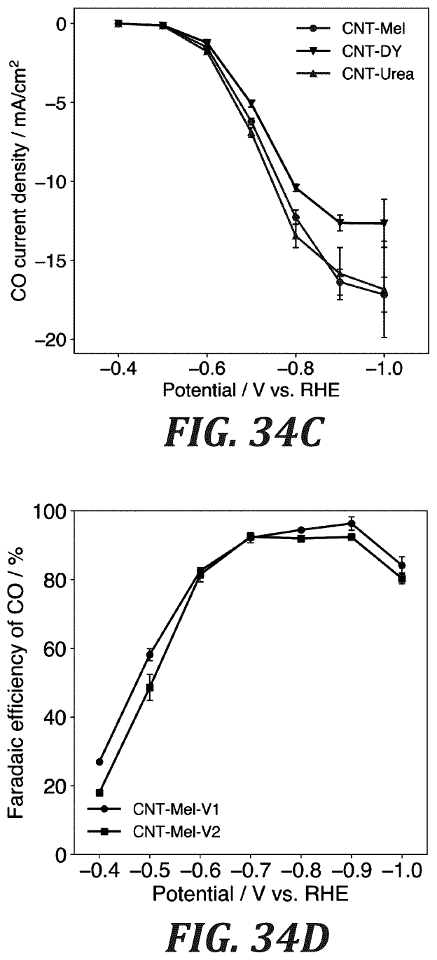

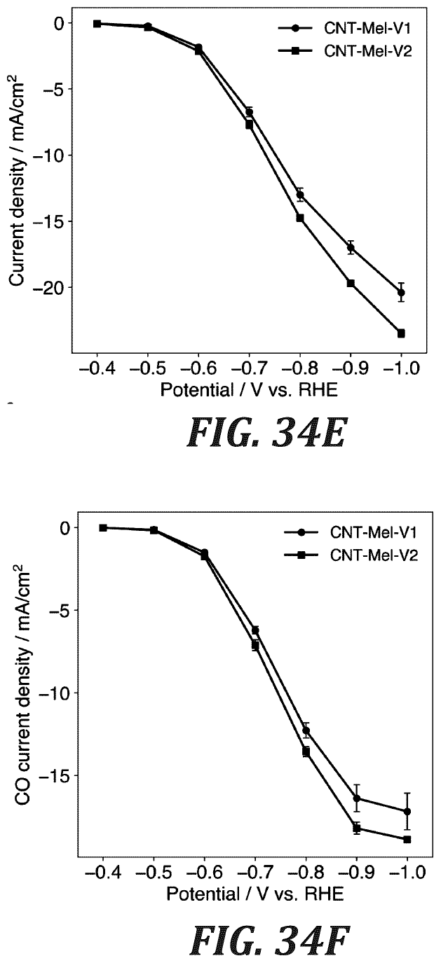

To further demonstrate the universally applicable nature of the synthesis method in this work, catalysts were prepared using two other widely used short-chain nitrogen precursors, urea and dicyandiamide. As shown in FIGS. 34A-34C, CNT-Mel and CNT-Urea demonstrated comparable CO₂RR performance and were slightly better than CNT-DY. All three samples had much higher performance than the control sample CNT-Heat that had no nitrogen doping (FIG. 31). This result indicates that the developed method in this work can be extended to many other nitrogen precursors to generate the M-N—C catalysts based on commercial CNTs.

Furthermore, commercial CNTs from two vendors were used to synthesize CNT-Mel-V1 and CNT-Mel-V2 and their CO₂RR performances were compared. As shown in FIGS. 34D-34F, both catalysts show similar results in terms of FE(CO) and current density. This indicates the synthesis method developed in this work can be extended to commercial CNTs from different manufacturers, besides the flexibility of nitrogen precursors.

### Investigation of Scalability of Synthesis and Repeatability of Performance

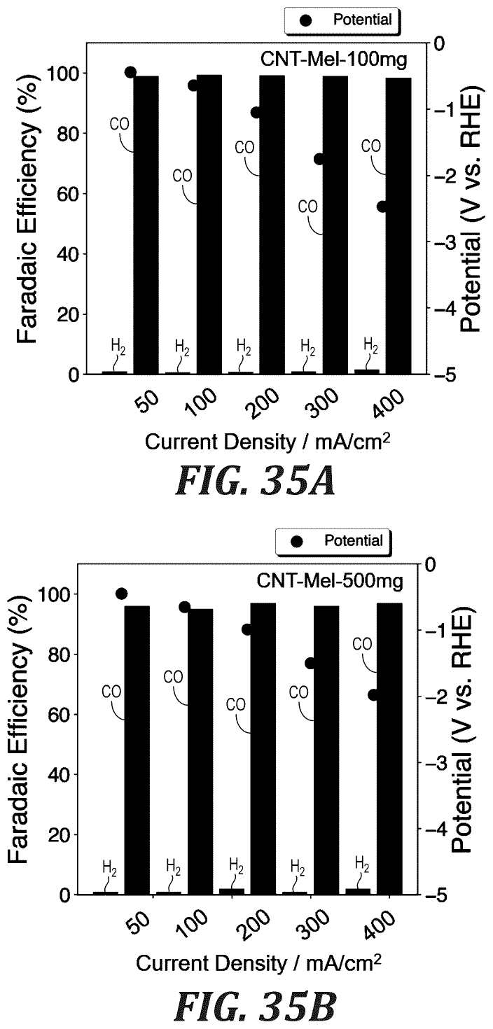

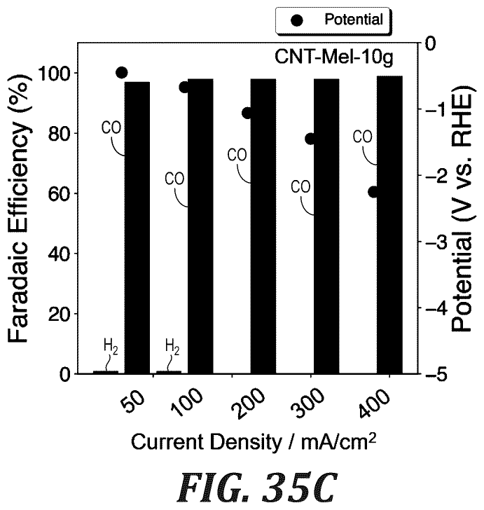

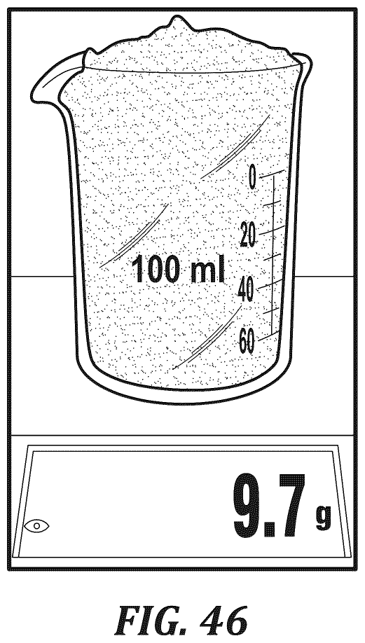

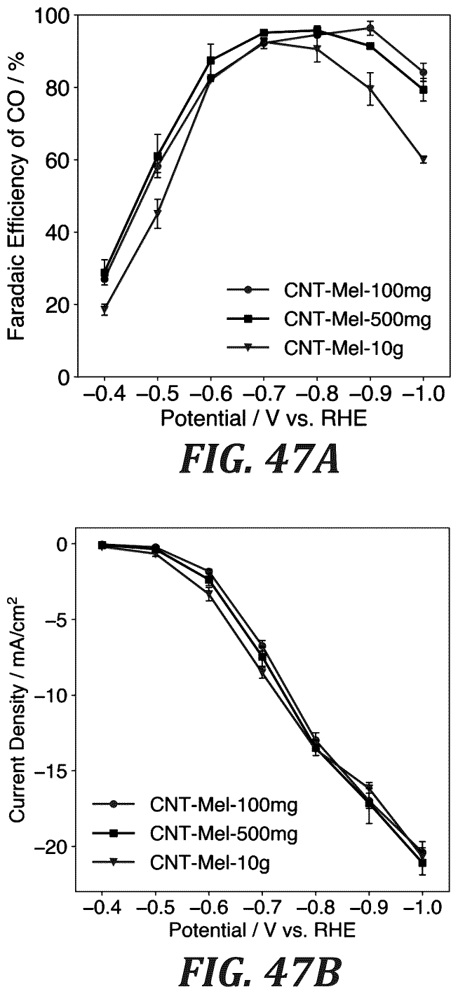

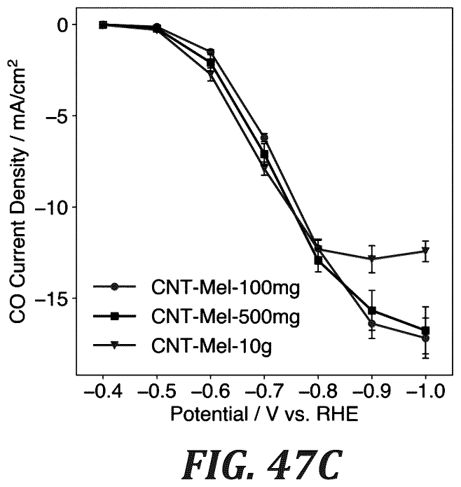

To further demonstrate the scalability of the synthesis method in this work, a series of batches with different mass (0.1, 0.5, and 10 g) were synthesized, denoted by CNT-Mel-100 mg, CNT-Mel-500 mg, and CNT-Mel-10 g, respectively. CNT-Mel-100 mg, i.e., CNT-Mel denoted elsewhere in the work, set the baseline for the catalyst performance, as shown in FIGS. 31A-31C, and is later compared with the other two later batches. The melamine/CNT mass ratio was also reduced from 10 to 4 in the larger two batches to investigate the possibility of saving nitrogen precursors. FIG. 46 shows the photo of the 10 g batch, which corresponds to approximately 150 ml in volume. As revealed in FIGS. 47A and 47B H-cell testing, the CO₂RR performances of both CNT-Mel-500 mg and CNT-Mel-10 g are comparable to that of CNT-Mel-100 mg, especially at the optimum potential range (−0.6˜−0.8 V vs. RHE), indicating the scalability of the synthesis method with good catalytic performance maintained. Furthermore, the flow cell testing results as shown in FIGS. 35-35C indicate that all three samples (CNT-Mel-100 mg, CNT-Mel-500 mg, and CNT-Mel-10 g) had similar CO₂RR performance (>95% FE CO) in the current density range from 50 to 400 mA/cm². This manufacturing method is further scalable by using larger apparatus such as a larger mixer and pyrolysis furnace because it only includes simple mixing and pyrolysis of commercial raw materials, indicating a great potential for mass production to meet industrial needs.

### Comparison to the Literature

We further compared the synthesis method and CO₂RR performance to the literature. As shown in Table 8, regarding H-Cell performance, the catalyst prepared in this work is among the top-level performances for Fe-based and Ni-based catalysts, with this method requiring significantly fewer treatment steps under milder synthesis conditions. In addition, as shown in Table 9, the synthesis method achieves one of the largest batches reported in the literature, indicating a significant advantage of this work on potential future mass applications.

TABLE 9
Comparison of the mass of catalysts synthesized in one batch for
high-performing Fe or Ni-based M-N-C catalysts in the literature.

| | | One-Batch | | |
|---|---|---|---|---|
| | Carbon | Catalyst | | |
| Catalyst | Precursor | Mass | | Literature |
| CNT-Mel-10 g | CNT | ~10 | g | This work |
| FeNC | Carbon black | 0.4 | g | Chem. Sci., 2018, 9, |
| | | | | 5064-5073 |
| Ni SAs/NCNTs | ZIF-8 | 0.2 | g | Applied Catalysis B: |
| | | | | Environmental 241 |
| | | | | (2019) 113-119 |
| Fe—N/ | CNT | 0.5 | g | ACS Nano 2020, 14, |
| CNT@GNR-2 | | | | 5, 5506-5516 |
| Fe—N—C | Carbon black | 0.4 | g | Energy Environ. Sci., |
| | | | | 2019,12, 640-647 |
| Fe/NG-750 | Graphene | 0.2 | g | Adv. Energy Mater. |
| | | | | 2018, 1703487 |
| Fe—N—C | ZIF-8 | 0.4 | g | J. Am. Chem. Soc. |
| | | | | 2019, 141, 31, |
| | | | | 12372-12381 |
| Ni@NiNCM | o- | 0.25 | g | Angew. Chem. 2021, |
| | phenylendiamine | | | 133, 12066-12072 |
| NiSA/N—C | g-C₃N₄ | 0.05 | g | Nano Energy 77 |
| | | | | (2020) 105158 |
| Ni—N—C | Graphene | 0.09 | g | Nature Chemistry |
| | quantum dots | | | volume 13, |
| | | | | pages887-894 (2021) |
| FeNC/NiNC | ZIF-8 | 0.4 | g | ACS Catal. 2019, 9, |
| | | | | 11, 10426-10439 |
| Fe—NC SAC | Porous carbon | 0.06 | g | Nature |
| | | | | communications |
| | | | | 10.1 (2019): 1-11 |
| Fe—N-G-p | Graphene | 0.1 | g | ACS Catal. 2020, 10, |
| | | | | 19, 10803-10811 |

Note:
most of the literature did not directly report one-batch mass of catalyst, however, the maximum amount of catalyst can be calculated based on the precursor composition and pyrolysis temperature since the nitrogen precursors usually completely decompose during the high-temperature pyrolysis (>800° C.) and metal contents in the form of single atoms do not contribute much to overall catalyst mass (usually less than 5 wt. %). Typically, the mass of carbon from the precursor determines the final mass of the catalyst. In Table 9, the one-batch catalyst mass is calculated based on the following conditions: (1) when the carbon precursor is carbon allotropes (e.g., CNT, carbon black, etc.), the catalyst mass is roughly equal to the mass of carbon precursor; (2) when the carbon precursor is organic materials (e.g., ZIF-8), the actual catalyst mass would be significantly smaller than the carbon precursor mass, because organic materials decompose significantly during carbonization process, and as a result, an estimated 50% mass conversion from precursor to catalyst is applied according to the literature.

As listed in Table 10, regarding the flow cell performance, the catalyst synthesized in this work demonstrates one of the best performances while the duration of our stability tests is longer than those in the literature.

TABLE 10
Comparison between the catalyst in this work with state-of-the-art Fe-based/Ni-
based M-N-C catalysts in the flow cell when running long-term tests.

| | | CO | | | |
|---|---|---|---|---|---|
| | | selectivity | Jco | Potential | Stability |
| Catalyst | Electrolyte | (%) | (mA/cm²) | (V vs. RHE) | (h) |
| CNT Mel | 1M KOH | 9 | 99 | −0.78 | 45 |
| (100% CO₂) | | | | | |
| CNT-Mel | 1M KOH | 94 | 94 | −0.8 | 24 |
| (25% CO₂) | | | | | |
| Fe-SAs | 0.5M KHCO₃ | 99.5 | 30 | −0.9 | 18 |
| (100% CO₂) | | | | | |
| Fe—N—C | 1M KHCO₃ | 20 | 20 | −0.8 | N/A |
| (100% CO₂) | | | | | |
| Ni—N—C | 1M KHCO₃ | 80 | 160 | −0.8 | 20 |
| (100% CO₂) | | | | | |
| Ni-SAC | 0.5M KHCO₃ | 90 | 20 | −0.8 | N/A |
| (100% CO₂) | | | | | |
| NiPcP | 1M KOH | 99.13 | 197 | −0.5 | N/A |
| (100% CO₂) | | | | | |
| Ni—N—C | 0.5M KHCO₃ (C)/ | 90 | 90 | −1.0 | 24 |
| | 2M KOH (A) | | | | |
| Fe—N—C | 0.5M KHCO₃ (C)/ | >95 | >95 | −0.83 | 24 |
| | 2M KOH (A) | | | | |
| Ni—N-AC-B1 | 1M KHCO₃ (C)/ | 80 | 40 | N/A | 24 |
| | 2M KOH (A) | | | | |
| Fe/N—C | 1M KOH | 70 | 1.4 | N/A | N/A |
| Ni/N—C | 1M KOH | 80 | 80 | N/A | N/A |
| Ni—N-C₁₀₀₀ | 0.5M KHCO₃ | 95 | 20 | −1.3 | 7 |
| Ni-NCB | 0.1M KHCO₃ | ~99 | ~90 | N/A | 20 |

### CONCLUSIONS

In conclusion, a facile, simple, and highly scalable method was developed in this work using two types of commercial materials, CNT and a Nitrogen-containing organic precursor. Unlike conventional synthesis methods, this method included only a one step pyrolysis of the mixture at 650° C. without the need of any pre- or post-treatment. It is also applicable to different types of nitrogen precursors and different brands of CNTs, indicating significant universality for different raw materials. In addition, different batches in mass (0.1 to 10 g) were synthesized and the catalytic performances were comparable, indicating the significant scale-up potential. From STEM/XAS investigation, both Ni and Fe metal impurities exist in the raw CNTs and are preserved after pyrolysis while the metals being coordinated with N dopants to form M-N—C catalysts. The Ni metals primarily exist as nanoparticles/nanoclusters that are encapsulated by carbon layers. Single atomic Fe—N sites are believed to be the main active sites responsible for high CO₂RR performance observed in this work, with the possibility of minor contribution from the synergetic effect of Ni NP and Fe—N. The prepared catalysts have achieved more than 95% CO selectivity and demonstrated long-term stability of 45 h at 100 mA/cm² in a pure CO₂ environment, outperforming the benchmark Ag NP catalyst and other single atomic M-N—C catalysts, ranking among the top of the leading literature. The catalyst also shows much stable performance at a diluted CO₂ environment (25%) than that of Ag NP, achieving >90% CO selectivity for 24 h at 100 mA/cm², indicating the feasibility in potential practical applications. The findings in this work provide a viable solution to cost-effective CO₂RR at a large scale by developing a facile and scalable catalyst synthesis method.

While illustrative embodiments have been illustrated and described, it will be appreciated that various changes can be made therein without departing from the spirit and scope of the invention.

1. A heteroatom-doped carbon nanotube comprising single atomic metal-nitrogen-carbon (M-N—C) sites for use as an electrocatalyst.

2. The heteroatom-doped carbon nanotube of claim 1, comprising single atomic Fe—N bonds as active sites configured to convert carbon dioxide to carbon monoxide.

3. The heteroatom-doped carbon nanotube of claim 2, wherein the active sites are disposed on an outer surface of the heteroatom-doped carbon nanotube.

4. The heteroatom-doped carbon nanotube of claim 2, wherein Fe in the single atomic Fe—N bonds is in a positive oxidation state as determined by high-resolution X-ray photoelectron spectroscopy (XPS).

5. The heteroatom-doped carbon nanotube of claim 2, wherein Fe in the single atomic Fe—N bonds comprises an oxidation state in a range of 0 and 3 as determined by high-resolution XPS.

6. The heteroatom-doped carbon nanotube of claim 2, further comprising Ni metal nanoparticles.

7. The heteroatom-doped carbon nanotube of claim 6, wherein the Ni metal nanoparticles are disposed in joints of the heteroatom-doped carbon nanotube.

8. The heteroatom-doped carbon nanotube of claim 6, wherein the Ni metal nanoparticles are encapsulated by graphitic carbon layers of the heteroatom-doped carbon nanotube.

9. The heteroatom-doped carbon nanotube of claim 6, wherein the Ni metal nanoparticles are configured to convert carbon dioxide to carbon monoxide synergistically with the single atomic M-N—C sites.

10. The heteroatom-doped carbon nanotube of claim 1, wherein the heteroatom-doped carbon nanotube is a multi-walled heteroatom-doped carbon nanotube.

11. The heteroatom-doped carbon nanotube of claim 1, wherein the heteroatom-doped carbon nanotube comprises a specific surface area in a range of about 100 m²/g and about 200 m²/g as measured by Brunauer-Emmett-Teller (BET) measurement.

12. The heteroatom-doped carbon nanotube of claim 1, wherein the heteroatom-doped carbon nanotube comprises a specific surface area of about 170 m²/g as measured by BET measurement.

13. The heteroatom-doped carbon nanotube of claim 1, wherein the heteroatom-doped carbon nanotube comprises an efficient CO₂ reduction performance with a CO Faradaic efficiency greater than 90% from −0.6 to −0.8 V vs. RHE for CO₂ reduction as measured in a H-Cell.

14. The heteroatom-doped carbon nanotube of claim 1, wherein the heteroatom-doped carbon nanotube comprises an efficient CO₂ reduction performance with a 13-15 mA/cm² of CO partial current density at −0.8 V vs. RHE as measured in a H-Cell.

15. (canceled)

16. (canceled)

17. A catalytic electrode comprising:
a carbon electrode; and
heteroatom-doped carbon nanotubes according to claim 1 disposed on a surface of the carbon electrode.

18. A reactor comprising:
a first fluid compartment;
a second fluid compartment;
an ion exchange membrane fluidically separating the first fluid compartment and the second fluid compartment and configured to allow passage of ions therethrough;
a first electrode in electrically conductive communication with an interior portion of the first fluid compartment; and
the catalytic electrode of claim 17 in electrically conductive communication with an interior portion of the second fluid compartment.

19. A method for making heteroatom-doped carbon nanotubes comprising M-N—C sites for use as an electrocatalyst to convert carbon dioxide to carbon monoxide, the method comprising:
pyrolyzing a mixture of a solid nitrogen precursor and carbon nanotubes comprising intrinsic metal impurities at a temperature and for a time sufficient to provide a heteroatom-doped carbon nanotube catalyst comprising M-N—C sites effective for electrochemical carbon dioxide reduction.

20. (canceled)

21. (canceled)

22. A method for making a heteroatom-doped carbon nanotubes comprising M-N—C sites for use as an electrocatalyst to convert carbon dioxide to carbon monoxide, the method comprising:
(a) contacting a solution comprising nitrogen precursors with carbon nanotubes comprising intrinsic metal impurities, whereby the carbon nanotubes adsorb nitrogen precursors from the solution to provide a suspension comprising organic-adsorbed carbon nanotubes comprising metal sites and adsorbed nitrogen precursors;
(b) separating the organic-adsorbed carbon nanotubes from a solvent of the suspension to provide a mixture including the organic-adsorbed carbon nanotubes,
(c) drying the mixture to provide carbon nanotubes comprising metal sites and adsorbed nitrogen precursors; and
(d) pyrolyzing the carbon nanotubes comprising metal sites and adsorbed nitrogen precursors at a temperature and for a time sufficient to provide a heteroatom-doped carbon nanotube catalyst comprising M-N—C sites effective for electrochemical carbon dioxide reduction.

23-34. (canceled)

35. A heteroatom-doped carbon nanotube having M-N—C sites prepared by the method of claim 19.

36. A method for electrochemically reducing a molecule, comprising contacting the molecule with a heteroatom-doped carbon nanotube of claim 1.

37-41. (canceled)
